(19) United States
(12) Patent Application Publication
(10) Pub. No.: US 2023/0262281 A1
(43) Pub. Date: Aug. 17, 2023

(54) DISPLAY SYNCHRONIZATION FOR TIME SENSITIVE NETWORKING

(71) Applicant: Intel Corporation, Santa Clara, CA (US)

(72) Inventors: Kishore Kasichainula, Phoenix, AZ (US); Aswin Padmanabhan, Gilbert, AZ (US); Satyeshwar Singh, Folsom, CA (US)

(21) Appl. No.: 18/296,264

(22) Filed: Apr. 5, 2023

(51) Int. Cl. H04N 21/43

(52) U.S. Cl. CPC H04N 21/43076

(57) ABSTRACT

The present disclosure provides display network synchronization (sync) technologies and techniques using time-sensitive networking (TSN) and/or Precision Time Protocol (PTP) technologies. The display network sync mechanisms synchronize multiple display systems that are communicatively coupled together via a network. The display network sync mechanisms involve synchronizing the display systems with one another, synchronizing the various clocks and/or timers of each display system, monitoring clock drift of display clocks of individual display systems, and adjusting display signaling based on the monitored clock drift. The monitoring and adjusting of the display signaling can be accomplished without broadcasting the display signaling over the network connection.

### TECHNICAL FIELD

The present disclosure is generally related to network topologies and engineering, time-aware networks, time-sensitive networking and time-sensitive applications, edge computing frameworks, and in particular, to techniques for precise and scalable display synchronization using time sensitive networking.

### BACKGROUND

Many visual media applications, such as digital signage, interactive kiosks, video wall deployments, and network video recorders (NVR), require playback content to be synchronized across many systems and screens with a high degree of accuracy. These systems are typically connected in a wired or wireless fashion. Existing synchronization (sync) solutions include either software (SW)-based sync solutions, hardware (HW)-based sync solutions, and hybrid sync solutions that employ mix of the aforementioned HW and SW methods.

The SW-based sync solutions are typically based on sync techniques using PTP or NTP standard protocols. The SW-based sync solutions can achieve good accuracy, but are limited to ranges with millisecond (ms) granularity. Additionally, the current SW-based solutions are limited in the number of displays that can be connected in a display network, as well as the physical distance between individual devices in the display network. Another limitation with these SW-based sync solutions is that, even though the applications that are running on each of these systems synchronized through PTP or NTP, the HW clock that the display controllers of each display device uses drifts (with respect to one another) and are not synchronized to the application clocks within individual display devices and among the display devices. Consequently, any drift in the clocks will eventually lead to misalignment of video frames across the network, and hence the accuracy is limited to a small number of frames. In these ways, SW-based solutions tend to be less accurate than the HW-based solutions and may require significant manual intervention. Moreover, the limited number of displays that can be supported is based in part on the complexity of maintaining sync.

The HW-based sync solutions usually involve using switches and/or coax cables, and are capable of achieving better accuracy than the SW-based sync solutions. For example, using a coax cable from a primary system (PS) to one or more secondary systems (SSs) is highly accurate. However, most HW-based implementations cannot cater to more than 16-screen installations without requiring additional re-timers owing to signal integrity issues, and can also create a lot of cable clutter. Another HW-based solution includes implementations using discrete graphics cards with a HW-based generator lock (genlock) to improve sync accuracy. However, such solutions also suffer from limitations on the number of displays that can be synchronized (sync'd) without causing signal integrity issues. Moreover, genlock solutions require PS and SS(s) to have the same genlock capability (e.g., same physical layer (PHY)) of the same generation. The HW-based sync solutions and the SW-based sync solutions can be improved by offloading sync calculations to audio video bridging (AVB) switches. However, AVB-based solutions require relatively expensive HW devices.

The hybrid methods use combination of PTP or NTP with HW display clock tuning. For example, the PTP protocol is used for sync-purposes across the systems in the network, and the PS broadcasts timestamps across the network. After an SS receives a PS timestamp, the SS calculates a timestamp delta and tunes its local display phased-lock loop (PLL) parameters to either speed up or slow-down its clock dynamically based on the computed delta. This method reduces sync errors considerably compared with SW-based sync solutions and is scalable to any number of displays. However, a first limitation to this hybrid method is that the display clock itself is not an accurate clock and includes clock drift. Since the display clock is not sync'd to the network grandmaster (GM) clock, the display clock drift is not corrected within its own system and across the network. Another limiting factor is the broadcasting network delay. As individual systems in the network are deployed physically apart from one another (e.g., which may be the case with displays in a sports stadium), the network delay will start dominating and eventually will lead to timing errors if not corrected. Another limiting factor is that the HW phased-lock loop (PLL) parameters have limited range of operation, which limits the amount of sync error that can be corrected without dropping and/or repeating frames.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which: FIG. 1 depicts an example display network environment; FIG. 2 depicts an example hybrid sync method timing diagram; FIG. 3 depicts an example vertical synchronization signal (Vsync) system architecture;

FIGS. 4a and 4b depict example display sync circuit implementations; FIG. 5 depicts an example of network device cross-timestamp and platform clock relation; FIG. 6 depicts example display network sync processes; FIG. 7 depicts an example display network sync process; FIG. 8 depicts an example application-level frame sync procedure on a PS and SSs; FIG. 9 depicts an example time-aware network; FIG. 10 depicts an example PTP instance model; FIG. 11 illustrates an example edge computing environment; and FIG. 12 depicts example components a compute node.

### DETAILED DESCRIPTION

### 1. Display Network Synchronization Aspects

The present disclosure describes display network synchronization (sync) mechanisms using time-sensitive networking (TSN) and/or Precision Time Protocol (PTP) technologies. In particular, the display network sync mechanisms extend the PTP/TSN sync techniques a display network. The display network sync mechanisms synchronize multiple displays in a display system that are communicatively coupled together. The display network sync mechanisms involve synchronizing the display systems with one another, synchronizing the various clocks of each system, and synchronizing the display clocks of each system. Here, the clock drift of display clocks of individual display systems is/are monitored, and the display signaling is adjusted based on the monitored clock drift. The monitoring and adjusting of the display signaling can be accomplished without broadcasting the display signaling over the network connection. The solutions described herein solve the limitations of SW-based sync solutions, HW-based sync solutions, and the hybrid methods discussed previously, and is/are capable of achieving sub-nanosecond (e.g., <100 nanosecond (ns)) accuracy. These aspects are discussed in more detail infra.

FIG. 1 depicts an example display network environment 100. The display network environment 100 is a system of interconnected digital displays 102 that are used to deliver content in a specific location. The content can include targeted messages, advertisements, and/or the like intended to be presented to a specific audience. In this example, the display network environment 100 includes a display arrangement 105, a network element 130, and a display control system (DCS) 140. The display arrangement 105 includes one or more display system 101 (e.g., display systems 101-1, 101-2, . . . 101-n, where n is a number), and the DCS 140 includes a scheduler 145, one or more media servers 150, and one or more databases (DBs) 155.

The display arrangement 105 includes a set of display systems 101, each of which includes a compute element 103 and a set of displays 102 (e.g., physical display devices, screens, monitors, and/or other visual output devices that present content). Although the example of FIG. 1 shows the display system 101-1 as including a single compute element 103 and a single display 102, in some implementations, a display system 101 can include multiple compute elements 103 and/or multiple displays 102. Additionally or alternatively, some display systems 101 can include mobile devices (e.g., including any of those discussed herein), where the display(s) 102 and compute element(s) 103 are part of the same form factor or housing. As discussed in more detail infra, the displays 102 (or display systems 101) of the display arrangement 105 are synchronized (sync'd) to display the same or different content/media according to some predefined or configurable order and/or timing. For example, multiple displays 102 (or display systems 101) can be sync'd to display the same video frame at the same time instance regardless of the position of each display 102 (or display system 101) in the display arrangement 105 and/or regardless of the relative position of individual displays 102 (or display systems 101) with respect to (w.r.t) one another. In another example, multiple displays 102 (or display systems 101) can be sync'd, such that a first display 102 (or display system 101) displays/outputs a first type of content at the same or similar time that a second display 102 (or display system 101) displays/outputs a second type of content. This example may be useful for display arrangements 105 that include different types of display devices 102.

FIG. 1 also shows different examples of display arrangements 105, namely an electronic signage arrangement 105a, a multi-level video wall display arrangement 105b (also referred to herein as “video wall 105b”), and a stadium display arrangement 105c (also referred to herein as “stadium display 105c”). The synchronization techniques can also be applied to other types of display arrangements 105 such as, for example, large format screens/displays (e.g., roadside displays, building wrap displays, stage screens/displays, and/or the like), architectural installation screens/displays, floor displays/screens, laser light show arrangements, and/or the like.

The electronic signage arrangement 105a comprises a set of displays/screens 102 that display content for wayfinding, exhibitions, marketing communications, advertising, and/or other purposes. These display devices 102 are typically deployed at various locations in public spaces. Examples of electronic signage displays/screens 102 can include fluorescent signs, high intensity displays (HID), incandescent signs, digital signs (e.g., using any suitable display technologies, such as any of those discussed herein), neon signs, projectors, semi-transparent window systems/displays, e-paper, and/or the like. In some implementations, the electronic signage arrangement 105a can include various interactive digital signage, which allow end users to interact with digital content via touchscreens, sensors, quick response (QR) codes via smartphones, SMS messaging, direct communications (e.g., Bluetooth® and/or the like), and/or using other technologies, such as any of those discussed herein.

The multi-level video wall display arrangement 105b is a display system that uses multiple layers of video screens or panels to create a single, large video display. The multi-level aspects of the video wall 105b refers to the use of multiple layers or levels of screens to create a more immersive and dynamic visual experience for content consumers. This can involve using multiple displays/screens of various sizes, shapes, angles, and/or orientations, as well as deploying the multiple displays/screens at multiple locations over relatively long distances. Additionally, video walls 105b are designed to be flexible and customizable with the ability to display different types of content across multiple displays/screens or layers, and to be easily updated and reconfigured as needed. In this example, the multiple display screens of the video wall 105b are deployed within an individual shopping center (e.g., a mall or the like). However, in other examples, the multiple display screens can be deployed in various arrangements and environments such as, for example, in relatively large public spaces (e.g., shopping malls, transportation hubs, event venues, and/or the like), corporate settings (e.g., for presentations, conferences, and/or other events), a TV studio backdrop display system, a control room display system, and/or the like. Multi-level video wall 105b can be used to display or otherwise output high-resolution video content and/or related audio content (e.g., advertising, informational content, live event coverage, and/or other types of visual/audio media).

The stadium display arrangement 105c is a display system including a set of display devices/screens that are installed in a stadium or arena to display visual content such as, for example, video footage, advertisements, game scores, and/or other information to the audience during events such as sports games, concerts, and/or other live performances. The displays/screens of the stadium display arrangement 105c are usually installed or disposed in prominent positions where they can be seen by some, most, or all members of an audience, and can vary in size from relatively small screens to extremely large displays that cover entire sections of the stadium or arena. As examples, the stadium displays can include relatively large fixed screens, video boards, indoor and/or outdoor perimeter boards, scoreboard screens, stage background screens/displays, stadium tier ribbon screens, and/or other display devices 102.

In various implementations, the display devices 102 can include any combination of display technologies such as, for example, hybrid laser cube displays, LED/OLED/QLED displays, microLED displays, projectors, LED sticks, LED strips, surface-mount device (SMD) pixel packaging, direct in-line packaging (DIP), projectors, and/or any other display technologies, such as any of those discussed herein. The particular display technologies to be used may be implementation-specific, based on specific use cases, and/or based on environmental conditions (e.g., indoor or outdoor setting, ambient light conditions, temperature surrounding the displays/screens, and/or the like). Using conventional sync techniques for the various display systems 101/arrangements 105 can result in transmission delays, glitches, screen artifacts (also referred to as “artefacts”), and/or other errors or issues. As discussed in more detail infra, the sync techniques and technologies discussed herein can sync displays connected over relatively long distances by reducing or eliminating delay and/or latency in frame rendering and/or signaling/communications among the various displays dispersed over the large area.

As alluded to previously, each display system 101 includes at least one display device 102 and at least one compute element 103. The compute element 103 is an appliance or some other suitable compute node that connects one or more display devices 102 of a display system 101 to the DCS 140, and enables the display device(s) 102 to render, play, or otherwise output content. Additionally, the compute element 103 includes HW and SW elements to receive data/signaling from the DCS 140, process the data, and render the appropriate experience on the display device(s). In some examples, the compute element 103 have the same or similar components as the compute node 1200 of FIG. 12. Examples of the compute element 103 can include digital media players or streaming devices (e.g., Amazon® Fire TV, Amazon® Fire TV Stick, Apple TV®, Google® Chromecast, NVIDIA® shield console, Roku® streaming player, Roku® streaming stick, and/or the like), video game console (e.g., Microsoft® Xbox, Sony® PlayStation, Nintendo® Wii U, and/or the like), smart TVs (e.g., Samsung® Neo™ QLED TVs, LG® OLED Evo™, Vizio® M-Series™ TVs, and/or the like), relatively small single board computers (SBCs) (e.g., Raspberry Pi™, Arduino™, Intel® Edison™ boards, NVIDIA® Jetson Nano™, and/or the like), small-form-factor computers (e.g., Intel® Next Unit of Computing (NUC) devices, AMD® Mini PCs™ Apple® Mac Mini®, Apple TV®, and/or the like), single-board microcontrollers, and/or any other computing device(s), such as any of those discussed herein.

In a first example implementation, each compute element 103 is built-in or otherwise enclosed within a corresponding display device 102. In a second example implementation, each compute element 103 is a separate or standalone compute node that is connected to at least one display device 102 and/or connected to at least one other compute element 103. In a third example implementation, some compute elements 103 is/are built-in or otherwise enclosed within corresponding display devices 102 and other compute elements 103 is/are a standalone compute nodes. In any of these example implementations, a compute element 103 is connected to a corresponding display device 102 and/or at least one other compute element 103 via a wired and/or wireless connection, and may utilize any suitable access technology, such as any of those discussed herein. In any of the aforementioned examples, the compute elements 103 and/or display devices 102 may be arranged into any suitable topology such as, for example, a point-to-point topology, bus topology, star topology, ring or circular topology, mesh topology, tree topology, daisy chain topology, or a hybrid topology (e.g., including two or more different topology types).

In some examples, at least one compute element 103 is connected to the DCS 140 via the network element(s) 130. The network element(s) 130 provides network connectivity for the compute element(s) 103, and in some examples, the network element(s) 130 is/are the same or similar as the NANs 1130 discussed infra w.r.t FIG. 11. Examples of the network element(s) 130 can include AVB bridges and/or AVB switches (e.g., Ethernet switches operating according to [IEEE802.1BA], [IEEE802.1AS], and/or [IEEE1588] technologies), Dante-enabled switches, AES67 switches, Gigabit Ethernet switches, HDMI switches/hubs, DisplayPort switches/hubs, HDBaseT switches, Digital Interface for Video and Audio (DiiVA) switches, and/or any other suitable network element or appliance.

The DCS 140 includes various HW and SW elements used to create, store, manage, and/or schedule the content that is to be displayed on the display devices 102 of one or more display systems 101. The DCS 140 can be implemented by a cloud computing service (e.g., cloud 1144 of FIG. 11), an edge computing network (e.g., edge computing framework 1135 and/or edge compute nodes 1136 of FIG. 11), and/or local devices (e.g., compute elements 103, UEs 1110 and/or NANs 1130 of FIG. 11), and manages content delivery to the display systems 101 and/or updates/changes to the content. For example, the various HW and SW elements of the DCS 140 include one or more media servers 150, one or more DBs 155, and a scheduler 145. The one or more DBs 155 may store content to be displayed by the display device(s) 102, and the media server(s) 150 manage storage and retrieval of the content from the DB(s) 155 and/or operate instances of the scheduler 145 to manage the delivery and/or provisioning of the content to the compute element(s) 103 and display device(s) 102. In other implementations, the scheduler 145 is a standalone gateway, appliance, or other suitable compute node(s) that handle delivery of the content to individual compute elements 103 and display device(s) 102. In either implementation, the compute element(s) 103 can include client applications (see e.g., apps 311 of FIG. 3) to display the content. As examples, these client applications can be browsers, web apps, websites or webpages, mobile apps, generic or platform-specific desktop apps, and/or the like.

In some implementations, the DCS 140 includes, a content management system (CMS) to manage the creation and modification of digital content. In these implementations, the CMS includes a content management application (CMA), which provides a front-end user interface that allows users to add, modify, and remove content; and a content delivery application (CDA) that compiles the content and updates the client apps. Here, the CDA can be part of the scheduler 145. Additionally or alternatively, the DCS 140 can implement analytics and reporting tools to track and measure the effectiveness of the content and the network. This can include data on audience engagement, impressions, and/or other metrics, such as any of those discussed herein.

The content to be displayed by the display device(s) 102 can include digital signage content and/or any other suitable content/media types. The content can be static or dynamic (e.g., using web development tools and/or the like), and can include a range of media types, such as text data, image data, video data, animations, and/or live data feeds. The content can be designed to inform, entertain, and/or otherwise engage an audience. Additionally or alternatively, any suitable media format and/or file format can be used, such as any of those discussed herein.

As discussed previously, the existing/current solutions can be grouped into three categories including SW-based sync solutions, HW-based sync solutions, and hybrid sync solutions. However, these existing/current solutions still introduce delays, latency, artifacts, and/or other errors into the display systems.

FIG. 2 shows an example timing diagram 200 for a hybrid sync solution where a frame N is synchronized between a PS 201-1 and an SS 201-2. Here, the PS 201-1 includes a primary SW system (P-SW) 210-1 and a primary HW system (P-HW) 220-1, and the SS 201-1 includes a secondary SW system (S-SW) 210-2 and a secondary HW system (S-HW) 220-2. The timing diagram 200 includes timing axes for each of the P-SW 210-1, P-HW 220-1, S-SW 210-2, and S-HW 220-2.

As shown by the timing diagram 200, there are three sources of error including: primary clock (P-clock) drift error 250, secondary clock (S-clock) drift error 255, broadcast latency 260, and a sync error 265. The P-clock drift error 250 is due to display clock drift within the PS 201-1, or is a display clock drift w.r.t. an application clock in the PS 201-1. Additionally, the S-clock drift error 255 is due to display clock drift within the SS 201-2, or is a display clock drift w.r.t. an application clock in the SS 201-2. The latency 260 is due to broadcast propagation delay/latency. The sync error 265 represents a total amount of error introduced into the system due to the clock drift errors 250, 255 and the latency 260. The fundamental issue of display clock drift 250, 255 and sync error 265 of the display clocks to a system clock limits the sync accuracy.

The display network sync mechanisms discussed herein include HW-based monitoring circuitry (e.g., display clock monitor 323 of FIG. 3) in a display controller (e.g., display controller 321 of FIG. 3), which is configured to monitor display clock drift 250, 255 and correct any detected clock drift 250, 255 within a display system 101. In these implementations, no SW-sync interventions and no vertical synchronization signal (Vsync) communication/broadcasting are used. The elimination of Vsync broadcasting across the network removes the latency induced sync error 265. The display network sync mechanisms are capable of achieving sub-nanosecond (<100 ns) display sync accuracy because the display clock and network clock within an individual display system 101 and among the display system 101 are precisely synchronized. Additionally, the display network sync mechanisms eliminate the SW overhead of managing display sync and need for expensive AVB switches or special coax cables. Furthermore, the display network sync mechanisms are scalable to any number of displays 102 (or display systems 101), and scalable to any physical (relative) distance between individual displays 102 (or display systems 101). The display network sync mechanisms are scalable to any display device models, types, makes, and/or display technologies as the sync solutions do not depend on any specific display technology, display controller platform, or sideband messages for time sync. This allows multiple display devices from multiple equipment manufacturers and different display technologies to sync'd within the same display network. Moreover, in comparison with existing display sync technologies, the display network sync mechanisms are less resource intensive (e.g., have less overhead) and require less silicon area to implement.

FIG. 3 depicts an example display sync system architecture 300, which includes a PS 301-1 connected to a primary display device 302-1 and an SS 301-2 connected to a secondary display device 302-2. The display sync system architecture 300 may correspond to any of the display arrangements 105 discussed previously, and may be designated as a PTP domain or a generalized PTP (gPTP) domain for purposes of PTP/TSN synchronization. In some implementations, the PS 301-1 is part of the primary display device 302-1, while in other implementations, the PS 301-1 is part of a standalone compute device that is separate from the primary display device 302-1. Additionally or alternatively, the SS 301-2 is part of the secondary display device 302-2, or the SS 301-2 is part of a standalone compute device that is separate from the secondary display device 302-2. Additionally or alternatively, the PS 301-1 and/or the SS 301-2 is are part of any of the compute elements 103 discussed previously. Although the system architecture 300 in this example includes one PS 301-1 connected to one primary display device 302-1 and one SS 301-2 connected to one secondary display device 302-2, in other implementations, many more SS 301-2 may be present, each of which can be connected to one or multiple secondary display devices 302-2 in any suitable topology or arrangement. Additionally or alternatively, each system 301 can be connected to multiple display devices 302. Other arrangements, configurations, and/or topologies are possible in other implementations.

The PS 301-1 includes a P-SW layer 310-1 and a P-HW layer 320-1. The P-SW layer 310-1 includes an application (app) 311-1, a display driver 312-1, and a network interface controller (NIC) driver 313-1. The P-HW layer 320-1 includes display controller circuitry 321-1 (also referred to as “display controller 321-1”), always running timer (ART) circuitry 325-1 (also referred to as “ART 325-1”), and a NIC 326-1 which includes PTP timer circuitry 327-1. The display controller 321-1 includes microcontroller circuitry 322-1 (also referred to as “μcontroller 322-1” or “MCU 322-1”), display clock monitor circuitry 323-1 (also referred to as “dispclk monitor 323-1”), and adjustable Vsync timer circuitry 324-1 (also referred to as “Vsync timer 324-1”). Additionally, the NIC 326-1 is connected to the dispclk monitor 323-1 via an interface 336-1.

The SS 301-2 includes an S-SW layer 310-2 and an S-HW layer 320-2. The S-SW layer 310-2 includes an app 311-2 a display driver 312-2, and a NIC driver 313-2. The S-HW layer 320-2 includes display controller circuitry 321-2, ART circuitry 325-2 (also referred to as “ART 325-2”), and a NIC 326-2 which includes PTP timer circuitry 327-2. The display controller 321-2 includes microcontroller circuitry 322-2 (also referred to as “μcontroller 322-2” or “MCU 322-2”), display clock monitor circuitry 323-2 (also referred to as “dispclk monitor 323-2”), and adjustable Vsync timer circuitry 324-2 (also referred to as “Vsync timer 324-2”). Additionally, the NIC 326-2 is connected to the dispclk monitor 323-2 via an interface 336-2.

As shown by FIG. 3 the PS 301-2 and SS 301-2 are connected to one another by an interface 306 (also referred to as a “PTP link” or the like). The interface 306 can be a wired or wireless connection and may be based on any suitable access technology, such as any of those discussed herein. In some implementations, the interface 306 is a category 5 (CAT5) or category 6 (CAT6) Ethernet cable. In other examples, the interface 306 can include a wireless link or channel according to a suitable radio access technology (RAT), such as any of those discussed herein. Additionally or alternatively, the interfaces 336-1, 336-2 can be implemented as general-purpose input/output (GPIO), time-aware GPIO (TGPIO), special input/output (SIO), I²C, and/or any other suitable interface or interconnect technology, such as any of those discussed herein. For example, discrete graphics chip implementations may use GPIO pins as the interface 306 to connect the NIC 326 and the display controller 321. In another example, the interface 306 can be PCB traces or some other interconnect technology directly within a SoC if both display controller 321 and the NIC 326 are on the same chip or IC.

The display network sync mechanisms include a system sync operation and a display sync operation. The system sync operation includes an inter-system sync operation and an intra-system sync operation. The inter-system sync operation involves synchronizing the PS 301-2 and SS(s) 301-2 to the same time source, and the intra-system sync operation involves synchronizing the internal clocks of individual systems 301. The display sync operation involves synchronizing the display devices 302 and/or synchronizing the display signaling to the displays 302.

The inter-system sync operation (e.g., synchronizing the PS 301-1 and SS 301-2) takes place over the interface 306 according to PTP (e.g., [IEEE1588]) and/or TSN (e.g., [IEEE802.1AS]) technologies. In this example, the best master clock algorithm (BMCA) is used to select or otherwise designate the PS 301-1 (or the NIC 326-1) as a grandmaster (GM) PTP instance, which is a PTP instance that contains a GM clock (e.g., the PTP timer 327-1 may be designated as the GM clock). After the PS 301-1 is selected as the GM PTP instance, all other systems (e.g., SS 301-2) are designated as a non-GM PTP instance (also referred to as a follower node, secondary PTP instance, or the like). The SS 301-2 can be a PTP relay instance or PTP end instance. The GM clock is the source of time to which all other PTP instances are synchronized, and the PTP timer 327-2 in the NIC 326-2 of the SS 301-2 synchronizes its time to the PTP timer 327-1. Various PTP packets (e.g., Announce, Management, Signaling, Sync, Follow_Up, Delay_Req, Delay_Resp, Pdelay_Req, Pdelay_Resp, and Pdelay_Resp_Follow_Up messages) are exchanged between the NICs 326-1, 326-2 to select the GM PTP instance and to synchronize the PTP timers 327-1, 327-2. At the end of the inter-system sync operation, the PTP timers 327-1, 327-2 are sync'd in both phase and frequency.

After the PS 301-1 and SS 301-2 are synchronized from the inter-system sync operation, the intra-system sync operation takes place. The intra-system sync operation takes place within individual display systems 101, 301. This involves synchronizing an app 311 running on a host (e.g., SW 310) with the NIC 326 system clock (e.g., PTP timer 327). In some implementations, the Intel® Hammock Harbor (HH) protocol can be used for this purpose. Additional aspects of intra-system sync operation are discussed infra w.r.t FIG. 5. A result of the intra-system sync operation is determining a relationship between a timestamp counter (TSC), the ART 325, and the PTP timer 327.

The display sync operation extends the system sync operations (e.g., PTP/TSN sync) to the respective displays 302. After the inter-system sync operation, each PTP timer 327 generates a clock-like signal referred to as a pulse per second signal (PPS) 330-1, 330-2. At any given time, the PPS 330 from each system 301 will be in-sync with each other in both frequency and phase regardless of their local PTP clock quality.

The PPS 330 within each system 301 is routed to the display controller 321 (or the dispclk monitor 323) through the interface 336. The PPS 330 is used to correct 333 the Vsync pulses/signals 334. In particular, individual μcontrollers 322-1, 322-2 generate respective display clock signals (dispclk) 332-1, 332-2 based on respective reference clock signals (refclk) 331-1, 331-2. In this example, both refclk 331-1 and refclk 331-2 have a same frequency (e.g., 38.4 megahertz (MHz)), but have different drift rates; namely, refclk 331-1 has a clock drift of 50 ppm and refclk 331-2 has a clock drift of 100 ppm.

The respective dispclk monitors 323-1, 323-2 generate respective display correction signals (dispcorr) 333-1, 333-2 based on the respective dispclk 332-1, 332-2 and the respective PPS 330-1, 330-2. The dispclk monitors 323 are HW counters that continuously monitor the display clock drift w.r.t the network time of the PTP clock/timer 327-1, 327-2 (e.g., using the PPS 330 as a frame of reference). In some implementations, this is done by having a counter that counts dispclk ticks within a specified interval (e.g., 125 ms).

The respective Vsync timers 324-1, 324-2 generate respective Vsync pulses/signals 334-1, 334-2 (or Vsync packets 334-1, 334-2) based on the respective dispcorrs 333-1, 333-2. The previous/existing display sync solutions do not address Vsync drifting freely within a display system, which leads to uncorrected sync errors 265. Previous/existing solutions, such as those described previously, either have a fixed time/divider or adjust the phased-lock loop (PLL) itself with limited accuracy and limited distance range. By contrast, the adjustable Vsync timers 324 have little to no limitation on the amount of the sync error or PLL parameter range that can be corrected as the display PLL is untouched.

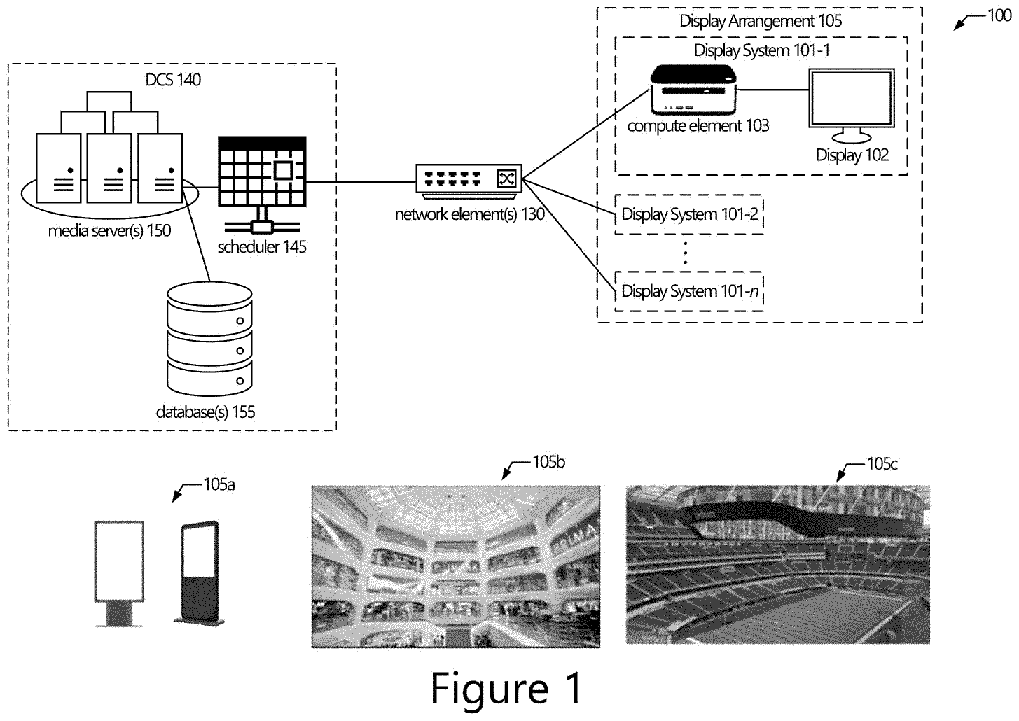

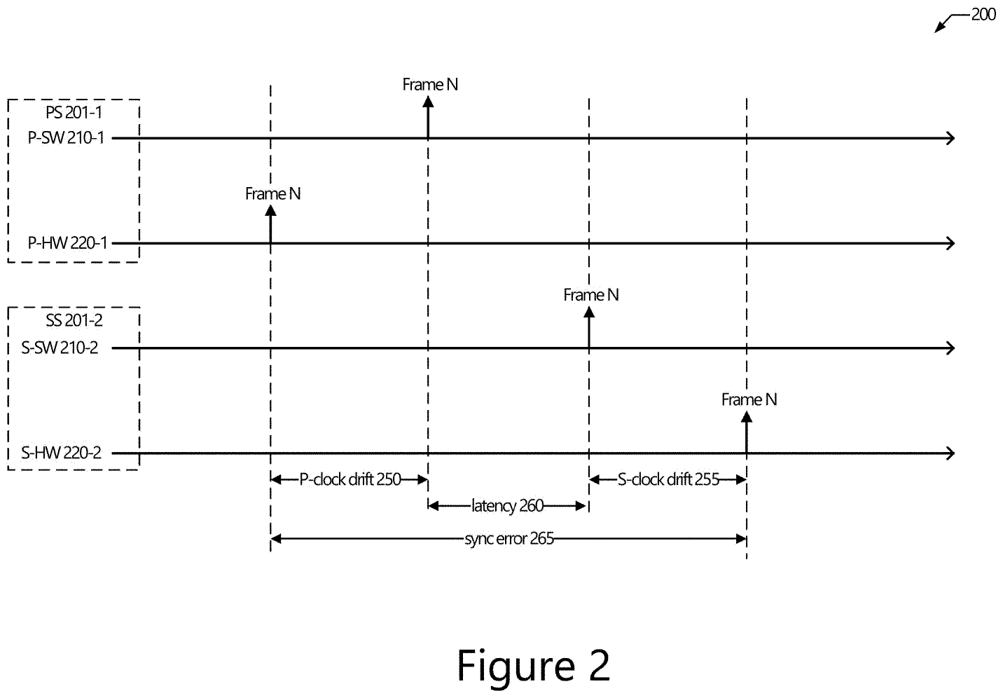

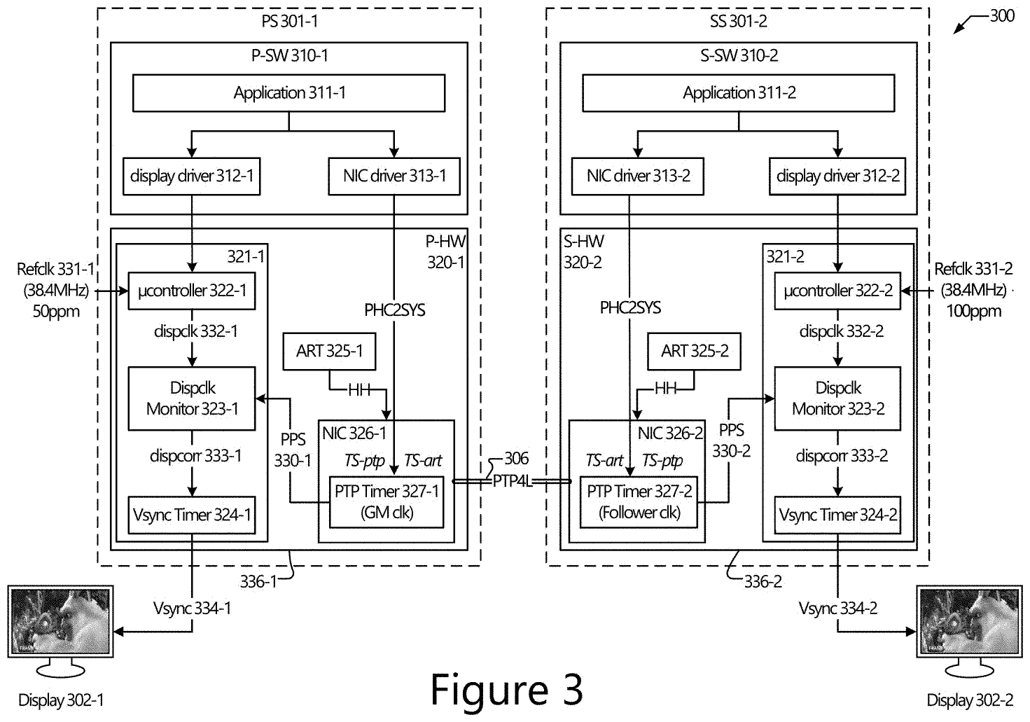

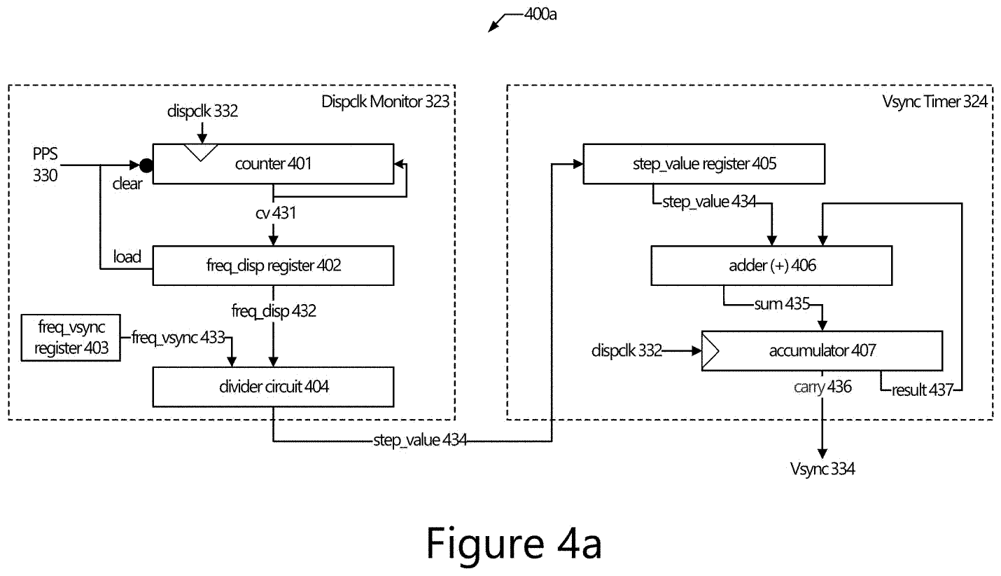

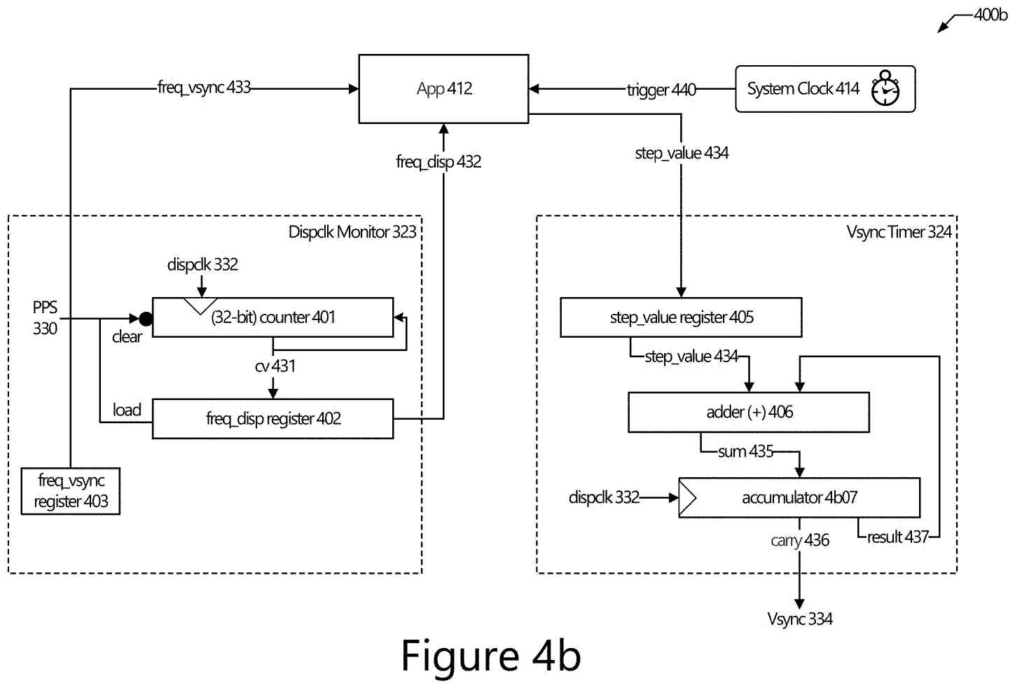

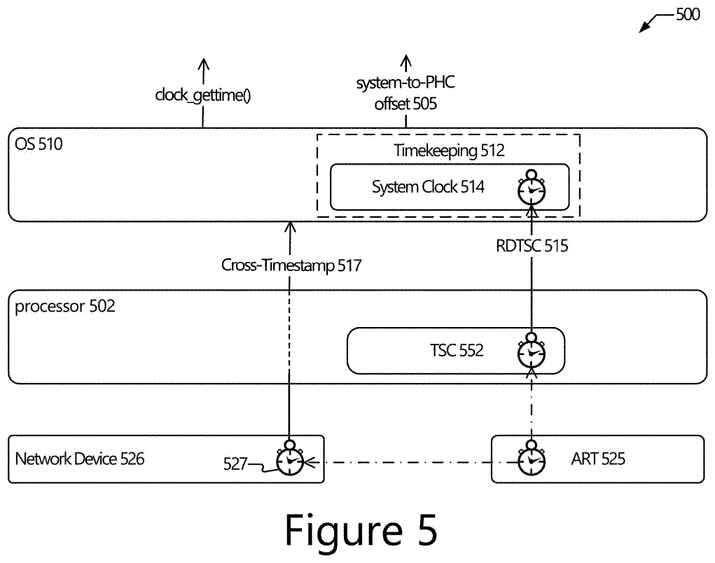

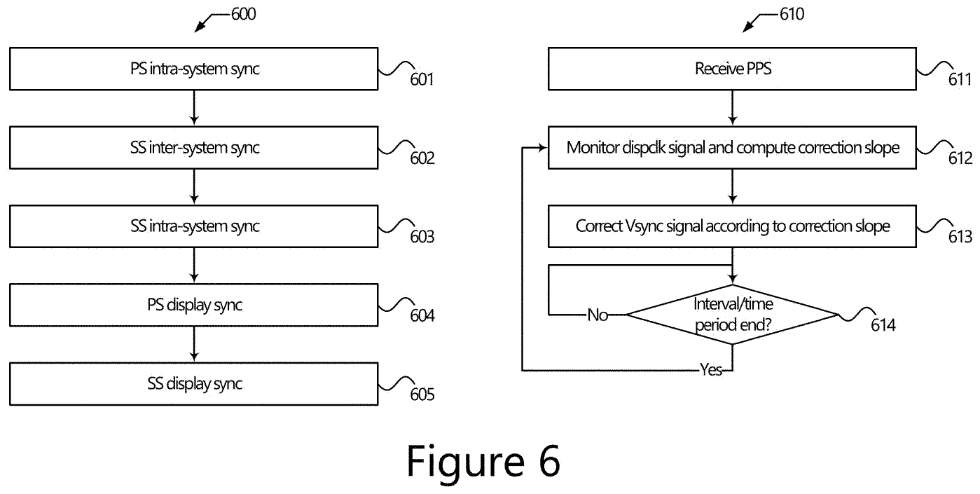

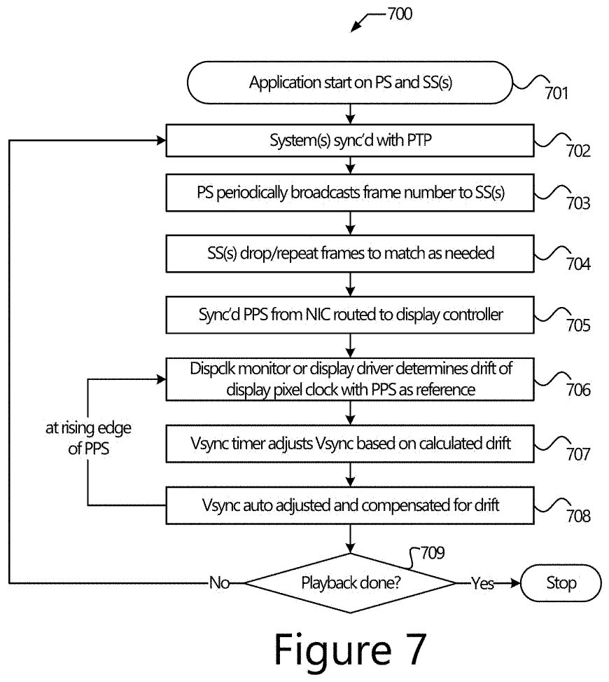

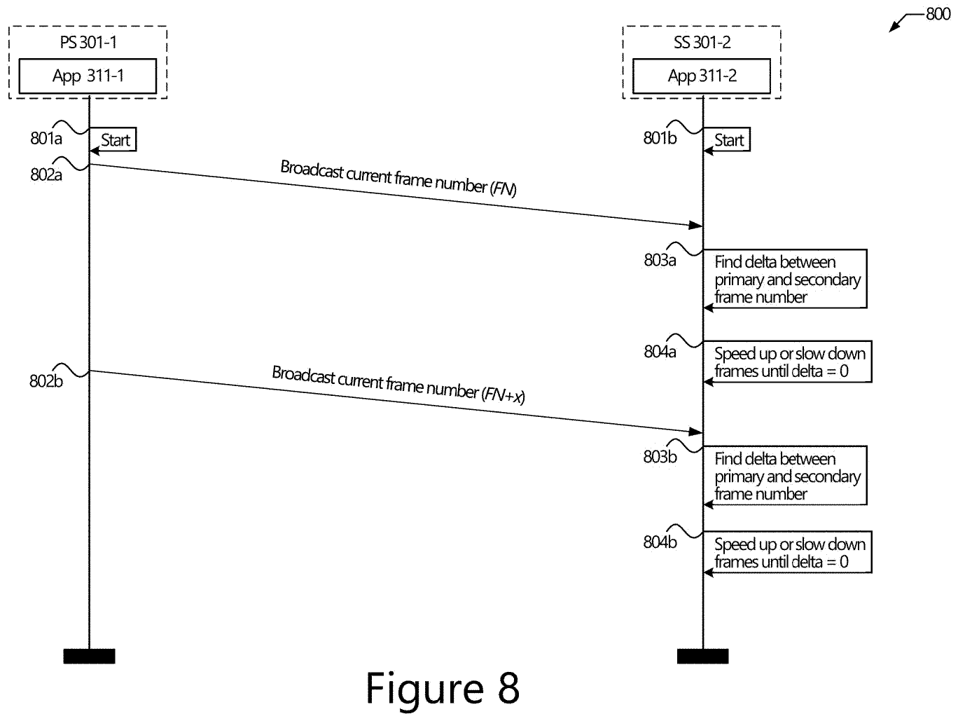

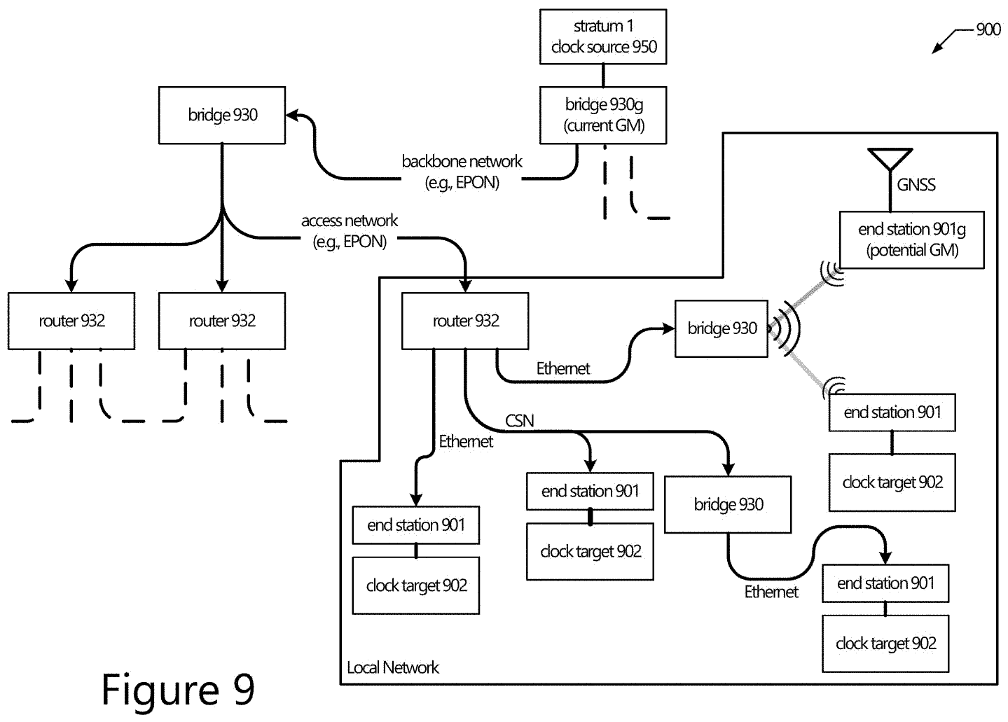

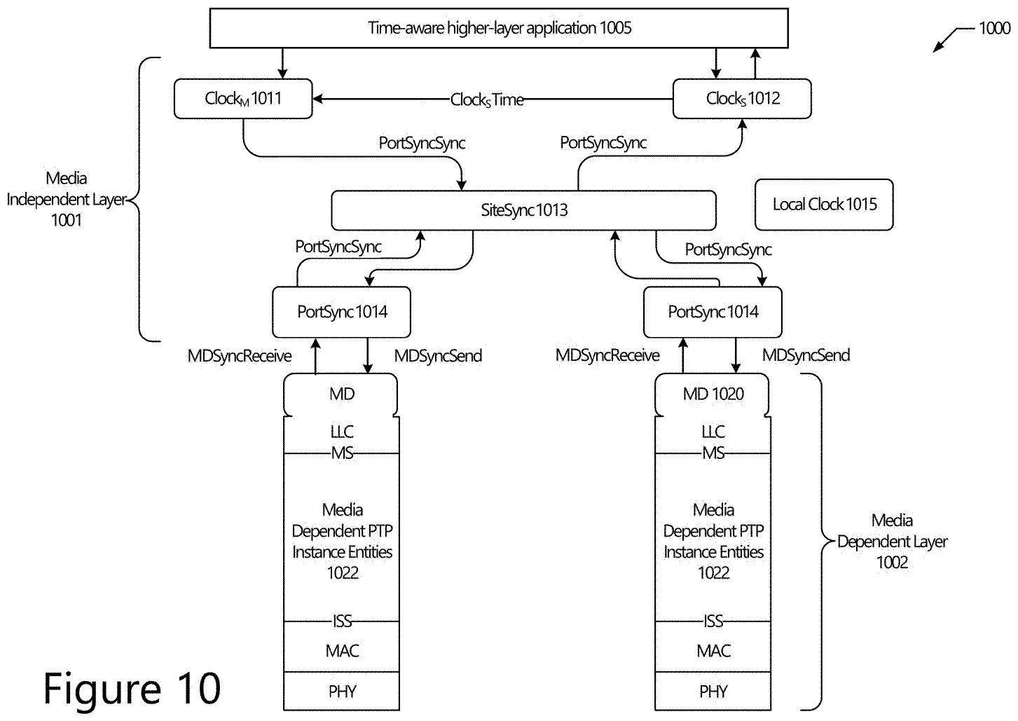

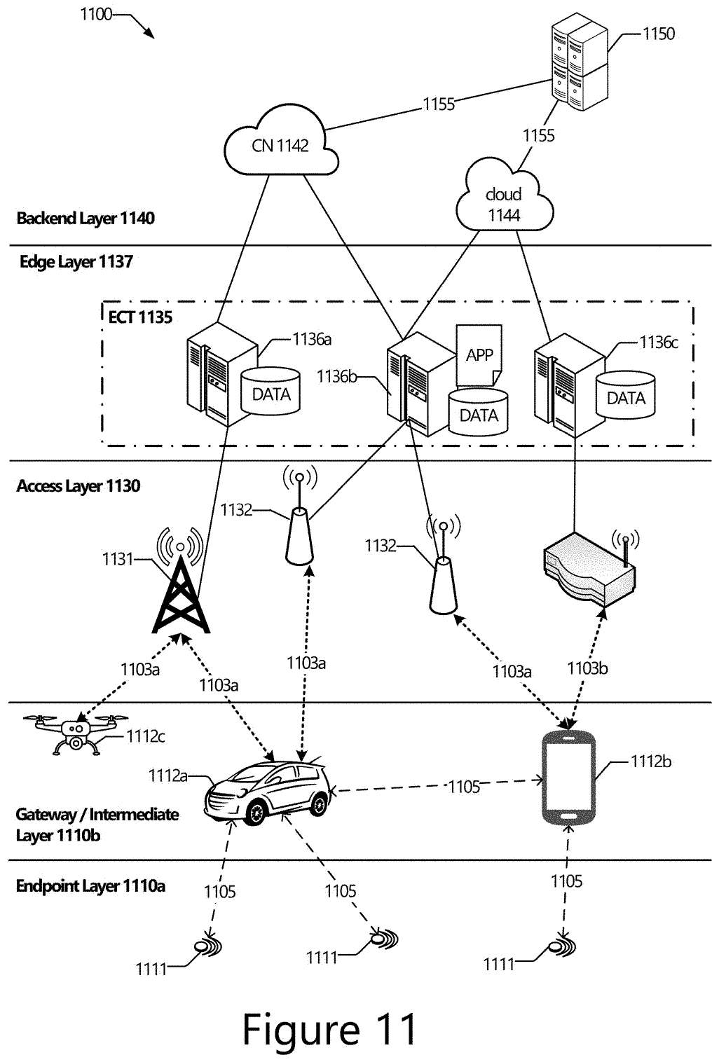

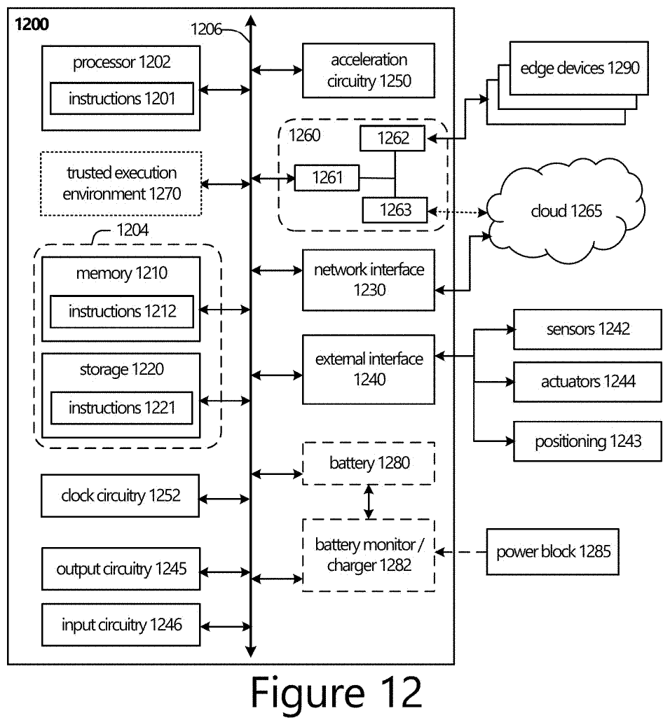

The (corrected, sync'd) Vsync 334 is provided to the display device 302, which is then used by the display device 302 to render and display content. In general, the Vsync 334 is a video signal that synchronizes the refresh rate of a display device 302 with the output signal of the display controller/GPU 321. The Vsync 334 helps to prevent visual artifacts (e.g., screen tearing, stuttering, and/or the like) by ensuring that the display 302 is refreshed at the same rate that the display controller/GPU 321 produces new frames. When Vsync 334 is enabled, the display 302 will wait for the display controller/GPU 321 to finish rendering a frame before it refreshes the display 302, which can provide smoother, more consistent visuals. Based on the detected clock drift (e.g., dispcorrs 333), the Vsync correction slope m is adjusted periodically with a relatively fine correction. Here, m is a step value, which is discussed in more detail infra w.r.t FIGS. 4a and 4b.

In some implementations, the dispcorr 333 is a corrected dispclk 332, while in other implementations, the dispcorr 333 is a correction factor that is applied to the dispclk 332. An example implementation of the dispclk correction is discussed infra w.r.t FIG. 4. In either implementation, the Vsync 334 is tightly coupled to a corresponding PTP clock 327 through the PPS 330. This is because the PPS 330-2 of each SS 301-2 is precisely synchronized to the primary PPS 330-1 using the PTP/TSN protocols. In this way, the Vsync 334 does not need to be broadcast over the network for sync purposes, which reduces the likelihood of introducing sync errors 265 into the display network, reduces network resource consumption, and reduces the need for multiple cables/wires to be used to connect the display systems 101, 301.

Although the example of FIG. 3 shows specific HW circuits of the display controller 321 to sync the Vsync 334, in other examples, the components of the display controller 321 can be implemented as one or more SW elements (e.g., as firmware (FW) executed by the display controller 321, program code executed by a GPU, and/or the like).

FIG. 4a depicts an example display sync circuit implementation 400a. In this example, the display sync circuit implementation 400a includes circuit components of the dispclk monitor 323 and the Vsync timer 324 of FIG. 3. During operation, the PPS 330 and the dispclk 332 are provided to the dispclk monitor 323, and specifically, the PPS 330 and the dispclk 332 are fed into a counter circuit 401 (e.g., a 32-bit counter). The counter circuit 401 counts a number of ticks of the dispclk 332 for each PPS 330. In general, the PPS 330 is usually slower than the dispclk 332. For example, the PPS 330 may have a frequency of 1 Hertz (e.g., 1 cycle/pulse per second) and the dispclk 332 may have a frequency of 100 MHz (e.g., 100 million cycles per second). This means that without clock drift, between the two ticks of the PPS 330, the counter circuit 401 will store a value of 100 million. However, with clock drift, the value of the counter 401 may have a higher or lower value than 100 million.

Each tick or pulse of the PPS 330 causes the counter circuit 401 to load its value (e.g., counter value (cv) 431) into display frequency (freq_disp) register 402, and also causes the counter circuit 401 to be cleared so that the number of ticks of the dispclk 332 can be counted anew for each PPS 330 tick/pulse. In some implementations, the cv 431 is simply the number of ticks counted per PPS 330, and the freq_disp register 402 determines a freq_disp. In other implementations, the output of the counter 401, cv 431, is the freq_disp (e.g., referred to herein as “freq_disp 431”). In either implementation, the freq_disp can be determined by dividing the cv 431 by the PPS 330. Furthermore, the freq_disp can be used to determine the drift value of the dispclk 332 w.r.t the PPS 330, for example, by calculating [symbol] the difference in time between the two clocks and dividing the difference in time by the duration of the measurement period. Additionally or alternatively, if an ideal or desired freq_disp value is known, the clock drift of the dispclk 332 w.r.t the PPS 330 can be a remainder value from subtracting the cv 431 from the ideal or desired freq_disp value. Additionally or alternatively, the clock drift can be computed by taking a ratio of the difference between an ideal count value and current couter value (e.g., cv 431) to the ideal count value.

The stored freq_disp 432 and a desired Vsync frequency (freq_vsync) 433 are provided to a divider circuit 404. In some implementations, a multiplier or shift register may be used as, or instead of, the divider circuit 404. The freq_vsync 433 is a desired Vsync frequency stored by a freq_vsync register 403. After obtaining the display clock drift (or freq_disp 432), a correction slope m is computed using the divider circuit 404, which is referred to as a “step_value 434” in this example. As an example, the step_value 434 can be expressed as shown by equation 4.1.

$$m = \frac{( {2}^{{c}_{s}} * {f}_{v} )}{{f}_{d}} \qquad ( 4.1 )$$

In equation 4.1, m is the step_value 434, cₛ is the size of the counter circuit 401 (e.g., cₛ=32 bits), fᵥ is the freq_vsync 433, and f_{d} is the freq_disp 432. In an example use case where the desired Vsync frequency (fᵥ) is set to 60 Hz, and the display clock frequency (f_{d}) drifts from 100 MHz to 110 MHz, then the step_value 434 can be computed as shown by table 1.

TABLE 1

| Parameter Values | step_value/correction slope computation |
|---|---|
| fᵥ = 60 Hz; f_{d} = 100 MHz; cₛ = 32 bits. | $m = \frac{( {2}^{32} * 0.00006 )}{100} ≅ 2576$ |
| fᵥ = 60 Hz; f_{d} = 100 MHz; cₛ = 32 bits. | $m = \frac{( {2}^{32} * 0.00006 )}{110} ≅ 2342$ |

The step_value 434 is then fed into Vsync pulse generator logic (e.g., Vsync timer 324), and the Vsync timer 324 does fine correction of slope and eventually aligning the Vsync 334 to the desired frequency and phase. In particular, the Vsync timer 324 includes a step_value register 405, an adder circuit 406, and an accumulation circuit (accumulator) 407. The step_value 434 is stored in a step_value register 405, which is then fed to the adder circuit 406. The adder circuit 406 adds the step_value 434 with a result of a previous accumulation operation (e.g., result 437 provided by accumulator 407), which produces a sum 435. The adder circuit 406 provides the sum 435 to the accumulator 407, which performs arithmetic or logical operation(s) on the sum 435. In some implementations, the accumulator 407 adds or subtracts the sum 435 to/from the dispclk 332 and feeds the result 437 back to the adder circuit 406 for a next computation. Any carry bits 436 are used to adjust the Vsync 334, for example, by adding or subtracting the carry bits 436 to the Vsync 334. Additionally or alternatively, the carry 436 may be a dispclk correction value (e.g., dispcorr 333).

FIG. 4b depicts another example display sync circuit implementation 400b, where like numbered elements operate in the same or similar manner as discussed previously w.r.t FIG. 4a. The display sync circuit implementation 400b includes an app 412 that interacts with the dispclk monitor 323 and the Vsync timer 324. The app 412 may be a universal app executed by individual display systems 101, 301, such as a display driver (e.g., display driver 312 of FIG. 3) or the like. In this example, a system clock 414 periodically triggers 440 the app 412 to begin the display network sync error correction process. In some examples, the app 412 can trigger 440 sync error correction 8 to 16 times in a second. Additionally or alternatively, the system clock 414 can send the trigger 440 to the app 412 in response to a predetermined or configured trigger condition. In some examples, the system clock 414 may be the same or similar as the system clock 514 of FIG. 5. When triggered 440, the app 412 reads the freq_disp 432 from the freq_disp register 402 and reads the freq_vsync 433 from the freq_vsync register 403, and computes the step_value 434. The app 412 then programs the step_value 434 into the step_value register 405.

FIG. 5 depicts an example Network Device Cross-Timestamp platform 500, which demonstrates an example of platform clock relations in platform 500. In this example, the platform 500 includes a network device 526 (also referred to as “NIC 526”), ART circuitry 525 (also referred to as “ART 525”), processor circuitry 502, and an operating system (OS) 510. Additionally, the NIC 526 includes a PTP HW clock (PHC) 527, the processor circuitry 502 includes clock circuitry 552 (e.g., referred to as Time Stamp Counter (TSC) clock 552 in this example), and the OS 510 includes a timekeeping module 512 which includes a system clock 514. In some examples, the platform 500 may be the same or similar to the PS 301-1 and/or SS 301-2 discussed previously. In these examples, the ART 525 corresponds to the ART 325-1 and/or ART 325-2 of FIG. 3, the NIC 526 corresponds to the NIC 326-1 and/or NIC 326-2 of FIG. 3, the PHC 527 corresponds to the PTP timer 327-1 and/or PTP timer 327-2 of FIG. 3, and the OS 510 corresponds to the P-SW 310-1 and/or the S-SW 310-2 of FIG. 3. Additionally or alternatively, the processor circuitry 502 may correspond to the P-HW 320-1 and/or the S-HW 320-2 of FIG. 3, or the display controller 321-1 and/or display controller 321-2. Additionally or alternatively, the processor circuitry 502 may correspond to the processor circuitry 1202 and/or acceleration circuitry 1250 of FIG. 12, and the TSC clock 552 and/or the ART 525 may correspond to the clock circuitry 1252 of FIG. 12. The system clock 514 is maintained by a kernel of the OS 510, while the HW clock (e.g., ART 525) is a physical clock device that is part of or connected to the host platform (e.g., processor circuitry 502). The HW clock is used to maintain time when the system/platform 500 is powered off and/or used to initialize the system clock 514 when the system/platform 500 is booted.

The example of FIG. 5 may be an Intel® Hammock Harbor implementation. Hammock Harbor implementations enable HW to deterministically relate the PTP time to CPU time through hardware cross-timestamps 517, achieving worst-case accuracy of less than hundreds of nanoseconds. Thus, accurate and fine-grained time is readable by SW and/or peripheral devices (e.g., NICs 526, host bus adapters (HBAs), display devices 102, 302, and/or the like) synchronized to time sources (e.g., obtained from GPS/GNSS) communicating over various routers, switches, bridges, access points, base stations, wireless networks, and/or the like. At a high level, the Hammock Hardware approach works as follows: after the PTP/TSN protocol(s) synchronize time to the network adapter 526, periodic timestamps of PTP time and CPU time (e.g., TSC 552 time) are captured simultaneously in HW (e.g., processor 502), making the timestamp pair 517 available to SW (e.g., OS 510 and/or timekeeping entity 512), which then computes a resulting linearity relationship. Given the tight synchronization between TSC 552 across all coherent processor cores and accelerators, this allows cooperating machines synchronized by PTP/TSN to make a common clock immediately available to app SW (e.g., OS 510 and/or timekeeping entity 512).

More specifically, the ART 525 time can be captured simultaneous to the capture of audio and/or network device clocks (e.g., PHC 527 time), allowing a correlation between timebases to be constructed. The TSC clock 552 is derived from the ART 525. Upon capture, the driver converts the captured ART value to the appropriate PHC 527 using a correlated clock source mechanism. For example, a platform hardware clock to system clock app/service (PHC2SYS) triggers the NIC 526 to perform cross-timestamping (see e.g., PHC2SYS provided by NIC driver 313 to NIC 326 in FIG. 3). Here, the NIC 526 records a timestamp of its PHC 527 (e.g., TS-ptp in FIG. 3) and records a timestamp of the ART 525 (e.g., TS-art in FIG. 3) by using sideband messages (e.g., the HH packets in FIG. 3), which are stored as a cross-timestamp 517 data structure inside the NIC 526. The app SW (e.g., OS 510, timekeeping entity 512, and/or PHC2SYS) reads the cross-timestamp 517 and determines a correlation between the ART clock 525 and a PHC 527 based on the cross-timestamp 517. The determined correlation (e.g., linear interpolation) may be based on a fixed relationship between the ART 525 and PHC 527. This process may be repeated according to some interval (e.g., every 8^{th} of a second, every 16^{th} of a second, or the like) and/or based on some trigger conditions.

In some implementations, a TSC 552 to ART 525 relation can be obtained using an instruction referred to as CPU identification (CPUID) leaf 15. For example, the CPUID leaf (0×15) can be used to return parameters m and n as shown by equation 5.1.

TSC=(ART*m)/n+k[n≥1] [Equation 5.1]

In equation 5.1, TSC is a TSC value (e.g., value of the TSC clock 552), ART is an ART value (e.g., a timestamp of ART 525), k is an offset that can adjusted by a privileged agent (IA32_TSC_ADJUST MSR is an example of an interface to adjust k). Additionally or alternatively, the TSC 552 to ART 525 relation is specified in CPUID[15H], as shown by equation 5.2.

TSC=(ART×CPUID[15H]·EBX)÷CPUID[15H]·EAX [Equation 5.2]

In equation 5.2, EAX and EBX represent the values of respective 32-bit general-purpose registers provided for holding items such as, for example, operands for logical and arithmetic operations, operands for address calculations, and memory pointers. In some implementations, EAX is an accumulator for operands and results data, and EBX stores pointer(s) to data in a data-segment. Additionally, CPUID[15H] is a TSC and nominal core crystal clock (CCC) information leaf. Here, the CPUID[15H] represents a value returned by the processor 502 in response to a CPUID instruction with an initial value of 15H. Here, CPUID[15H]. EAX is (or returns) an unsigned integer which is the denominator of a TSC/CCC ratio, and CPUID[15H]. EBX is (or returns) an unsigned integer which is the numerator of the TSC/CCC ratio. The CCC may differ from the reference clock, bus clock, and/or core clock frequencies.

Additionally or alternatively, if CPUID.15H:EBX[31:0]≠0 and CPUID. 80000007:EDX[InvariantTSC]=1, the linearity relationship of equation 5.3 holds between the TSC 552 and the ART 525.

TSC=(ART*CPUID·15H:EBX[31:0])/CPUID·15H:EAX[31:0]+K [Equation 5.3]

In equation 5.3, K is an offset that can be adjusted by a privileged agent. Additionally, when the ART 525 is reset, both the invariant TSC and K are also reset. If EBX[31:0] is 0, the TSC/CCC ratio is not enumerated. Additionally, EBX[31:0]/EAX[31:0] indicates a ratio of the TSC frequency and the CCC frequency. The relationship between the TSC frequency and the CCC frequency is shown by equation 5.4, where TSC_{f} is the TSC frequency, CCC_{f} is the CCC frequency, and EBX/EAX is the TSC frequency to CCC frequency ratio.

TSC_{f}=CCC_{f}*EBX/EAX [Equation 5.4]

The invariant TSC is based on the invariant timekeeping HW (e.g., ART 525), that runs at the core crystal clock frequency. The ratio defined by CPUID leaf 15H expresses the frequency relationship between the ART 525 and TSC 552. The OS system clock 514 is related to the TSC clock 552 using shift/multiply values to compute TSC nominal nanoseconds, as shown by equation 5.5. In equation 5.5, T_{sys} is the system time, Xₘ is the multiply value, and X_{S} is the shift value.

T_{sys}=(TSC×Xₘ)→Xₛ [Equation 5.5]

In various implementations, the platform clock relations for platform 500 may operate as follows. The system clock 514 is read by an app (e.g., app 311-1, 311-2) using clock_gettime( ). The processor clock 552 (e.g., TSC clock 552) value is obtained using a Read Time-Stamp Counter (RDTSC) instruction 515 via a SW interface between the TSC clock 552 and the system clock 514. The timekeeping OS module 512 transforms the processor clock 552 (e.g., TSC clock 552) value into a system clock 514 value. The RDTSC instruction 515 reads the TSC 552 and returns a monotonically increasing unique value whenever executed, except for a 64-bit counter wraparound. The TSC clock 552 is derived from the ART clock 525. The ART clock 525 is the platform clock component of the cross-timestamp 517.

The PHC 527 value is transformed to the system clock 514 by the timekeeping module 512. The PHC2SYS service/program reads the (system, device) clock cross-timestamp 517 using a SYS_OFFSET Input/Output Control (ioctl) system call. The PHC2SYS program is used to synchronize the system clock 514 to the PHC 527 on the NIC 526. The PHC2SYS mechanism works by reading the current time from the PHC 527 and adjusting the system clock 514, accordingly. The SYS_OFFSET ioctl is used to query an offset 505 between the system clock 514 and the HW clock (e.g., PHC 527) on the system/platform 500. When the SYS_OFFSET ioctl is called, the kernel/OS 510 calculates the difference between the system clock 514 and the HW clock (e.g., PHC 527), and returns the result as a signed 64-bit integer value. A positive value indicates that the system clock is ahead of the HW clock (e.g., PHC 527), while a negative value indicates that the HW clock (e.g., PHC 527) is ahead of the system clock 514.

FIG. 6 depicts an example display network sync process 600. Process 600 begins at operation 601, intra-system sync of the PS 301-1 takes place where an app clock (e.g., system clock 514) of the PS 301-1 is sync'd to the PTP GM clock (e.g., PTP timer 327-1). In some implementations, this is accomplished through the PHC2SYS utility. Here, the app 310-1 (or NIC driver 313-1) triggers cross-timestamping through the NIC 326-1, and the NIC 326-1 initiates sideband messaging with the ART 325-1 (see e.g., HH packets in FIG. 3, which are used to obtain the ART timestampes (TS-art)) in Power Management Controller (PMC), and takes cross timestamps between the ART 325-1 and the PTP timer 327-1 simultaneously. The app 310-1 (or NIC driver 313-1) reads two timestamps (e.g., TS-art and TS-ptp in FIG. 3) and computes a correlation over one or more seconds (e.g., 8 times per second) assuming the PTP clock 327-1 is designated as the GM (see e.g., FIGS. 5 and 9-10).

At operation 602, inter-system sync of the SS(s) 301-2 takes place where the secondary NIC(s) 326-2 synchronizes to the PTP GM clock (e.g., PTP timer 327-1 in the example of FIG. 3) through the PTP protocol. In some implementations, the primary app 310-1 triggers/initiates PTP sync messaging through a PTP for Linux (PTP4L) utility. The PTP4L program/service implements the PTP boundary clock and ordinary clock. With HW time stamping PTP4L is used to synchronize the PTP HW clock (e.g., PHC 527 or PTP timer 327-2) to the GM clock (e.g., PTP timer 327-1 in the example of FIG. 3), and with SW time stamping PTP4L synchronizes the system clock (e.g., system clock 514 of an SS) to the GM clock (e.g., PTP timer 327-1 in the example of FIG. 3). Additionally, individual secondary NICs 326-2 synchronize to the primary GM clock (e.g., PTP timer 327-1) through HW and/or through SW based PTP correction.

At operation 603, intra-system sync of the SS(s) 301-2 takes place where the secondary app 310-2 (or secondary app clock 514) synchronizes to the PTP clock 327-2 in a same or similar as discussed previously w.r.t operation 601. In particular, the PHC2SYS utility is triggered and causes the sync of the secondary app clock 514 to the secondary PTP clock 327-2, which is itself synced to the GM PTP clock 327-1 (see e.g., FIGS. 9-10). Additionally or alternatively, the secondary app 310-2 triggers PHC2SYS and syncs to secondary PTP clock 327-2 through HH. At this point all the systems 301 in the display network are synced to each other.

At operation 604, display sync of the PS 301-1 takes place where the display Vsync 334-1 is sync'd to the primary PTP clock 327-1. Here, the primary NIC 326-1 generates a PPS 330-1 with a predefined or configurable frequency or interval (e.g., 125 ms reference frame). This is done by the NIC driver 313-1, which programs PPS registers inside the NIC 326-1 with the predefined or configurable frequency or interval. The PPS 330-1 is routed to the display controller 321-1, which aligns the Vsync 334-1 to the PPS 330-1 (see e.g., process 610). At operation 605, display sync of the SS 301-2 takes place where the display Vsync 334-2 is sync'd to the secondary PTP clock 327-2. Here, the secondary NIC 326-2 generates a PPS 330-2 with a predefined or configurable frequency or interval (e.g., 125 ms reference frame). This is done by the NIC driver 313-2, which programs PPS registers inside the NIC 326-2 with the predefined or configurable frequency or interval. The PPS 330-2 is routed to the display controller 321-2, which aligns the Vsync 334-2 to the PPS 330-2 (see e.g., process 610). After operation 605, process 600 may end or repeat as necessary.

FIG. 6 also depicts process 610 for aligning the Vsync 334 to the PPS 330, which may take place at operations 604 and 605 of process 600. Process 610 begins at operation 611 where a dispclk monitor 323 receives a PPS 330 from a corresponding NIC 326 over interface 306. At operation 612, the dispclk monitor 323 monitors the dispclk 332 and computes the a correction slope or step_value (e.g., dispcorr 333) corresponding to the display clock drift. Additionally or alternatively, this value can be computed by the display driver 312. At operation 613, the dispcorr 333 is fed to Vsync timer 324. The dispcorr 333 loading operation is done across the systems 301 at a precise time in accordance with a reference app clock and/or the GM PTP clock 327. The Vsync timer 324 finely corrects the Vsync slope/signal and within few frames, the Vsync pulse 334 produced by each system 301 are synced to each other in frequency and phase. At operation 614, when an interval or time period ends (e.g., PPS 330), the correction slope or step_value (e.g., dispcorr 333) is computed for a next interval/time period at operation 612. Here, the process of monitoring and correction is done continuously at the predetermined interval to achieve accurate display sync.

FIG. 7 depicts an example content playback process 700, which can be used in a display network, such as those discussed previously. Process 700 begins at operation 701 where the apps startup takes place on PS 301-1 and SS 301-2. At operation 702, the systems 301 are sync'd via PTP/TSN protocols. At operation 703, the PS 301-1 periodically broadcasts a frame number to the SS(s) 301-2. At operation 704, the SS(s) 301-2 drop or repeat frames to match the broadcasted frame number, as needed. At operation 705, at each system 301, the synchronized PPS 330 is routed from NIC 326 to display controller 321. At operation 706, the dispclk monitor 323 determines the clock drift of dispclk 332 w.r.t the reference (e.g., PPS 330). Additionally or alternatively, the display driver 312 determines the correction slope and programs the correction value for Vsync adjustment. At operation 707, the Vsync timer 324 adjusts Vsync 334 based on calculated clock drift, and at operation 708, the Vsync 334 is auto adjusted and compensated for drift. The clock drift monitoring and Vsync adjustment (i.e., operations 706, 707, and 708) take place at each rising edge of the PPS 330 in a continuous fashion. At operation 709, a check of whether the content playback is completed or otherwise ended where the PS 301-1 loops back to operation 702 to continue system sync when the playback is not completed; otherwise process 700 ends when the playback is completed. In other implementations, the PS 301-1 loops back to operation 703 where the PS 301-1 broadcasts another frame number to the SS(s) 301-2 when the playback is not completed; otherwise process 700 ends when the playback is completed. In some implementations, operation 709 is executed or otherwise takes place at predefined or configured intervals, and/or in response to some trigger condition. As examples, the trigger condition may be based on signaling/messages produced by the application layer, signaling/messages produced by an external system/device (e.g., based on user commands and/or the like), an aspect of the content being played, and/or based on any suitable trigger, condition, and/or parameters.

FIG. 8 depicts an example application-level frame sync procedure 800 between a primary content playback app 311-1 on the PS 301-1 and a secondary content playback app 311-2 on the SS 301-2. Here, the apps 311 may be client apps (e.g., web browser, web app, and/or the like), a CMA, or some other suitable app. Besides achieving accurate display synchronization within each system 301, as was discussed previously w.r.t FIGS. 3-7, procedure 800 is used to ensure that content playback apps 311 are synchronized across several systems 301 such that they play or output the same content (or different content that is desired to be played at the same time) at the same time. Here, the expectation is that all systems 301 would start their respective video playback apps 811 when they start up (801a, 801b). As discussed previously, all systems 301 would be connected via PTP/TSN (e.g., [IEEE1588] and/or [IEEE802.1AS]). There is a possibility that the systems 301 start up at different times, and as such, the apps 311 also start playing frames in a completely unsynchronized manner. However, the app 311-1 running on the PS 301-1 would go about broadcasting a frame number (FN) that it is playing or about to play to all SSs 301-2 via the interface 306 (802a). After receiving the frame number (FN), each secondary app 311-2 running on respective SSs 301-2 would first find the difference between the frame that it is currently playing and the one that primary is at (FN) (803a), and then decides to either speed up its own playback (e.g., by skipping one or more frames) or slow down (e.g., by repeating frames) in a user indiscernible manner (804a). In this way, the app 311-2 can catch up or otherwise align with the app 311-1 to achieve frame sync. Due to various factors (e.g., GPU or CPU stress, environmental conditions, and/or the like), it is possible that during playback, an SSs 301-2 gets ahead or behind the PS 301-1. In order to overcome this challenge, the playback app 311-1 running on PS 301-1 periodically broadcasts its frame number (e.g., FN+x where x is a number) that it is on (802b) so that all SSs 301-2 can check if they are in sync with the PS 301-1, and if not, then repeat the same operations discussed previously (803b, 804b), which allows the SSs 301-2 stay in frame sync throughout playback.

### 2. Precision Time Protocol and Time-Aware Network Aspects

TSN and PTP technologies are becoming increasingly important for many applications and use cases, such as industrial automation, autonomous vehicles and drones, AVB sync, and/or the like. The PTP standard (see e.g., IEEE Standard for a Precision Clock Synchronization Protocol for Networked Measurement and Control Systems, IEEE Std 1588-2019 (16 Jun. 2020) (“[IEEE1588]”), the contents of which are hereby incorporated by reference in its entirety) provides precise synchronization of clocks in packet-based networked systems. Synchronization of clocks can be achieved in heterogeneous systems that include clocks of different inherent precision, resolution, and stability. PTP supports synchronization accuracy and precision in the sub-microsecond range with minimal network and local computing resources. Customization is supported by means of profiles. The protocol includes default profiles that permit simple systems to be installed and operated without the need for user management. Sub-nanosecond time transfer accuracy can be achieved in a properly designed network. PTP can be employed to synchronize various systems and/or networks involving, for example, financial transactions, cellular network base station/tower transmissions, sub-sea acoustic sensor arrays, networks that require precise timing but lack access to satellite navigation signals, among many others.

The IEEE TSN standards (e.g., IEEE Standard for Local and Metropolitan Area Networks Timing and Synchronizationfor Time-Sensitive Applications, IEEE Std 802.1AS-2020 (19 Jun. 2020) (“[IEEE802.1AS]”), the contents of which is hereby incorporated by reference in its entirety) specify protocols, procedures, and managed objects used to ensure that the synchronization requirements are met for time-sensitive applications (TSAs), such as AVB and time-sensitive control across networks (see e.g., [IEEE802] and similar media). This includes the maintenance of synchronized time during normal operation and following addition, removal, or failure of network components and network reconfiguration. It specifies the use of [IEEE1588] where applicable in the context of IEEE Standard for Local and Metropolitan Area Network—Bridges and Bridged Networks, IEEE Std 802.1Q-2018, pp.1-1993 (6 Jul. 2018) (“[IEEE802.1Q]”), IEEE Standard for Local and metropolitan area networks-Audio Video Bridging (AVB) Systems, IEEE Std 802.1BA-2021, pp. 1-45 (17 Dec. 2021) (“[IEEE802.1BA]”), IEEE Standard for Local and Metropolitan Area Networks—Virtual Bridged Local Area Networks Amendment 12: Forwarding and Queuing Enhancements for Time—Sensitive Streams, IEEE Std 802.1Qav-2009, pp. C1-72 (5 Jan. 2010) (“[IEEE802.1Qav]”); IEEE Standard for Local and metropolitan area networks—Bridges and Bridged Networks—Amendment 25: Enhancements for Scheduled Traffic, IEEE Std 802.1Qbv-2015, pp. 1-57 (18 Mar. 2018) (“[IEEE802.1Qbv]”); and IEEE Standard for Local and metropolitan area networks—Bridges and Bridged Networks—Amendment 26: Frame Preemption, IEEE Std 802.1Qbu-2016, pp. 1-52, (30 Aug. 2016) (“[IEEE802.1Qbu]”), the contents of each of which are hereby incorporated by reference in their entireties. Synchronization to an externally provided timing signal (e.g., a recognized timing standard such as Coordinated Universal Time (UTC) or International Atomic Time (TAI) timescales). [IEEE802.1AS] enables systems to meet respective jitter, wander, and time-synchronization requirements for TSAs, including those that involve multiple streams delivered to multiple end stations. To facilitate the widespread use of packet networks for these applications, synchronization information is one of the components needed at each network element where TSA data are mapped or de-mapped or a time-sensitive function is performed. Some features provided by TSN are oriented to resource management, reliability, access control, and time synchronization (sync). In particular, TSN access control includes utilizing a traffic shaper (or credit-based shaper) that guarantees the worst-case latency for critical data. TSN time sync uses PTP/gPTP to provide accurate time synchronization across the network.

FIG. 9 illustrates an example time-aware network (TAN) 900, which includes a single gPTP domain. The TAN 900 includes a number of interconnected time-aware systems (TASs) that support one or more timing standards, such as generalized PTP (gPTP), TAI, UTC, GPS time, LORAN time, and/or the like. These TASs can be any networking device, including, for example, bridges 930, routers 932, and end stations 901. A set of TASs that are interconnected by gPTP capable network elements is referred to as a gPTP network.

Each instance of gPTP that a TAS supports is in at least one gPTP domain, and the instances of gPTP are said to be part of that gPTP domain. A gPTP domain (also referred to as a “TSN domain” or simply “domain”) includes one or more PTP instances and links that meet the requirements of [IEEE802.1AS] and/or [IEEE1588], and communicate with each other as defined by the [IEEE802.1AS]. A gPTP domain defines the scope of gPTP message communication, state, operations, data sets, and timescale. Other aspects of gPTP domains are discussed in [IEEE802.1AS] § 8. A TAS can support, and be part of, more than one gPTP domain. The entity of a single TAS that executes gPTP in one gPTP domain is referred to as a PTP instance. A TAS can contain multiple PTP instances, which are each associated with a different gPTP domain. A TSN domain is defined as a quantity of commonly managed industrial automation devices. Here, a TSN domain comprises a set of devices, their ports, and the attached individual LANs that transmit time-sensitive streams using TSN standards, which include, for example, transmission selection algorithms, preemption, time synchronization and enhancements for scheduled traffic and that share a common management mechanism. The grouping of devices into a TSN domain may be based on administrative decision, implementation, and/or use cases involved.

There are two types of PTP instances including PTP end instances (or simply “end instances” or “end nodes”) and PTP relay instances (or simply “relay instances” or “relay nodes”). An end instance, if not a PTP grandmaster (GM) instance (or simply “GM instance”), is a recipient of time information. A relay instance, if not a GM instance, receives time information from the GM instance, applies corrections to compensate for delays in the local area network (LAN) and the relay instance itself, and retransmits the corrected information. The relay instances can receive the time information directly from a GM instance, or indirectly through one or more other relay instances. Delay can be measured using standard-based procedures and/or mechanisms such as, for example, Ethernet using full-duplex point-to-point links, Ethernet Passive Optical Network (EPON) links (see e.g., [IEEE802.3]), the contents of which are hereby incorporated by reference in its entirety), [IEEE80211] wireless, generic coordinated shared networks (CSNs), for example, MoCA, G.hn, delay measurement mechanisms (see e.g., [IEEE1588] and [IEEE802.1AS]), and the White Rabbit (WR) link delay model (see e.g., Lipiński et al., White Rabbit: a PTP Application for Robust Sub-nanosecond Synchronization, IEEE International Symposium on Precision Clock Synchronization for Measurement, Control and Communication (ISPCS), pp. 25-30 (12 Sep. 2011), the contents of which are hereby incorporated by reference in its entirety), and/or using any other suitable mechanism, such as those discussed herein.

In some examples, the TAN 900 may be part of, or used in various use cases such as any of the example use cases discussed herein and/or those discussed in Belliardi et al., Use Cases IEC/IEEE 60802, version (V) 1.3 (13 Sep. 2018), the contents of which is hereby incorporated by reference in its entirety. The TAN 900 uses some or all of the aforementioned above network technologies, where end stations on several local networks are connected to a GM instance on a backbone network via an EPON access network. In the TAN 900, the bridges 930 and routers 932 are examples of TASs that each contain a relay instance, and the end stations 901 are time-aware systems that contain at least one PTP end instance. The end stations 901 are also connected to (or include) respective clock target entities 902. A clock target entity 902 represents any application that uses information provided by the secondary clock entity (e.g., Clocks 1012 of FIG. 10) via an application interface.

Any PTP instance with clock sourcing capabilities can be a potential GM instance, and a selection method (e.g., the best master clock algorithm (BMCA)) ensures that all of the PTP instances in a gPTP domain use the same GM instance. In this example, the bridge 930g (current GM instance) and end station 901g (potential GM) are GM-capable stations. The bridge 930g is connected to, or is otherwise capable of accessing a clock source 950, which is an entity that can be used as an external timing source for the gPTP domain. The clock source entity 950 either contains or has access to a clock. Additionally or alternatively, a steady state GM selection strategy may be used where GM-capable stations advertise their GM-capabilities via announce messages. When a subject GM-capable station obtains an announce message from another GM-capable station with a “better” clock entity, the subject GM-capable station does not send it's an announce message. There may be a settable priority field in the announce message that can override clock quality, and GM-capable station determine the “better” clock entity using a bitwise compare or some other suitable mechanism. Additionally, a suitable tie breaking method can be used where two GM-capable stations have the same priority (e.g., a MAC address-based tie breaker algorithm and/or the like). Bridges 930 (and/or routers 932) drop all inferior announce messages, and forward only the best (e.g., highest priority) announce messages to other PTP instances. A remaining GM-capable station (e.g., a GM-capable station whose announce message is not dropped) is considered to be the GM instance for the TAN 900. The GM instance is the root of the [IEEE802.1AS] timing tree, and sends a current time (e.g., in time sync messages) for synchronizing the various nodes/instances in the TAN 900. The GM instance may send the current time on a periodic basis and/or in response to some detected event (or trigger condition). Bridges 930 (and/or routers 932) in the timing tree propagate timing messages toward the leaves of the timing tree (e.g., other PTP instances/nodes in the TAN 900) taking queuing delay into account (referred to as “residence time”). Additional aspects of GM selection, synchronization, and/or other like timing aspects are discussed in [IEEE802.1AS], [IEEE1588], and Stanton, Tutorial: The Time-Synchronization Standard from the AVB TSN suite IEEE Std 802.11AS™-2011 (and following), IEEE PLENARY, San Diego Calif., July 2014 (July 2014), the contents of which is hereby incorporated by reference in its entirety.

In some implementations, there can be short periods during network reconfiguration when more than one GM instance might be active while the BMCA process is taking place. BMCA may be the same or similar to that used in [IEEE1588], but can be somewhat simplified in some implementations. In FIG. 9, the BMCA process has resulted in the GM instance being on the network backbone. If, however, the access network fails, the systems on a local network automatically switch over to one of the potential GM instances on the local network that is as least as “good” as any other. For example, when an access network link fails, and a potential GM instance that has a GNSS reference source has become the active GM instance, then two gPTP domains may exist where there used to be one.

When the TAN 900 includes multiple gPTP domains that could be used, some of the gPTP domains may use the PTP timescale and one or more other domains may use another timescale such as the arbitrary (ARB) timescale. Additionally or alternatively, some or all PTP instances belonging to the same domain may have direct connections among them in their physical topology (e.g., time cannot be transported from one PTP instance in a first domain to another PTP instance that same domain via a TAS that does not have that domain active). As in the single-domain case, any of the network technologies discussed herein can be used. The GM instance of each domain is selected by BMCA where a separate, independent BMCA instance is invoked in each domain.

The timescale for a gPTP domain is established by the GM clock. There are two types of timescales supported by gPTP including a timescale PTP and a timescale arbitrary (ARB). For timescale PTP, the epoch is the PTP epoch (see e.g., [IEEE802.1AS] § 8.2.2), and the timescale is continuous. The unit of measure of time is the second defined by International Atomic Time (TAI). For timescale ARB, the epoch is the domain startup time and can be set by an administrative procedure. Between invocations of the administrative procedure, the timescale is continuous. Additional invocations of the administrative procedure can introduce discontinuities in the overall timescale. The unit of measure of time is determined by the GM Clock. The second used in the operation of the protocol can differ from the SI second. The “epoch” at least in some examples refers to the origin of the timescale of a gPTP domain. The PTP epoch (epoch of the timescale PTP) is 1 Jan. 1970 00:00:00 TAI (see e.g., Annex C of [IEEE802.1AS] for information on converting between common timescales).

The communications in the TAN 900 occur via PTP messages and/or media-specific messages. The PTP messages may be any suitable datagram or protocol data unit (PDU). These messages may have the following attributes: message class and message type. The message type attribute indicates a type or name of a particular message such as “sync”, “announce”, “time measurement frame”, and/or the like (see e.g., [IEEE802.1AS] § 3.18).

There are two message classes, the event message class and the general message class. General messages are not timestamped whereas event messages are timestamped on egress from a PTP instance and ingress to a PTP instance. The timestamp is the time, relative to the LocalClock entity (see e.g., LocalClock entity 1015 of FIG. 10 and [IEEE802.1AS] § 10.1) at which the message timestamp point passes the reference plane marking the boundary between the PTP instance and the network media. The definition of the timestamp measurement plane (see e.g., [IEEE802.1AS] § 3.33), along with the corrections defined as follows, allows transmission delays to be measured in such a way (at such a low layer) that they appear fixed and symmetrical to gPTP even though the MAC client might otherwise observe substantial asymmetry and transmission variation. For example, the timestamp measurement plane is located below any retransmission and queuing performed by the MAC.

Additionally, the PTP instances in a gPTP domain interface with the network media via physical ports. gPTP defines a logical port (e.g., a PTP port) in such a way that communication between PTP instances is point-to-point even over physical ports that are attached to shared media. One logical port, consisting of one PortSync entity and one media-dependent (MD) entity, is instantiated for each PTP instance with which the PTP instance communicates. For shared media, multiple logical ports can be associated with a single physical port. Additional aspects of the PTP ports are discussed in section 8.5 of [IEEE802.1AS].

Although the TAN 900 is described as being implemented according to gPTP, the embodiments discussed herein are also applicable to PTP implementations. In gPTP there are only two types of PTP instances: PTP end instances and relay instances, while [IEEE1588] has ordinary clocks (OCs), boundary clocks (BCs), end-to-end (e2e) transparent clocks (TCs), and P2P TCs. An OC is a clock that has only one port, and can be PS or SS. A BC is a clock with multiple ports, and can be designated as a PS on one port and SS on another port. The top-level PS is called the GM clock, which can be synchronized by using a GNSS/GPS time source or some other reference timing source. A PTP end instance corresponds to an OC in [IEEE1588], and a relay instance is a type of [IEEE1588] BC where its operation is very tightly defined, so much so that a relay instance with Ethernet ports can be shown to be mathematically equivalent to a P2P TC in terms of how synchronization is performed (see e.g., [IEEE802.1AS] § 11.1.3). In addition, a relay instance can operate in a mode (e.g., the mode where the variable syncLocked is TRUE; see e.g., [IEEE802.1AS] § 10.2.5.15) where the relay instance is equivalent to a P2P TC in terms of when time-synchronization messages are sent. A TAS measures link delay and residence time and communicates these in a correction field. In summary, a relay instance conforms to the specifications for a BC in [IEEE1588]-based systems, but a relay instance does not conform to the complete specifications for a P2P TC in [IEEE1588] because when syncLocked is FALSE, the relay instance sends Sync according to the specifications for a BC, and the relay instance invokes the BMCA and has PTP port states. Furthermore, gPTP communications between PTP instances is done using IEEE 802 MAC PDUs and addressing, while [IEEE1588] supports various layer 2 and layer 3-4 communication methods.

FIG. 10 depicts an example PTP instance model 1000. The PTP instance model 1000 includes a time-aware higher-layer application 1005, a media independent layer 1001 and one or more media dependent entities 1022 within a media dependent layer 1002. The time-aware higher-layer app 1005 is a TSA and/or any application that utilizes the time-aware aspects of a TAN 900 and/or the like. Examples of such apps 1005 include audio, video, time-sensitive control apps, network apps, network functions, and/or other like apps.

If the PTP instance includes app(s) 1005 that either use or source time information, then they interface with the gPTP information using the application interfaces specified in clause 9 of [IEEE802.1AS]. These interfaces include a ClockSourceTime interface, which provides external timing to the PTP instance, a ClockTargetEventCapture interface, which returns the synchronized time of an event signaled by a ClockTarget entity, a ClockTargetTriggerGenerate interface, which causes an event to be signaled at a synchronized time specified by a ClockTarget entity, a ClockTargetClockGenerator interface, which causes a periodic sequence of results to be generated, with a phase and rate specified by a ClockTarget entity, and a ClockTargetPhaseDiscontinuity interface, which supplies information that an application can use to determine if a discontinuity in GM Clock phase or frequency has occurred.

The single media-independent part 1001 includes a main clock (Clock_{M}) 1011 (sometimes referred to as a “ClockMaster”), a secondary clock (Clocks) 1012 (sometimes referred to as a “ClockSlave”), and SiteSync logical entities 1013, one or more PortSync entities 1014, and a LocalClock entity 1015. The BMCA and forwarding of time information between logical ports and the and Clock_{M} 1011 is done by the SiteSync entity 1013, while the computation of PTP port-specific delays needed for time-synchronization correction is done by the PortSync entities 1014.

The PTP Instance has a LocalClock entity (e.g., Clock_{M} 1011 and/or Clocks 1012), which can be a free-running clock circuitry (e.g., a quartz crystal or any other clock technology, such as any of those discussed herein) that meets the requirements of [IEEE802.3], but could also be better than those requirements. There can be a ClockSource entity (e.g., timing taken from positioning circuitry 1275 of FIG. 12), available in the local system that provides timing to the ClockSource entity. The time provided by the PTP instance, if it is the GM PTP instance, is reflected by the combination of these two entities, and the clockClass reflects this combination as specified [IEEE1588] § 7.6.2.5. The clockClass attribute denotes the traceability of the synchronized time distributed by a ClockMaster when it is the GM PTP instance. For example, when the LocalClock entity uses a quartz oscillator that meets the requirements of [IEEE802.3] and [IEEE802.1AS] § B.1, clockClass is set to 248. But, if a GNSS receiver is present and synchronizes the PTP Instance, then the clockClass is set to the value 6, indicating traceability to a primary reference time source (see e.g., [IEEE1588] § 7.6.2.5).

The media dependent layer 1002 includes a protocol stack including media-dependent (MD) ports 1020 disposed on a logical link control (LLC) layer, which is separated from the one or more media dependent entities 1022 by a MAC Service (MS). The media dependent entities 1022 is connected to a media access control (MAC) layer by an Internal Sublayer Service (ISS), and the MAC layer is disposed on a physical (PNY) layer. MD ports 1020, which translate the abstract “MDSyncSend” and “MDSyncReceive” structures/signals received from or sent to the media-independent layer and corresponding methods used for the particular LAN attached to the port.

For full-duplex Ethernet ports, [IEEE1588] Sync and Follow_Up (or just Sync if the optional one-step processing is enabled) messages are used, with an additional TLV in the Follow_Up (or the Sync if the optional one-step processing is enabled) used for communication of the RR and information on phase and frequency change when there is a change in GM instance. The path delay (pDelay) is measured using the two-step [IEEE1588] P2P delay mechanism. This is defined in [IEEE802.1AS] § 11.

For [IEEE80211] ports, timing information is communicated using the MAC Layer Management Entity to request a “Timing Measurement” or “Fine Timing Measurement” (as defined in [IEEE80211]), which also sends everything that would be included in the Follow_up message for full-duplex Ethernet. The Timing Measurement or Fine Timing Measurement result includes all the information to determine the path delay. This is defined in [IEEE802.1AS] § 12. For EPON, timing information is communicated using a “slow protocol” as defined in [IEEE802.1AS] § 13. CSNs use the same communication system used by full-duplex Ethernet, as defined in [IEEE802.1AS] § 16.

### 3. Computing System Configurations and Arrangements

FIG. 11 illustrates an example edge computing environment 1100 including different layers of communication, starting from an endpoint layer 1110a (also referred to as “sensor layer 1110a”, “things layer 1110a”, or the like) including one or more IoT devices 1111 (also referred to as “endpoints 1110a” or the like) (e.g., in an Internet of Things (IoT) network, wireless sensor network (WSN), fog, and/or mesh network topology); increasing in sophistication to intermediate layer 1110b (also referred to as “client layer 1110b”, “gateway layer 1110b”, or the like) including various user equipment (UEs) 1112a, 1112b, and 1112c (also referred to as “intermediate nodes 1110b” or the like), which may facilitate the collection and processing of data from endpoints 1110a; increasing in processing and connectivity sophistication to access layer 1130 including a set of network access nodes (NANs) 1131, 1132, and 1133 (collectively referred to as “NANs 1130” or the like); increasing in processing and connectivity sophistication to edge layer 1137 including a set of edge compute nodes 1136a-c (collectively referred to as “edge compute nodes 1136” or the like) within an edge computing framework 1135 (also referred to as “ECT 1135” or the like); and increasing in connectivity and processing sophistication to a backend layer 1140 including core network (CN) 1142, cloud 1144, and server(s) 1150. The processing at the backend layer 1140 may be enhanced by network services as performed by one or more remote servers 1150, which may be, or include, one or more CN functions, cloud compute nodes or clusters, app servers, and/or other like systems and/or devices. Some or all of these elements may be equipped with or otherwise implement some or all features and/or functionality discussed herein.

The environment 1100 is shown to include end-user devices such as intermediate nodes 1110b and endpoint nodes 1110a, which are configured to connect to (or communicatively couple with) one or more communication networks (also referred to as “access networks,” “radio access networks,” or the like) based on different access technologies (or “radio access technologies”) for accessing application, edge, and/or cloud services. Examples of such access technologies (or “radio access technologies”) are discussed section 5 infra. For purposes of the present disclosure, the terms “node 1110”, “UE 1110”, and/or the like may refer to any of the endpoint nodes 1110a, any of the intermediate nodes 1110b, and/or both any of the endpoint nodes 1110a and any of the intermediate nodes 1110b unless the context dictates otherwise. These access networks may include one or more NANs 1130, which are arranged to provide network connectivity to the UEs 1110 via respective links 1103a and/or 1103b (collectively referred to as “channels 1103”, “links 1103”, “connections 1103”, and/or the like) between individual NANs 1130 and respective UEs 1110.

As examples, the communication networks and/or access technologies may include cellular technology such as LTE, MuLTEfire, and/or NR/5G (e.g., as provided by Radio Access Network (RAN) node 1131 and/or RAN nodes 1132), WiFi or wireless local area network (WLAN) technologies (e.g., as provided by access point (AP) 1133 and/or RAN nodes 1132), and/or the like. Different technologies exhibit benefits and limitations in different scenarios, and application performance in different scenarios becomes dependent on the choice of the access networks (e.g., WiFi, LTE, and/or the like) and the used network and transport protocols (e.g., Transfer Control Protocol (TCP), Virtual Private Network (VPN), Multi-Path TCP (MPTCP), Generic Routing Encapsulation (GRE), and/or the like).

The intermediate nodes 1110b include UE 1112a, UE 1112b, and UE 1112c (collectively referred to as “UE 1112” or “UEs 1112”). In this example, the UE 1112a is illustrated as a vehicle system (also referred to as a vehicle UE or vehicle station), UE 1112b is illustrated as a smartphone (e.g., handheld touchscreen mobile computing device connectable to one or more cellular networks), and UE 1112c is illustrated as a flying drone or unmanned aerial vehicle (UAV). However, the UEs 1112 may be any mobile or non-mobile computing device, such as desktop computers, workstations, laptop computers, tablets, wearable devices, PDAs, pagers, wireless handsets smart appliances, single-board computers (SBCs) (e.g., Raspberry Pi™, Arduino™ Intel® Edison™ boards, and/or the like), computer-on-module (COM), system-on-module (SOM), plug computers, and/or any type of computing device such as any of those discussed herein. In some examples, some or all of the UEs 1112 correspond to AVB systems, display devices 102 of display systems 101, compute elements 103, PS 301-1, SS 301-2, and/or any other computing device discussed herein.

The endpoints 1110a include UEs 1111, which may be IoT devices (also referred to as “IoT devices 1111”), which are uniquely identifiable embedded computing devices (e.g., within the Internet infrastructure) that comprise a network access layer designed for low-power IoT applications utilizing short-lived UE connections. The IoT devices 1111 are any physical or virtualized, devices, sensors, or “things” that are embedded with HW and/or SW components that enable the objects, devices, sensors, or “things” capable of capturing and/or recording data associated with an event, and capable of communicating such data with one or more other devices over a network with little or no user intervention. As examples, IoT devices 1111 may be abiotic devices such as autonomous sensors, gauges, meters, image capture devices, microphones, light emitting devices, audio emitting devices, audio and/or video playback devices, electro-mechanical devices (e.g., switch, actuator, and/or the like), EEMS, ECUs, ECMs, embedded systems, microcontrollers, control modules, networked or “smart” appliances, MTC devices, M2M devices, and/or the like. The IoT devices 1111 can utilize technologies such as M2M or MTC for exchanging data with one or more MTC servers (e.g., app servers 1150, cloud servers in cloud 1144, NFs in CN 1142 and/or the like), edge server(s) 1136 and/or ECT 1135, or device via a PLMN, ProSe or D2D communication, sensor networks, or IoT networks. The M2M or MTC exchange of data may be a machine-initiated exchange of data.

The IoT devices 1111 may execute background applications (e.g., keep-alive messages, status updates, and/or the like) to facilitate the connections of the IoT network. Where the IoT devices 1111 are, or are embedded in, sensor devices, the IoT network may be a WSN. An IoT network describes an interconnecting IoT UEs, such as the IoT devices 1111 being connected to one another over respective direct links 1105. The IoT devices may include any number of different types of devices, grouped in various combinations (referred to as an “IoT group”) that may include IoT devices that provide one or more services for a particular user, customer, organizations, and/or the like. A service provider (e.g., an owner/operator of server(s) 1150, CN 1142, and/or cloud 1144) may deploy the IoT devices in the IoT group to a particular area (e.g., a geolocation, building, and/or the like) in order to provide the one or more services. In some implementations, the IoT network may be a mesh network of IoT devices 1111, which may be termed a fog device, fog system, or fog, operating at the edge of the cloud 1144. In some examples, the UEs 1111 correspond to one or more display systems 101, display devices 102, compute elements 103, PS 301-1, SS 301-2, and/or any other computing device discussed herein.

As mentioned previously, the access networks provide network connectivity to the end-user devices 1120, 1110 via respective NANs 1130. The access networks may be Radio Access Networks (RANs) such as an NG RAN or a 5G RAN for a RAN that operates in a 5G/NR cellular network, an E-UTRAN for a RAN that operates in an LTE or 4G cellular network, or a legacy RAN such as a UTRAN or GERAN for GSM or CDMA cellular networks. The access network or RAN may be referred to as an Access Service Network for Worldwide Interoperability for Microwave Access (WiMAX) implementations (see e.g., IEEE Standard for Air Interface for Broadband Wireless Access Systems, IEEE Std 802.16-2017, pp.1-2726 (2 Mar. 2018) (“[WiMAX]”)). Additionally or alternatively, all or parts of the RAN may be implemented as one or more SW entities running on server computers as part of a virtual network, which may be referred to as a cloud RAN (CRAN), Cognitive Radio (CR), a virtual baseband unit pool (vBBUP), and/or the like. Additionally or alternatively, the CRAN, CR, or vBBUP may implement a RAN function split, wherein one or more communication protocol layers are operated by the CRAN/CR/vBBUP and other communication protocol entities are operated by individual RAN nodes 1131, 1132. This virtualized framework allows the freed-up processor cores of the NANs 1131, 1132 to perform other virtualized applications, such as virtualized applications for various elements discussed herein. The Radio Access Technologies (RATs) employed by the NANs 1130, the UEs 1110, and the other elements in FIG. 11 may include, for example, any of the communication protocols and/or RATs discussed herein.

The UEs 1110 may utilize respective connections (or channels) 1103a, each of which comprises a physical communications interface or layer. The connections 1103a are illustrated as an air interface to enable communicative coupling consistent with cellular communications protocols, such as 3GPP LTE, 5G/NR, Push-to-Talk (PTT) and/or PTT over cellular (POC), UMTS, GSM, CDMA, and/or any of the other communications protocols discussed herein. Additionally or alternatively, the UEs 1110 and the NANs 1130 communicate data (e.g., transmit and receive) data over a licensed medium (also referred to as the “licensed spectrum” and/or the “licensed band”) and an unlicensed shared medium (also referred to as the “unlicensed spectrum” and/or the “unlicensed band”). To operate in the unlicensed spectrum, the UEs 1110 and NANs 1130 may operate using LAA, enhanced LAA (eLAA), and/or further eLAA (feLAA) mechanisms. The UEs 1110 may further directly exchange communication data via respective direct links 1105, which may be LTE/NR Proximity Services (ProSe) link or PC5 interfaces/links, or WiFi based links or a personal area network (PAN) based links (e.g., [IEEE802154] based protocols including ZigBee, IPv6 over Low power Wireless Personal Area Networks (6LoWPAN), WirelessHART, MiWi, Thread, and/or the like; WiFi-direct; Bluetooth/Bluetooth Low Energy (BLE) protocols).

Additionally or alternatively, individual UEs 1110 provide radio information to one or more NANs 1130 and/or one or more edge compute nodes 1136 (e.g., edge servers/hosts, and/or the like). The radio information may be in the form of one or more measurement reports, and/or may include, for example, signal strength measurements, signal quality measurements, and/or the like. Each measurement report is tagged with a timestamp and the location of the measurement (e.g., the UEs 1110 current location). As examples, the measurements collected by the UEs 1110 and/or included in the measurement reports may include one or more measurements discussed in 3GPP TS 36.214 v16.2.0 (2021-03-31) (“[TS36214]”), 3GPP TS 38.215 v16.4.0 (2021-01-08) (“[TS38215]”), 3GPP TS 38.314 v16.4.0 (2021-09-30) (“[TS38314]”), IEEE Standard for Information Technology—Telecommunications and Information Exchange between Systems—Local and Metropolitan Area Networks—Specific Requirements—Part II: Wireless LANMedium Access Control (MAC) and Physical Layer (PHY) Specifications, IEEE Std 802.11-2020, pp. 1-4379 (26 Feb. 2021) (“[IEEE80211]”), and/or the like. In any of the examples discussed herein, any suitable data collection and/or measurement mechanism(s) may be used to collect the observation data. For example, data marking (e.g., sequence numbering, and/or the like), packet tracing, signal measurement, data sampling, and/or timestamping techniques may be used to determine any of the aforementioned metrics/observations. The collection of data may be based on occurrence of events that trigger collection of the data. Additionally or alternatively, data collection may take place at the initiation or termination of an event. The data collection can be continuous, discontinuous, and/or have start and stop times. The data collection techniques/mechanisms may be specific to a HW configuration/implementation or non-HW-specific, or may be based on various SW parameters (e.g., OS type and version, and/or the like). Various configurations may be used to define any of the aforementioned data collection parameters. Such configurations may be defined by suitable specifications/standards, such as 3GPP (e.g., [SA6Edge]), ETSI (e.g., [MEC]), O-RAN (e.g., [O-RAN]), Intel® Smart Edge Open (formerly OpenNESS) (e.g., [ISEO]), IETF (e.g., [MAMS]), IEEE/WiFi (e.g., [IEEE80211], [WiMAX], IEEE Guide for Wireless Access in Vehicular Environments (WAVE) Architecture, IEEE Std 1609.0-2019 (10 Apr. 2019) (“[IEEE16090]”), and/or the like), and/or any other like standards such as those discussed herein.

The UE 1112b is shown as being capable of accessing access point (AP) 1133 via a connection 1103b. In this example, the AP 1133 is shown to be connected to the Internet without connecting to the CN 1142 of the wireless system. The connection 1103b can comprise a local wireless connection, such as a connection consistent with any [IEEE802] protocol (e.g., [IEEE80211] and variants thereof), wherein the AP 1133 comprise a WiFi station (e.g., router, bridge, and/or the like). Additionally or alternatively, the UEs 1110 can be configured to communicate using suitable communication signals with each other or with any of the AP 1133 over a single or multicarrier communication channel in accordance with various communication techniques, such as, but not limited to, an OFDM communication technique, a single-carrier frequency division multiple access (SC-FDMA) communication technique, and/or the like, although the scope of the present disclosure is not limited in this respect. The communication technique may include a suitable modulation scheme such as Complementary Code Keying (CCK); Phase-Shift Keying (PSK) such as Binary PSK (BPSK), Quadrature PSK (QPSK), Differential PSK (DPSK), and/or the like; or Quadrature Amplitude Modulation (QAM) such as M-QAM; and/or the like.

The one or more NANs 1131 and 1132 that enable the connections 1103a may be referred to as “RAN nodes” or the like. The RAN nodes 1131, 1132 may comprise ground stations (e.g., terrestrial access points) or satellite stations providing coverage within a geographic area (e.g., a cell). The RAN nodes 1131, 1132 may be implemented as one or more of a dedicated physical device such as a macrocell base station, and/or a low power base station for providing femtocells, picocells or other like cells having smaller coverage areas, smaller user capacity, or higher bandwidth compared to macrocells. In this example, the RAN node 1131 is embodied as a NodeB, evolved NodeB (eNB), or a next generation NodeB (gNB), and the RAN nodes 1132 are embodied as relay nodes, distributed units, or Road Side Unites (RSUs). Any other type of NANs can be used.

The NANs 1131, 1132 may be configured to communicate with one another via respective interfaces or links (not shown), such as an X2 interface for LTE implementations (e.g., when CN 1142 is an Evolved Packet Core (EPC)), an Xn interface for 5G or NR implementations (e.g., when CN 1142 is an Fifth Generation Core (5GC)), or the like. The NANs 1131 and 1132 are also communicatively coupled to CN 1142. Additionally or alternatively, the CN 1142 may be an evolved packet core (EPC), a NextGen Packet Core (NPC), a 5G core (5GC), and/or some other type of CN. The CN 1142 is a network of network elements and/or network functions (NFs) relating to a part of a communications network that is independent of the connection technology used by a terminal or user device. The CN 1142 comprises a plurality of network elements/NFs configured to offer various data and telecommunications services to customers/subscribers (e.g., users of UEs 1112 and IoT devices 1111) who are connected to the CN 1142 via a RAN. The components of the CN 1142 may be implemented in one physical node or separate physical nodes including components to read and execute instructions from a machine-readable or computer-readable medium (e.g., a non-transitory machine-readable storage medium). Additionally or alternatively, Network Functions Virtualization (NFV) may be utilized to virtualize any or all of the above-described network node functions via executable instructions stored in one or more computer-readable storage mediums (described in further detail infra). A logical instantiation of the CN 1142 may be referred to as a network slice, and a logical instantiation of a portion of the CN 1142 may be referred to as a network sub-slice. NFV architectures and infrastructures may be used to virtualize one or more network functions, alternatively performed by proprietary HW, onto physical resources comprising a combination of industry-standard server HW, storage HW, or switches. In other words, NFV systems can be used to execute virtual or reconfigurable implementations of one or more CN 1142 components/functions.

The CN 1142 is shown to be communicatively coupled to an application server 1150 and a network 1150 via an IP communications interface 1155. the one or more server(s) 1150 comprise one or more physical and/or virtualized systems for providing functionality (or services) to one or more clients (e.g., UEs 1112 and IoT devices 1111) over a network. The server(s) 1150 may include various computer devices with rack computing architecture component(s), tower computing architecture component(s), blade computing architecture component(s), and/or the like. The server(s) 1150 may represent individual servers, a cluster of servers, a server farm, a cloud computing service, a data center, and/or other grouping or pool of servers. Generally, the server(s) 1150 offer applications or services that use IP/network resources. As examples, the server(s) 1150 may provide traffic management services, cloud analytics, content streaming services, immersive gaming experiences, social networking and/or microblogging services, communication services (e.g., Voice-over-Internet Protocol (VoIP) sessions, PTT sessions, group communication sessions, social networking services, and/or the like), initiating and controlling SW and/or FW updates for applications or individual components implemented by the UEs 1110, and/or other like services.

The cloud 1144 may represent a cloud computing architecture/platform that provides one or more cloud computing services. Cloud computing refers to a paradigm for enabling network access to a scalable and elastic pool of shareable computing resources with self-service provisioning and administration on-demand and without active management by users. Computing resources (or simply “resources”) are any physical or virtual component, or usage of such components, of limited availability within a computer system or network. Examples of resources include usage/access to, for a period of time, servers, processor(s), storage equipment, memory devices, memory areas, networks, electrical power, input/output (peripheral) devices, mechanical devices, network connections (e.g., channels/links, ports, network sockets, and/or the like), operating systems, virtual machines (VMs), SW/applications, computer files, and/or the like. Cloud computing provides cloud computing services (or cloud services), which are one or more capabilities offered via cloud computing that are invoked using a defined interface (e.g., an API or the like). Some capabilities of cloud 1144 include application capabilities type, infrastructure capabilities type, and platform capabilities type. A cloud capabilities type is a classification of the functionality provided by a cloud service to a cloud service customer (e.g., a user of cloud 1144), based on the resources used. The application capabilities type is a cloud capabilities type in which the cloud service customer can use the cloud service provider's applications; the infrastructure capabilities type is a cloud capabilities type in which the cloud service customer can provision and use processing, storage or networking resources; and platform capabilities type is a cloud capabilities type in which the cloud service customer can deploy, manage and run customer-created or customer-acquired applications using one or more programming languages and one or more execution environments supported by the cloud service provider.

Additionally or alternatively, the cloud 1144 may represent one or more cloud servers, application servers, web servers, and/or some other remote infrastructure. The remote/cloud servers may include any one of a number of services and capabilities such as, for example, any of those discussed herein. Additionally or alternatively, the cloud 1144 may represent a network such as the Internet, a local area network (LAN), a wide area network (WAN), a wireless local area network (WLAN), or a wireless wide area network (WWAN) including proprietary and/or enterprise networks for a company or organization, or combinations thereof. The cloud 1144 may be a network that comprises computers, network connections among the computers, and SW routines to enable communication between the computers over network connections. In this regard, the cloud 1144 comprises one or more network elements that may include one or more processors, communications systems (e.g., including network interface controllers, one or more transmitters/receivers connected to one or more antennas, and/or the like), and computer readable media. Examples of such network elements may include wireless access points (WAPs), home/business servers (with or without RF communications circuitry), routers, switches, hubs, radio beacons, base stations, picocell or small cell base stations, backbone gateways, and/or any other like network device. Connection to the cloud 1144 may be via a wired or a wireless connection using the various communication protocols discussed infra. More than one network may be involved in a communication session between the illustrated devices. Connection to the cloud 1144 may require that the computers execute SW routines which enable, for example, the seven layers of the OSI model of computer networking or equivalent in a wireless (cellular) phone network. Cloud 1144 may be used to enable relatively long-range communication such as, for example, between the one or more server(s) 1150 and one or more UEs 1110. Additionally or alternatively, the cloud 1144 may represent the Internet, one or more cellular networks, local area networks, or wide area networks including proprietary and/or enterprise networks, TCP/Internet Protocol (IP)-based network, or combinations thereof. In these implementations, the cloud 1144 may be associated with network operator who owns or controls equipment and other elements necessary to provide network-related services, such as one or more base stations or access points, one or more servers for routing digital data or telephone calls (e.g., a core network or backbone network), and/or the like. The backbone links 1155 may include any number of wired or wireless technologies, and may be part of a LAN, a WAN, or the Internet. In one example, the backbone links 1155 are fiber backbone links that couple lower levels of service providers to the Internet, such as the CN 1112 and cloud 1144.

As shown by FIG. 11, each of the NANs 1131, 1132, and 1133 are co-located with edge compute nodes (or “edge servers”) 1136a, 1136b, and 1136c, respectively.

Edge computing refers to the implementation, coordination, and use of computing and resources at locations closer to the “edge” or collection of “edges” of a network. Deploying computing resources at the network's edge may reduce application and network latency, reduce network backhaul traffic and associated energy consumption, improve service capabilities, improve compliance with security or data privacy requirements (especially as compared to conventional cloud computing), and improve total cost of ownership. Individual compute platforms or other components that can perform edge computing operations (referred to as “edge compute nodes,” “edge nodes,” or the like) can reside in whatever location needed by the system architecture or ad hoc service. In many edge computing architectures, edge nodes are deployed at NANs, gateways, network routers, and/or other devices that are closer to endpoint devices (e.g., UEs, IoT devices, and/or the like) producing and consuming data. As examples, edge nodes may be implemented in a high performance compute data center or cloud installation; a designated edge node server, an enterprise server, a roadside server, a telecom central office; or a local or peer at-the-edge device being served consuming edge services. Edge compute nodes may partition resources (e.g., memory, CPU, GPU, interrupt controller, I/O controller, memory controller, bus controller, network connections or sessions, and/or the like) where respective partitionings may contain security and/or integrity protection capabilities. Edge nodes may also provide orchestration of multiple applications through isolated user-space instances such as containers, partitions, virtual environments (VEs), virtual machines (VMs), Function-as-a-Service (FaaS) engines, Servlets, servers, and/or other like computation abstractions. Containers are contained, deployable units of SW that provide code and needed dependencies. Various edge system arrangements/architecture treats VMs, containers, and functions equally in terms of application composition. The edge nodes are coordinated based on edge provisioning functions, while the operation of the various applications are coordinated with orchestration functions (e.g., VM or container engine, and/or the like). The orchestration functions may be used to deploy the isolated user-space instances, identifying and scheduling use of specific HW, security related functions (e.g., key management, trust anchor management, and/or the like), and other tasks related to the provisioning and lifecycle of isolated user spaces. Applications that have been adapted for edge computing include but are not limited to virtualization of traditional network functions including include, for example, SW-Defined Networking (SDN), Network Function Virtualization (NFV), distributed RAN units and/or RAN clouds, and the like. Additional example use cases for edge computing include computational offloading, Content Data Network (CDN) services (e.g., video on demand, content streaming, security surveillance, alarm system monitoring, building access, data/content caching, and/or the like), gaming services (e.g., AR/VR, and/or the like), accelerated browsing, IoT and industry applications (e.g., factory automation), media analytics, live streaming/transcoding, and V2X applications (e.g., driving assistance and/or autonomous driving applications).

In any of the examples discussed herein, the edge servers 1136 provide a distributed computing environment for application and service hosting, and also provide storage and processing resources so that data and/or content can be processed in close proximity to subscribers (e.g., users of UEs 1110) for faster response times The edge servers 1136 also support multitenancy run-time and hosting environment(s) for applications, including virtual appliance applications that may be delivered as packaged virtual machine (VM) images, middleware application and infrastructure services, content delivery services including content caching, mobile big data analytics, and computational offloading, among others. Computational offloading involves offloading computational tasks, workloads, applications, and/or services to the edge servers 1136 from the UEs 1110, CN 1142, cloud 1144, and/or server(s) 1150, or vice versa. For example, a device application or client application operating in a UE 1110 may offload application tasks or workloads to one or more edge servers 1136. In another example, an edge server 1136 may offload application tasks or workloads to one or more UE 1110 (e.g., for distributed ML computation or the like).

The edge compute nodes 1136 may include or be part of an edge system 1135 that employs one or more edge computing technologies (ECTs) 1135. The edge compute nodes 1136 may also be referred to as “edge hosts 1136” or “edge servers 1136.” The edge system 1135 includes a collection of edge servers 1136 and edge management systems (not shown by FIG. 11) necessary to run edge computing applications within an operator network or a subset of an operator network. The edge servers 1136 are physical computer systems that may include an edge platform and/or virtualization infrastructure, and provide compute, storage, and network resources to edge computing applications. Each of the edge servers 1136 are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 1110. The VI of the edge servers 1136 provide virtualized environments and virtualized resources for the edge hosts, and the edge computing applications may run as VMs and/or application containers on top of the VI.

In one example implementation, the ECT 1135 is and/or operates according to the MEC framework, as discussed in ETSI GR MEC 001 v3.1.1 (2022-01), ETSI GS MEC 003 v3.1.1 (2022-03), ETSI GS MEC 009 v3.1.1 (2021-06), ETSI GS MEC 010-1 v1.1.1 (2017-10), ETSI GS MEC 010-2 v2.2.1 (2022-02), ETSI GS MEC 011 v2.2.1 (2020-12), ETSI GS MEC 012 V2.2.1 (2022-02), ETSI GS MEC 013 V2.2.1 (2022-01), ETSI GS MEC 014 v2.1.1 (2021-03), ETSI GS MEC 015 v2.1.1 (2020-06), ETSI GS MEC 016 v2.2.1 (2020-04), ETSI GS MEC 021 v2.2.1 (2022-02), ETSI GR MEC 024 v2.1.1 (2019-11), ETSI GS MEC 028 V2.2.1 (2021-07), ETSI GS MEC 029 v2.2.1 (2022-01), ETSI MEC GS 030 v2.1.1 (2020-04), ETSI GR MEC 031 v2.1.1 (2020-10), U.S. Provisional App. No. 63/003,834 filed Apr. 1, 2020 (“[US′834]”), and Int'l App. No. PCT/US2020/066969 filed on Dec. 23, 2020 (“[PCT′696]”) (collectively referred to herein as “[MEC]”), the contents of each of which are hereby incorporated by reference in their entireties. In another example implementation, the ECT 1135 is and/or operates according to the Open RAN alliance (“O-RAN”) framework, as described in O-RAN Architecture Description v07.00, O-RAN ALLIANCE WG1 (October 2022); O-RAN Working Group 2 AIML workflow description and requirements v01.03 O-RAN ALLIANCE WG2 (October 2021); O-RAN Working Group 2 Non-RT RIC: Functional Architecture v01.01, O-RAN ALLIANCE WG2 (June 2021); O-RAN Working Group 3 Near-Real-time RAN Intelligent Controller Architecture & E2 General Aspects and Principles v02.02 (July 2022); O-RAN Working Group 3 Near-Real-time Intelligent Controller E2 Service Model (E2SM) v02.01 (March 2022); and/or any other O-RAN standard/specification (collectively referred to as “[O-RAN]”); the contents of each of which are hereby incorporated by reference in their entireties. In another example implementation, the ECT 1135 operates according to the 3rd Generation Partnership Project (3GPP) System Aspects Working Group 6 (SA6) Architecture for enabling Edge Applications (referred to as “3GPP edge computing”) as discussed in 3GPP TS 23.558 v18.1.0 (2022-12-23) (“[TS23558]”), 3GPP TS 23.501 v18.0.0 (2022-12-21) (“[TS23501]”), 23.548 v18.0.0 (2022-12-21) (“[TS23548]”), and 3GPP TR 23.700-98 v18.0.0 (2022-12-23) (“[TR23700-98]”) (collectively referred to as “[SA6Edge]”), the contents of each of which is hereby incorporated by reference in their entireties. In another example implementation, the ECT 1135 is and/or operates according to the Intel® Smart Edge Open framework (formerly known as OpenNESS) as discussed in Intel® Smart Edge Open Developer Guide, version 21.09 (30 Sep. 2021), available at: https://smart-edge-open.github.io/(“[ISEO]”), the contents of which is hereby incorporated by reference in its entirety. In another example implementation, the ECT 1135 operates according to the Multi-Access Management Services (MAMS) framework as discussed in Kanugovi et al., Multi-Access Management Services (MAMS), INTERNET ENGINEERING TASK FORCE (IETF), Request for Comments (RFC) 8743 (March 2020), Ford et al., TCP Extensions for Multipath Operation with Multiple Addresses, IETF RFC 8684, (March 2020), De Coninck et al., Multipath Extensions for QUIC (MP-QUIC), IETF DRAFT-DECONINCK-QUIC-MULTIPATH-07, IETA, QUIC Working Group (3 May 2021), Zhu et al., User-Plane Protocols for Multiple Access Management Service, IETF DRAFT-ZHU-INTAREA-MAMS-USER-PROTOCOL-09, IETA, INTAREA (4 Mar. 2020), and Zhu et al., Generic Multi-Access (GM4) Convergence Encapsulation Protocols, IETF RFC 9188 (February 2022) (collectively referred to as “[MAMS]”), the contents of each of which are hereby incorporated by reference in their entireties.

Any of the aforementioned example implementations, and/or in any other example implementation discussed herein, may also include one or more virtualization technologies, such as those discussed in ETSI GR NFV 001 V1.3.1 (2021-03); ETSI GS NFV 002 V1.2.1 (2014-12); ETSI GR NFV 003 V1.6.1 (2021-03); ETSI GS NFV 006 V2.1.1 (2021-01); ETSI GS NFV-INF 001 V1.1.1 (2015-01); ETSI GS NFV-INF 003 V1.1.1 (2014-12); ETSI GS NFV-INF 004 V1.1.1 (2015-01); ETSI GS NFV-MAN 001 v1.1.1 (2014-12); Israel et al., OSM Release FIVE Technical Overview, ETSI OPEN SOURCE MANO, OSM White Paper, 1st ed. (January 2019); E2E Network Slicing Architecture, GSMA, Official Doc. NG.127, v1.0 (3 Jun. 2021); Open Network Automation Platform (ONAP) documentation, Release Istanbul, v9.0.1 (17 Feb. 2022); 3GPP Service Based Management Architecture (SBMA) as discussed in 3GPP TS 28.533 v17.1.0 (2021-12-23) (“[TS28533]”); the contents of each of which are hereby incorporated by reference in their entireties.

It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge computing networks/systems described herein. For example, many ECTs and networking technologies may be applicable to the present disclosure in various combinations and layouts of devices located at the edge of a network. Examples of such ECTs include [MEC]; [O-RAN]; [ISEO]; [SA6Edge]; [MAMS]; Content Delivery Networks (CDNs) (also referred to as “Content Distribution Networks” or the like); Mobility Service Provider (MSP) edge computing and/or Mobility as a Service (MAs) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be applicable to the present disclosure.

FIG. 12 illustrates an example of components that may be present in an compute node 1200 for implementing the techniques (e.g., operations, processes, methods, and methodologies) described herein. This compute node 1200 provides a closer view of the respective components of node 1200 when implemented as or as part of a computing device or system. The compute node 1200 can include any combination of the HW or logical components referenced herein, and may include or couple with any device usable with a communication network or a combination of such networks. In particular, any combination of the components depicted by FIG. 12 can be implemented as individual ICs, discrete electronic devices, or other modules, instruction sets, programmable logic or algorithms, HW, HW accelerators, SW, FW, or a combination thereof adapted in the compute node 1200, or as components otherwise incorporated within a chassis of a larger system. Additionally or alternatively, any combination of the components depicted by FIG. 12 can be implemented as a system-on-chip (SoC), a single-board computer (SBC), a system-in-package (SiP), a multi-chip package (MCP), and/or the like, in which a combination of the HW elements are formed into a single IC or a single package. Furthermore, the compute node 1200 may be or include, server, appliance, network infrastructure, machine, robot, drone, and/or any other type of computing devices such as any of those discussed herein. For example, compute node 1200 may be embodied as a client device and/or mobile compute device, a smart appliance, an in-vehicle compute system (e.g., a navigation system), an edge compute node, a NAN, switch, router, bridge, hub, a server, network infrastructure, machine, robot, drone, and/or any other type of computing device such as any of those discussed herein. Additionally or alternatively, the compute node 1200 may be embodied as any of the computing devices discussed herein, such as, for example, the display systems 101, 301, display devices 102, 302, any of the TASs in TAN 900, PTP instance 1000, the UEs 1110, NANs 1130, edge compute node(s) 1136, cloud compute nodes (e.g., in cloud 1144), NF(s) (e.g., in CN 1142), and/or app servers 1150 of FIG. 11; and/or any other type of computing device such as any of those discussed herein.

The compute node 1200 includes one or more processors 1202 (also referred to as “processor circuitry 1202”). The processor circuitry 1202 includes circuitry capable of sequentially and/or automatically carrying out a sequence of arithmetic or logical operations, and recording, storing, and/or transferring digital data. Additionally or alternatively, the processor circuitry 1202 includes any device capable of executing or otherwise operating computer-executable instructions, such as program code, SW modules, and/or functional processes. The processor circuitry 1202 includes various HW elements or components such as, for example, a set of processor cores and one or more of on-chip or on-die memory or registers, cache and/or scratchpad memory, low drop-out voltage regulators (LDOs), interrupt controllers, serial interfaces (e.g., SPI, I²C, universal asynchronous receiver/transmitter (UART), universal programmable serial interface, advanced host controller interface (AHCI) and/or the like), real time clock (RTC), timer-counters including interval and watchdog timers, general purpose I/O (GPIO), memory card controllers such as secure digital/multi-media card (SD/MMC) or similar, interfaces, mobile industry processor interface (MIPI) interfaces and Joint Test Access Group (JTAG) test access ports. Some of these components, such as the on-chip or on-die memory or registers, cache and/or scratchpad memory, may be implemented using the same or similar devices as the memory circuitry 1210 discussed infra. The processor circuitry 1202 is also coupled with memory circuitry 1210 and storage circuitry 1220, and is configured to execute instructions stored in the memory/storage to enable various apps, OSs, or other SW elements to run on the platform 1200. In particular, the processor circuitry 1202 is configured to operate app SW (e.g., instructions 1201, 1211, 1221) to provide one or more services to a user of the compute node 1200 and/or user(s) of remote systems/devices.

As examples, the processor circuitry 1202 can be embodied as, or otherwise include one or multiple central processing units (CPUs), application processors, graphics processing units (GPUs), accelerated processing units (APUs), RISC processors, Acorn RISC Machine (ARM) processors, complex instruction set computer (CISC) processors, DSPs, FPGAs, programmable logic devices (PLDs), ASICs, baseband processors, radio-frequency integrated circuits (RFICs), microprocessors or controllers, multi-core processors, multithreaded processors, ultra-low voltage processors, embedded processors, a specialized x-processing units (xPUs) or a data processing unit (DPUs) (e.g., Infrastructure Processing Unit (IPU), network processing unit (NPU), and the like), and/or any other processing devices or elements, or any combination thereof. In some implementations, the processor circuitry 1202 is embodied as one or more special-purpose processor(s)/controller(s) configured (or configurable) to operate according to the various implementations and other aspects discussed herein. Additionally or alternatively, the processor circuitry 1202 includes one or more HW accelerators (e.g., same or similar to acceleration circuitry 1250), which can include microprocessors, programmable processing devices (e.g., FPGAs, ASICs, PLDs, DSPs. and/or the like), and/or the like.

As mentioned previously, the processor circuitry 1202 and/or the acceleration circuitry 1250 includes one or more GPUs (also referred to “graphics card”, “video card”, “display card”, “graphics adapter”, “display adapter”, and/or the like). In these examples, GPU(s) is/are a specialized piece of HW that is responsible for rendering images on a display device (e.g., display 102 or display 302). The GPU(s) are dedicated processor(s) that is/are designed specifically for handling complex mathematical calculations required to render images. In some implementations, the GPU(s) is/are an expansion card that connects to a motherboard of the compute node 1200 via an IX 1206 slot or lane (e.g., a PCIe slot and/or the like). In these implementations, the GPU(s) also include their own memory (e.g., video random access memory (VRAM)), which may be separate from the computer's main memory (e.g., memory 1210) and is optimized for fast access by the GPU(s). In other implementations, the GPU(s) is/are integrated or built into the host platform and uses a relatively small amount of memory shared with the main system memory 1210. Additionally or alternatively, the GPU(s) can also include their own cooling system (e.g., fans and/or heatsinks) that dissipate heat generated by the display controller 321 during operation. Examples of GPUs/graphics cards include Iris® Xe, Arc™, and/or the like GPUs provided by Intel®; Titan™, GeForce®, Tegra®, Titan®, Tesla®, Shield®, Quadro®, NX-SoC, and/or other like GPUs provided by Nvidia®; Radeon™, FirePro™, FireStream™, Imageon™, and/or other like GPUs provided by AMD®; RK-series, Mali™, and/or other like GPUs provided by Rockchip®; GCNano™, GCx, Vega xX™, and/or other like GPUs provided by Vivante® and/or VeriSilicon®; Adreno™ and/or other like GPUs provided by Qualcomm®; VideoCore™ and/or other like GPUs provided by Broadcom®; PowerVR™ accelerators and/or other GPUs provided by Imagination Technologies, Ltd.; and/or the like.

During operation, the GPU(s) obtains data for rendering content from the processor circuitry 1202. This data includes information about the colors, textures, shapes, lighting and shading, and/or other information of the objects in the image. The GPU(s) uses this data to perform a series of complex mathematical calculations to transform the data into a format that can be displayed on by the display device 102, 302 (e.g., vertex processing, rasterization, fragment processing, framebuffer or frame buffering, and/or the like). The GPU(s) performs these calculations using a specialized set of instructions called shaders, which are designed specifically for rendering images. The GPU(s) also uses its own memory (e.g., VRAM) to store the data required to render images. Once the GPU(s) finish processing the data, the final image is sent to the computer's memory 1210. The image is then sent to the display controller 321, which sends the image (along with the Vsync 334) to the display device 102, 302. In some implementations, the GPU(s) and the display controller 321 can be part of the same SoC, SBC, SiP, MCP, and/or some other suitable package or IC.

The system memory 1210 (also referred to as “memory circuitry 1210”) includes one or more HW elements/devices for storing data and/or instructions 1211 (and/or instructions 1201, 1221). Any number of memory devices may be used to provide for a given amount of system memory 1210. As examples, the memory 1210 can be embodied as processor cache or scratchpad memory, volatile memory, non-volatile memory (NVM), and/or any other machine readable media for storing data. Examples of volatile memory include random access memory (RAM), static RAM (SRAM), dynamic RAM (DRAM), synchronous DRAM (SDRAM), thyristor RAM (T-RAM), content-addressable memory (CAM), video RAM (VRAM), and/or the like. Examples of NVM can include read-only memory (ROM) (e.g., including programmable ROM (PROM), erasable PROM (EPROM), electrically EPROM (EEPROM), flash memory (e.g., NAND flash memory, NOR flash memory, and the like), solid-state storage (SSS) or solid-state ROM, programmable metallization cell (PMC), and/or the like), non-volatile RAM (NVRAM), phase change memory (PCM) or phase change RAM (PRAM) (e.g., Intel® 3D XPoint™ memory, chalcogenide RAM (CRAM), Interfacial Phase-Change Memory (IPCM), and the like), memistor devices, resistive memory or resistive RAM (ReRAM) (e.g., memristor devices, metal oxide-based ReRAM, quantum dot resistive memory devices, and the like), conductive bridging RAM (or PMC), magnetoresistive RAM (MRAM), electrochemical RAM (ECRAM), ferroelectric RAM (FeRAM), anti-ferroelectric RAM (AFeRAM), ferroelectric field-effect transistor (FeFET) memory, and/or the like. Additionally or alternatively, the memory circuitry 1210 can include spintronic memory devices (e.g., domain wall memory (DWM), spin transfer torque (STT) memory (e.g., STT-RAM or STT-MRAM), magnetic tunneling junction memory devices, spin-orbit transfer memory devices, Spin-Hall memory devices, nanowire memory cells, and/or the like). In some implementations, the individual memory devices 1210 may be formed into any number of different package types, such as single die package (SDP), dual die package (DDP), quad die package (Q17P), memory modules (e.g., dual inline memory modules (DIMMs), microDIMMs, and/or MiniDIMMs), and/or the like. Additionally or alternatively, the memory circuitry 1210 is or includes block addressable memory device(s), such as those based on NAND or NOR flash memory technologies (e.g., single-level cell (“SLC”), multi-level cell (“MLC”), quad-level cell (“QLC”), tri-level cell (“TLC”), or some other NAND or NOR device). Additionally or alternatively, the memory circuitry 1210 can include resistor-based and/or transistor-less memory architectures. In some examples, the memory circuitry 1210 can refer to a die, chip, and/or a packaged memory product. In some implementations, the memory 1210 can be or include the on-die memory or registers associated with the processor circuitry 1202. Additionally or alternatively, the memory 1210 can include any of the devices/components discussed infra w.r.t the storage circuitry 1220. In some examples, the memory circuitry 1210 corresponds to the host (system) memory 1270 discussed previously.

The storage 1220 (also referred to as “storage circuitry 1220”) provides persistent storage of information, such as data, OSs, apps, instructions 1221, and/or other SW elements. As examples, the storage 1220 may be embodied as a magnetic disk storage device, hard disk drive (HDD), microHDD, solid-state drive (SSD), optical storage device, flash memory devices, memory card (e.g., secure digital (SD) card, eXtreme Digital (XD) picture card, USB flash drives, SIM cards, and/or the like), and/or any combination thereof. The storage circuitry 1220 can also include specific storage units, such as storage devices and/or storage disks that include optical disks (e.g., DVDs, CDs/CD-ROM, Blu-ray disks, and the like), flash drives, floppy disks, hard drives, and/or any number of other HW devices in which information is stored for any duration (e.g., for extended time periods, permanently, for brief instances, for temporarily buffering, and/or caching). Additionally or alternatively, the storage circuitry 1220 can include resistor-based and/or transistor-less memory architectures. Further, any number of technologies may be used for the storage 1220 in addition to, or instead of, the previously described technologies, such as, for example, resistance change memories, phase change memories, holographic memories, chemical memories, among many others. Additionally or alternatively, the storage circuitry 1220 can include any of the devices or components discussed previously w.r.t the memory 1210.

Computer program code for carrying out operations of the present disclosure (e.g., computational logic and/or instructions 1201, 1211, 1221) may be written in any combination of one or more programming languages, including object oriented programming languages, procedural programming languages, scripting languages, markup languages, and/or some other suitable programming languages including proprietary programming languages and/or development tools, or any other languages tools. The computer program/code 1201, 1211, 1221 for carrying out operations of the present disclosure may also be written in any combination of programming languages and/or machine language, such as any of those discussed herein. The program code may execute entirely on the system 1200, partly on the system 1200, as a stand-alone SW package, partly on the system 1200 and partly on a remote computer or entirely on the remote computer or server. In the latter scenario, the remote computer may be connected to the system 1200 through any type of network, including a LAN or WAN, or the connection may be made to an external computer (e.g., through the Internet, enterprise network, and/or some other network). Additionally or alternatively, the computer program/code 1201, 1211, 1221 can include one or more operating systems (OS) and/or other SW to control various aspects of the compute node 1200. The OS can include drivers to control particular devices that are embedded in the compute node 1200, attached to the compute node 1200, and/or otherwise communicatively coupled with the compute node 1200. Example OSs include consumer-based OS, real-time OS (RTOS), hypervisors, and/or the like.

The storage 1220 may include instructions 1221 in the form of SW, FW, or HW commands to implement the techniques described herein. Although such instructions 1221 are shown as code blocks included in the memory 1210 and/or storage 1220, any of the code blocks may be replaced with hardwired circuits, for example, built into an ASIC, FPGA memory blocks/cells, and/or the like. In an example, the instructions 1201, 1211, 1221 stored and/or provided via the memory 1210, the storage 1220, and/or the processor 1202 are embodied as a non-transitory or transitory machine-readable medium 1204 (also referred to as “computer readable medium 1204” or “CRM 1204”) including code (e.g., instructions 1201, 1211, 1221, accessible over the IX 1206, to direct the processor 1202 to perform various operations and/or tasks, such as a specific sequence or flow of actions as described herein and/or depicted in any of the accompanying drawings. The CRM 1204 may be embodied as any of the devices/technologies described for the memory 1210 and/or storage 1220.

The various components of the computing node 1200 communicate with one another over an interconnect (IX) 1206. The IX 1206 may include any number of IX (or similar) technologies including, for example, instruction set architecture (ISA), extended ISA (eISA), Inter-Integrated Circuit (I²C), serial peripheral interface (SPI), point-to-point interfaces, power management bus (PMBus), peripheral component interconnect (PCI), PCI express (PCIe), PCI extended (PCIx), Intel® Ultra Path Interconnect (UPI), Intel® Accelerator Link, Intel® QuickPath Interconnect (QPI), Intel® Omni-Path Architecture (OPA), Compute Express Link™ (CXL™) IX, RapidIO™ IX, Coherent Accelerator Processor Interface (CAPI), OpenCAPI, Advanced Microcontroller Bus Architecture (AMBA) IX, cache coherent interconnect for accelerators (CCIX), Gen-Z Consortium IXs, a HyperTransport IX, NVLink provided by NVIDIA®, ARM Advanced eXtensible Interface (AXI), a Time-Trigger Protocol (TTP) system, a FlexRay system, PROFIBUS, Ethernet, USB, On-Chip System Fabric (IOSF), Infinity Fabric (IF), and/or any number of other IX technologies. The IX 1206 may be a proprietary bus, for example, used in a SoC based system. Additionally or alternatively, the IX 1206 may be a suitable compute fabric such as any of those discussed herein.

The communication circuitry 1260 comprises a set of HW elements that enables the compute node 1200 to communicate over one or more networks (e.g., cloud 1265) and/or with other devices 1290. Communication circuitry 1260 includes various HW elements, such as, for example, switches, filters, amplifiers, antenna elements, and the like to facilitate over-the-air (OTA) communications. Communication circuitry 1260 includes modem circuitry 1261 that interfaces with processor circuitry 1202 for generation and processing of baseband signals and for controlling operations of transceivers (TRx) 1262, 1263. The modem circuitry 1261 handles various radio control functions according to one or more communication protocols and/or RATs, such as any of those discussed herein. The modem circuitry 1261 includes baseband processors or control logic to process baseband signals received from a receive signal path of the TRxs 1262, 1263, and to generate baseband signals to be provided to the TRxs 1262, 1263 via a transmit signal path.

The TRxs 1262, 1263 include HW elements for transmitting and receiving radio waves according to any number of frequencies and/or communication protocols, such as any of those discussed herein. The TRxs 1262, 1263 can include transmitters (Tx) and receivers (Rx) as separate or discrete electronic devices, or single electronic devices with Tx and Rx functionally. In either implementation, the TRxs 1262, 1263 may be configured to communicate over different networks or otherwise be used for different purposes. In one example, the TRx 1262 is configured to communicate using a first RAT (e.g., [IEEE802] RATs, such as [IEEE80211], [IEEE802154], [WiMAX], IEEE 802.11bd, ETSI ITS-G5, and/or the like) and TRx 1263 is configured to communicate using a second RAT (e.g., 3GPP RATs such as 3GPP LTE or NR/5G). In another example, the TRxs 1262, 1263 may be configured to communicate over different frequencies or ranges, such as the TRx 1262 being configured to communicate over a relatively short distance (e.g., devices 1290 within about 10 meters using a local Bluetooth®, devices 1290 within about 50 meters using ZigBee®, and/or the like), and TRx 1262 being configured to communicate over a relatively long distance (e.g., using [IEEE802], [WiMAX], and/or 3GPP RATs). The same or different communications techniques may take place over a single TRx at different power levels or may take place over separate TRxs.

A network interface circuitry 1230 (also referred to as “network interface controller 1230” or “NIC 1230”) provides wired communication to nodes of the cloud 1265 and/or to connected devices 1290. The wired communications may be provided according to Ethernet (e.g.,) or may be based on other types of networks, such as Controller Area Network (CAN), Local Interconnect Network (LIN), DeviceNet, ControlNet, Data Highway+, or PROFINET, among many others. As examples, the NIC 1230 may be embodied as a SmartNIC and/or one or more intelligent fabric processors (IFPs). Additionally or alternatively, the NIC 1230 may support advanced features such as, for example, AVB aspects (see e.g., [IEEE802.1BA]), TSN/PTP precision timestamping (see e.g., [IEEE802.1AS] and [IEEE1588]), error correcting code (ECC) packet buffers, enhanced management interface options, and/or the like. One or more additional NICs 1230 may be included to enable connecting to additional/alternative networks. For example, a first NIC 1230 can provide communications to the cloud 1265 over an Ethernet network (e.g., [IEEE802.3]), a second NIC 1230 can provide communications to connected devices 1290 over an optical network (e.g., optical transport network (OTN), Synchronous optical networking (SONET), and synchronous digital hierarchy (SDH)), and so forth. In some examples, the NIC 1230 corresponds to the NIC 326-1, 326-2 discussed previously.

Given the variety of types of applicable communications from the compute node 1200 to another component, device 1290, and/or network (e.g., cloud 1265), applicable communications circuitry used by the compute node 1200 may include or be embodied by any combination of components 1230, 1240, 1250, or 1260. Accordingly, applicable means for communicating (e.g., receiving, transmitting, broadcasting, and so forth) may be embodied by such circuitry.

The acceleration circuitry 1250 (also referred to as “accelerator circuitry 1250”) includes any suitable HW device or collection of HW elements that are designed to perform one or more specific functions more efficiently in comparison to general-purpose processing elements. The acceleration circuitry 1250 can include various HW elements such as, for example, one or more GPUs, FPGAs, DSPs, SoCs (including programmable SoCs and multi-processor SoCs), ASICs (including programmable ASICs), PLDs (including complex PLDs (CPLDs) and high capacity PLDs (HCPLDs), xPUs (e.g., DPUs, IPUs, and NPUs) and/or other forms of specialized circuitry designed to accomplish specialized tasks. Additionally or alternatively, the acceleration circuitry 1250 may be embodied as, or include, one or more of artificial intelligence (AI) accelerators (e.g., vision processing unit (VPU), neural compute sticks, neuromorphic HW, deep learning processors (DLPs) or deep learning accelerators, tensor processing units (TPUs), physical neural network HW, and/or the like), cryptographic accelerators (or secure cryptoprocessors), network processors, I/O accelerator (e.g., DMA engines and the like), and/or any other specialized HW device/component. The offloaded tasks performed by the acceleration circuitry 1250 can include, for example, AI/ML tasks (e.g., training, feature extraction, model execution for inference/prediction, classification, and so forth), visual data processing, graphics processing, digital and/or analog signal processing, network data processing, infrastructure function management, object detection, rule analysis, and/or the like.

The TEE 1270 operates as a protected area accessible to the processor circuitry 1202 and/or other components to enable secure access to data and secure execution of instructions. In some implementations, the TEE 1270 may be a physical HW device that is separate from other components of the system 1200 such as a secure-embedded controller, a dedicated SoC, a trusted platform module (TPM), a tamper-resistant chipset or microcontroller with embedded processing devices and memory devices, and/or the like. Additionally or alternatively, the TEE 1270 is implemented as secure enclaves (or “enclaves”), which are isolated regions of code and/or data within the processor and/or memory/storage circuitry of the compute node 1200, where only code executed within a secure enclave may access data within the same secure enclave, and the secure enclave may only be accessible using the secure app (which may be implemented by an app processor or a tamper-resistant microcontroller). In some implementations, the memory circuitry 1204 and/or storage circuitry 1208 may be divided into one or more trusted memory regions for storing apps or SW modules of the TEE 1270. Additionally or alternatively, the processor circuitry 1202, acceleration circuitry 1250, memory circuitry 1210, and/or storage circuitry 1220 may be divided into, or otherwise separated into virtualized environments using a suitable virtualization technology, such as, for example, virtual machines (VMs), virtualization containers, and/or the like. These virtualization technologies may be managed and/or controlled by a virtual machine monitor (VMM), hypervisor container engines, orchestrators, and the like. Such virtualization technologies provide execution environments in which one or more apps and/or other SW, code, or scripts may execute while being isolated from one or more other apps, SW, code, or scripts.

The input/output (I/O) interface circuitry 1240 (also referred to as “interface circuitry 1240”) is used to connect additional devices or subsystems. The interface circuitry 1240, is part of, or includes circuitry that enables the exchange of information between two or more components or devices such as, for example, between the compute node 1200 and various additional/external devices (e.g., sensor circuitry 1242, actuator circuitry 1244, and/or positioning circuitry 1243). Access to various such devices/components may be implementation specific, and may vary from implementation to implementation. At least in some examples, the interface circuitry 1240 includes one or more HW interfaces such as, for example, buses, input/output (I/O) interfaces, peripheral component interfaces, network interface cards, and/or the like. Additionally or alternatively, the interface circuitry 1240 includes a sensor hub or other like elements to obtain and process collected sensor data and/or actuator data before being passed to other components of the compute node 1200.

The sensor circuitry 1242 includes devices, modules, or subsystems whose purpose is to detect events or changes in its environment and send the information (sensor data) about the detected events to some other a device, module, subsystem, and the like. Individual sensors 1242 may be exteroceptive sensors (e.g., sensors that capture and/or measure environmental phenomena and/external states), proprioceptive sensors (e.g., sensors that capture and/or measure internal states of the compute node 1200 and/or individual components of the compute node 1200), and/or exproprioceptive sensors (e.g., sensors that capture, measure, or correlate internal states and external states). Examples of such sensors 1242 include inertia measurement units (IMU), microelectromechanical systems (MEMS) or nanoelectromechanical systems (NEMS), level sensors, flow sensors, temperature sensors (e.g., thermistors, including sensors for measuring the temperature of internal components and sensors for measuring temperature external to the compute node 1200), pressure sensors, barometric pressure sensors, gravimeters, altimeters, image capture devices (e.g., visible light cameras, thermographic camera and/or thermal imaging camera (TIC) systems, forward-looking infrared (FLIR) camera systems, radiometric thermal camera systems, active infrared (IR) camera systems, ultraviolet (UV) camera systems, and/or the like), light detection and ranging (LiDAR) sensors, proximity sensors (e.g., IR radiation detector and the like), depth sensors, ambient light sensors, optical light sensors, ultrasonic transceivers, microphones, inductive loops, and/or the like. The IMUs, MEMS, and/or NEMS can include, for example, one or more 3-axis accelerometers, one or more 3-axis gyroscopes, one or more magnetometers, one or more compasses, one or more barometers, and/or the like.

The actuators 1244 allow compute node 1200 to change its state, position, and/or orientation, or move or control a mechanism or system. The actuators 1244 comprise electrical and/or mechanical devices for moving or controlling a mechanism or system, and converts energy (e.g., electric current or moving air and/or liquid) into some kind of motion. Additionally or alternatively, the actuators 1244 can include electronic controllers linked or otherwise connected to one or more mechanical devices and/or other actuation devices. As examples, the actuators 1244 can be or include any number and combination of the following: soft actuators (e.g., actuators that changes its shape in response to a stimuli such as, for example, mechanical, thermal, magnetic, and/or electrical stimuli), hydraulic actuators, pneumatic actuators, mechanical actuators, electromechanical actuators (EMAs), microelectromechanical actuators, electrohydraulic actuators, linear actuators, linear motors, rotary motors, DC motors, stepper motors, servomechanisms, electromechanical switches, electromechanical relays (EMRs), power switches, valve actuators, piezoelectric actuators and/or biomorphs, thermal biomorphs, solid state actuators, solid state relays (SSRs), shape-memory alloy-based actuators, electroactive polymer-based actuators, relay driver integrated circuits (ICs), solenoids, impactive actuators/mechanisms (e.g., jaws, claws, tweezers, clamps, hooks, mechanical fingers, humaniform dexterous robotic hands, and/or other gripper mechanisms that physically grasp by direct impact upon an object), propulsion actuators/mechanisms (e.g., wheels, axles, thrusters, propellers, engines, motors, servos, clutches, rotors, and the like), projectile actuators/mechanisms (e.g., mechanisms that shoot or propel objects or elements), payload actuators, audible sound generators (e.g., speakers and the like), LEDs and/or visual warning devices, and/or other like electromechanical components. Additionally or alternatively, the actuators 1244 can include virtual instrumentation and/or virtualized actuator devices.

Additionally or alternatively, the interface circuitry 1240 and/or the actuators 1244 can include various individual controllers and/or controllers belonging to one or more components of the compute node 1200 such as, for example, host controllers, cooling element controllers, baseboard management controller (BMC), platform controller hub (PCH), uncore components (e.g., shared last level cache (LLC) cache, caching agent (Cbo), integrated memory controller (IMC), home agent (HA), power control unit (PCU), configuration agent (Ubox), integrated I/O controller (IIO), and interconnect (IX) link interfaces and/or controllers), and/or any other components such as any of those discussed herein. The compute node 1200 may be configured to operate one or more actuators 1244 based on one or more captured events, instructions, control signals, and/or configurations received from a service provider, client device, and/or other components of the compute node 1200. Additionally or alternatively, the actuators 1244 can include mechanisms that are used to change the operational state (e.g., on/off, zoom or focus, and/or the like), position, and/or orientation of one or more sensors 1242.

The positioning circuitry (pos) 1243 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), and the like), or the like. The positioning circuitry 1245 comprises various HW elements (e.g., including HW devices such as switches, filters, amplifiers, antenna elements, and the like to facilitate OTA communications) to communicate with components of a positioning network, such as navigation satellite constellation nodes. Additionally or alternatively, the positioning circuitry 1245 may include a Micro-Technology for Positioning, Navigation, and Timing (Micro-PNT) IC that uses a master timing clock to perform position tracking/estimation without GNSS assistance. The positioning circuitry 1245 may also be part of, or interact with, the communication circuitry 1260 to communicate with the nodes and components of the positioning network. The positioning circuitry 1245 may also provide position data and/or time data to the application circuitry (e.g., processor circuitry 1202), which may use the data to synchronize operations with various infrastructure (e.g., radio base stations), for turn-by-turn navigation, or the like. In some implementations, the positioning circuitry 1245 is, or includes an INS, which is a system or device that uses sensor circuitry 1242 (e.g., motion sensors such as accelerometers, rotation sensors such as gyroscopes, and altimeters, magnetic sensors, and/or the like to continuously calculate (e.g., using dead by dead reckoning, triangulation, or the like) a position, orientation, and/or velocity (including direction and speed of movement) of the platform 1200 without the need for external references.

In some examples, various I/O devices may be present within or connected to, the compute node 1200, which are referred to as input circuitry 1246 and output circuitry 1245. The input circuitry 1246 and output circuitry 1245 include one or more user interfaces designed to enable user interaction with the platform 1200 and/or peripheral component interfaces designed to enable peripheral component interaction with the platform 1200. The input circuitry 1246 and/or output circuitry 1245 may be, or may be part of a Human Machine Interface (HMI). Input circuitry 1246 includes any physical or virtual means for accepting an input including buttons, switches, dials, sliders, keyboard, keypad, mouse, touchpad, touchscreen, microphone, scanner, headset, and/or the like. The output circuitry 1245 may be included to show information or otherwise convey information, such as sensor readings, actuator position(s), or other like information. Data and/or graphics may be displayed on one or more user interface components of the output circuitry 1245. Output circuitry 1245 may include any number and/or combinations of audio or visual display, including, inter alia, one or more simple visual outputs/indicators (e.g., binary status indicators (e.g., light emitting diodes (LEDs)) and multi-character visual outputs, or more complex outputs, such as touchscreens and/or other display devices, with the output of characters, graphics, multimedia objects, and the like being generated or produced from the operation of the compute node 1200. The output circuitry 1245 may also include speakers or other audio emitting devices, printer(s), and/or the like. Additionally or alternatively, the sensor circuitry 1242 may be used as the input circuitry 1245 (e.g., an image capture device, motion capture device, or the like) and one or more actuators 1244 may be used as the output device circuitry 1245 (e.g., an actuator to provide haptic feedback or the like). In another example, near-field communication (NFC) circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, and the like. A display or console HW, in the context of the present system, may be used to provide output and receive input of an edge computing system; to manage components or services of an edge computing system; identify a state of an edge computing component or service; or to conduct any other number of management or administration functions or service use cases.

A battery 1280 can be used to power the compute node 1200, although, in examples in which the compute node 1200 is mounted in a fixed location, it may have a power supply coupled to an electrical grid, or the battery 1280 may be used as a backup power source. As examples, the battery 1280 can be a lithium ion battery or a metal-air battery (e.g., zinc-air battery, aluminum-air battery, lithium-air battery, and the like). Other battery technologies may be used in other implementations.

A battery monitor/charger 1282 may be included in the compute node 1200 to track the state of charge (SoCh) of the battery 1280, if included. The battery monitor/charger 1282 may be used to monitor other parameters of the battery 1280 to provide failure predictions, such as the state of health (SoH) and the state of function (SoF) of the battery 1280. The battery monitor/charger 1282 may include a battery monitoring IC. The battery monitor/charger 1282 may communicate the information on the battery 1280 to the processor 1202 over the IX 1206. The battery monitor/charger 1282 may also include an analog-to-digital (ADC) converter that enables the processor 1202 to directly monitor the voltage of the battery 1280 or the current flow from the battery 1280. The battery parameters may be used to determine actions that the compute node 1200 may perform, such as transmission frequency, mesh network operation, sensing frequency, and the like. A power block 1285, or other power supply coupled to a grid, may be coupled with the battery monitor/charger 1282 to charge the battery 1280. In some examples, the power block 1285 may be replaced with a wireless power receiver to obtain the power wirelessly, for example, through a loop antenna in the compute node 1200. A wireless battery charging circuit may be included in the battery monitor/charger 1282. The specific charging circuits may be selected based on the size of the battery 1280, and thus, the current required. The charging may be performed according to Airfuel Alliance standards, the Qi wireless charging standard, the Rezence charging standard, among others.

The compute node 1200 also includes clock circuitry 1252, which is a device (or collection of devices) that tracks the passage of time. In some implementations, the clock circuitry 1252 may be an atomic clock and/or a clock generator (electronic oscillator and/or timing-signal generator). In clock generator implementations, the clock circuitry 1252 may include resonant circuitry (e.g., crystal oscillator or the like) and amplifier circuitry to invert the signal from the resonant circuitry and feed a portion back into the resonant circuitry to maintain oscillation. In some examples, the clock circuitry 1252 may correspond to any of the clocks/timers discussed herein, such as ART 325-1, 325-2, 525; PTP timer 327-1, 327-2, 527; and TSC clock 552.

The crystal oscillator includes a piezoelectric resonator such as quartz, polycrystalline ceramics, thin-film resonators, and/or the like. Where crystal units are used, the clock circuitry 1252 may also include an oscillation circuit separate from the crystal clock. Where crystal oscillators are used, the crystal unit and oscillation circuit may be integrated into a single package or integrated circuit. Examples of such clock circuitry 1252 include crystal clocks (Y), crystal oscillators (XOs), calibrated dual XO (CDXO), microcomputer-compensated crystal oscillator (MCXO), oven controlled XOs (OCXOs), double OCXOs (DOCXOs), temperature-compensated crystal oscillator crystal oscillators (TCXOs), tactical miniature crystal oscillator (TMXO), temperature-sensing crystal oscillator (TSXO), voltage controlled XOs (VCXOs), and/or other suitable clocks and/or variants and/or combinations thereof. Any of the aforementioned crystal clocks and/or XOs may be formed from a suitable material such as quartz, rubidium (e.g., rubidium crystal oscillators (RbXO)), cesium (e.g., cesium beam atomic clocks), and/or other suitable materials and/or variants and/or combinations thereof.

The clock circuitry 1252 is configured to create a signal with a relatively precise frequency, which may be used by other components such as for example, keeping track of time, providing a clock signal for digital circuits, stabilizing frequencies for transmitters and receivers, and/or the like. In some implementations, the clock circuitry 1252 may be a stand-alone component (e.g., separate from the other components of compute node 1200), or may be part of another component (e.g., processor circuitry 1202 positioning circuitry 1243, and/or the like). Additionally or alternatively, the clock circuitry 1252 can be synchronized with a synchronization source. In one example, a timing indicated by GNSS signals (e.g., as provided by positioning circuitry 1275) can be used as a synchronization source in deployment scenarios where global synchronization is desired. Additionally or alternatively, a network time (or timing) can be used as a synchronization source in deployment scenarios where network-based synchronization is desired. Additionally or alternatively, a longwave radio clock or radio-controlled clock may be used as a synchronization source, where a dedicated terrestrial longwave radio transmitter connected to a time standard (e.g., an atomic clock) transmits a time code that is demodulated and decoded to determine the current time. Additionally or alternatively, a GM instance may be used as a synchronization source as described previously. Any combination of the previous synchronization sources may be used. Additionally or alternatively, any of the aforementioned synchronization sources as a primary synchronization source, and another one or more of the aforementioned synchronization sources can be used as secondary or fallback synchronization sources that is/are used when the primary synchronization source is unavailable. Additionally or alternatively, the clock circuitry 1252 may be configured with priority information for different synchronization sources, where each a highest priority synchronization source is used when available. The synchronization configuration may be signaled to, and provisioned in, the clock circuitry 1252 (via the communication circuitry 1260).

The example of FIG. 12 is intended to depict a high-level view of components of a varying device, subsystem, or arrangement of an edge computing node. However, in other implementations, some of the components shown may be omitted, additional components may be present, and a different arrangement of the components shown may occur in other implementations. Further, these arrangements are usable in a variety of use cases and environments, including those discussed herein (e.g., a mobile device in industrial compute for smart city or smart factory, among many other examples).

### 4. Example Implementations

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example 1 includes a method of operating a display controller, comprising: monitoring clock drift of a display clock (dispclk) with respect to a Precision Time Protocol (PTP) clock; and adjusting a vertical synchronization signal (Vsync) based on the clock drift without broadcasting the Vsync over a network.

Example 2 includes the method of example 1 and/or some other example(s) herein, wherein the method includes: receiving a pulse per second signal (PPS) from a network interface controller (NIC), wherein the PPS is based on the PTP clock.

Example 3 includes the method of example 2 and/or some other example(s) herein, wherein the method includes: determining the clock drift of the dispclk with respect to the PPS, wherein the PPS is a frame of reference for the PTP clock.

Example 4 includes the method of example 3 and/or some other example(s) herein, wherein the method includes: determining a step value based on the clock drift and a desired Vsync frequency.

Example 5 includes the method of example 4 and/or some other example(s) herein, wherein the method includes: adding the step value to a previous dispelk correction value.

Example 6 includes the method of example 5 and/or some other example(s) herein, wherein the method includes: adjusting the Vsync based on carry bits produced as a result of adding the step value to the previous dispclk correction value.

Example 7 includes the method of examples 1-6 and/or some other example(s) herein, wherein the method includes: broadcasting a frame number of a frame to be played by a content playback application.

Example 8 includes the method of examples 1-7 and/or some other example(s) herein, wherein the method includes: receiving a first frame number of a first frame to be played by a content playback application of a primary system; determine a difference between the first frame number and a second frame of a second frame to be played by another content playback application of a secondary system; and speeding up or slowing down rendering of one or more frames subsequent to the second frame based on the determined difference between the first frame number and the second frame.

Example 9 includes a method for display network synchronization, comprising: performing intra-system synchronization of a primary display system (PS) including synchronizing a primary Precision Time Protocol (PTP) clock of the PS with a primary application clock of the PS; performing inter-system synchronization between the PS and a secondary display system (SS) including synchronizing the primary PTP clock with a secondary PTP clock of the SS; performing intra-system synchronization of the SS including synchronizing the secondary PTP clock with a secondary application clock of the SS; and performing display synchronization.

Example 10 includes the method of example 9 and/or some other example(s) herein, wherein the display synchronization includes: synchronizing a primary display clock of the PS with the primary PTP clock; and synchronizing a secondary display clock of the SS with the secondary PTP clock.

Example 10 includes the method of examples 9-10 and/or some other example(s) herein, wherein the performing the display synchronization includes: monitoring clock drift of a display clock with respect to the PTP clock; and adjusting a vertical synchronization signal (Vsync) based on the clock drift without broadcasting the Vsync over a network.

Example 11 includes the method of example 10 and/or some other example(s) herein, wherein the performing the display synchronization includes: receiving a pulse per second signal (PPS) from a network interface controller (NIC), wherein the PPS is based on the PTP clock; determining the clock drift of the display clock with respect to the PPS, wherein the PPS is a frame of reference for the PTP clock; and determining a step value based on the clock drift and a desired Vsync frequency.

Example 12 includes the method of example 11 and/or some other example(s) herein, wherein the performing the display synchronization includes: adding the step value to a previous display clock correction value; and adjusting the Vsync based on carry bits produced as a result of adding the step value to the previous display clock correction value.

Example 13 includes the method of examples 9-12 and/or some other example(s) herein, wherein the method includes: broadcasting a frame number of a frame to be played by a content playback application.

Example 14 includes the method of examples 9-13 and/or some other example(s) herein, wherein the method includes: receiving a first frame number of a first frame to be played by a content playback application of a primary system; determining a difference between the first frame number and a second frame of a second frame to be played by another content playback application of a secondary system; and adjusting rendering and/or displaying of one or more frames subsequent to the second frame based on the determined difference between the first frame number and the second frame.

Example 15 includes a method of operating a display controller, comprising: generating, by display clock (dispclk) monitor circuitry, a correction signal based on a clock drift of a dispclk with respect to a reference time of a Precision Time Protocol (PTP) clock; adjusting, by vertical synchronization signal (Vsync) timer circuitry, generation of a Vsync based on the correction signal; and outputting, by the Vsync timer circuitry, the Vsync to a display device, wherein the Vsync is to cause the display device to synchronize output of a set of frames to the PTP time.

Example 16 includes the method of example 15 and/or some other example(s) herein, wherein the method includes: receiving, by the dispclk monitor circuitry, the reference time from a network interface controller (NIC), wherein the PTP clock is part of the NIC.

Example 17 includes the method of examples 15-16 and/or some other example(s) herein, wherein the method includes: determining, by the dispclk monitor circuitry, a correction slope based on a display frequency and a desired Vsync frequency, wherein the display frequency is based on the clock drift.

Example 18 includes the method of example 17 and/or some other example(s) herein, wherein the method includes: adding, by the Vsync timer circuitry, the correction slope to a previous correction signal value; and adjusting, by the Vsync timer circuitry, the Vsync based on carry bits produced as a result of adding the correction slope to the previous correction signal value.

Example 19 includes the method of examples 15-18 and/or some other example(s) herein, wherein the method includes: providing, by microcontroller circuitry, an indication of a frame number of a current frame to be rendered.

Example 20 includes the method of examples 15-19 and/or some other example(s) herein, wherein the method includes: receiving, by microcontroller circuitry, a first frame number of a first frame to be played by a content playback application of a primary system; determining, by microcontroller circuitry, a difference between the first frame number and a second frame of a second frame to be played by another content playback application of a secondary system; and speeding up or slowing down, by microcontroller circuitry, rendering of one or more frames subsequent to the second frame based on the determined difference between the first frame number and the second frame.

Example 21 includes the method of examples 1-20 and/or some other example(s) herein, wherein the display controller is a discrete display controller or an integrated display controller.

Example 22 includes the method of examples 1-21 and/or some other example(s) herein, wherein the display controller includes one or more graphics processing units (GPUs).

Example 23 includes the method of examples 1-22 and/or some other example(s) herein, wherein the display controller and one or more graphics processing units (GPUs) are part of a same package, system-on-chip (SoC), single-board computer (SBC), a system-in-package (SiP), or a multi-chip package (MCP).

Example 24 includes one or more computer readable media comprising instructions, wherein execution of the instructions by processor circuitry is to cause the processor circuitry to perform the method of examples 1-23 and/or some other example(s) herein.

Example 25 includes a computer program comprising the instructions of example 25 and/or some other example(s) herein.

Example 26 includes an Application Programming Interface defining functions, methods, variables, data structures, and/or protocols for the computer program of example 25 and/or some other example(s) herein.

Example 27 includes an apparatus comprising circuitry loaded with the instructions of example 25 and/or some other example(s) herein.

Example 28 includes an apparatus comprising circuitry operable to run the instructions of example 25 and/or some other example(s) herein.

Example 29 includes an integrated circuit comprising one or more of the processor circuitry and the one or more computer readable media of example 25 and/or some other example(s) herein.

Example 30 includes a computing system comprising the one or more computer readable media and the processor circuitry of example 25 and/or some other example(s) herein.

Example 31 includes an apparatus comprising means for executing the instructions of example 25 and/or some other example(s) herein.

Example 32 includes a signal generated as a result of executing the instructions of example 25 and/or some other example(s) herein.

Example 33 includes a data unit generated as a result of executing the instructions of example 25 and/or some other example(s) herein.

Example 34 includes the data unit of example 33 and/or some other example(s) herein, wherein the data unit is a datagram, packet, frame, subframe, segment, Protocol Data Unit (PDU), Service Data Unit (SDU), message, data block, data chunk, partition, fragment, and/or database object.

Example 35 includes a signal encoded with the data unit of examples 33-34 and/or some other example(s) herein.

Example 36 includes an electromagnetic signal carrying the instructions of example 25 and/or some other example(s) herein.

Example 37 includes an apparatus comprising means for performing the method of examples 1-24 and/or some other example(s) herein.

### 5. Terminology

The terminology discussed infra may be applicable to any of the examples, embodiments, and/or implementations discussed previously. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” each of which may refer to one or more of the same or different embodiments. Furthermore, the terms “comprising,” “including,” “having,” and the like, as used with respect to the present disclosure, are synonymous.

The terms “master” and “slave” at least in some examples refers to a model of asymmetric communication or control where one device, process, element, or entity (the “master”) controls one or more other device, process, element, or entity (the “slaves”). The terms “master” and “slave” are used in this disclosure only for their technical meaning. The term “master” or “grandmaster” may be substituted with any of the following terms “main”, “source”, “primary”, “initiator”, “requestor”, “transmitter”, “host”, “maestro”, “controller”, “provider”, “producer”, “client”, “source”, “mix”, “parent”, “chief”, “manager”, “reference” (e.g., as in “reference clock” or the like), and/or the like. Additionally, the term “slave” may be substituted with any of the following terms “receiver”, “secondary”, “subordinate”, “replica”, target”, “responder”, “device”, “performer”, “agent”, “standby”, “consumer”, “peripheral”, “follower”, “server”, “child”, “helper”, “worker”, “node”, and/or the like.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “establish” or “establishment” at least in some examples refers to (partial or in full) acts, tasks, operations, and the like, related to bringing or the readying the bringing of something into existence either actively or passively (e.g., exposing a device identity or entity identity). Additionally or alternatively, the term “establish” or “establishment” at least in some examples refers to (partial or in full) acts, tasks, operations, and the like, related to initiating, starting, or warming communication or initiating, starting, or warming a relationship between two entities or elements (e.g., establish a session, establish a session, and the like). Additionally or alternatively, the term “establish” or “establishment” at least in some examples refers to initiating something to a state of working readiness. The term “established” at least in some examples refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some examples refers to (partial or in full) acts, tasks, operations, and the like, of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive a stream of packets (or the following parameters and templates or template values).

The term “receipt” at least in some examples refers to any action (or set of actions) involved with receiving or obtaining an object, data, data unit, and the like, and/or the fact of the object, data, data unit, and the like being received. The term “receipt” at least in some examples refers to an object, data, data unit, and the like, being pushed to a device, system, element, and the like (e.g., often referred to as a push model), pulled by a device, system, element, and the like (e.g., often referred to as a pull model), and/or the like.

The term “element” at least in some examples refers to a unit that is indivisible at a given level of abstraction and has a clearly defined boundary, wherein an element may be any type of entity including, for example, one or more devices, systems, controllers, network elements, modules, and so forth, or combinations thereof. The term “entity” at least in some examples refers to a distinct circuit, component, platform, architecture, device, system, and/or any other element.

The term “measurement” at least in some examples refers to the observation and/or quantification of attributes of an object, event, or phenomenon. Additionally or alternatively, the term “measurement” at least in some examples refers to a set of operations having the object of determining a measured value or measurement result, and/or the actual instance or execution of operations leading to a measured value. Additionally or alternatively, the term “measurement” at least in some examples refers to data recorded during testing.

The term “metric” at least in some examples refers to a quantity produced in an assessment of a measured value. Additionally or alternatively, the term “metric” at least in some examples refers to data derived from a set of measurements. Additionally or alternatively, the term “metric” at least in some examples refers to set of events combined or otherwise grouped into one or more values. Additionally or alternatively, the term “metric” at least in some examples refers to a combination of measures or set of collected data points. Additionally or alternatively, the term “metric” at least in some examples refers to a standard definition of a quantity, produced in an assessment of performance and/or reliability of the network, which has an intended utility and is carefully specified to convey the exact meaning of a measured value.

The term “signal” at least in some examples refers to an observable change in a quality and/or quantity. Additionally or alternatively, the term “signal” at least in some examples refers to a function that conveys information about of an object, event, or phenomenon. Additionally or alternatively, the term “signal” at least in some examples refers to any time varying voltage, current, or electromagnetic wave that may or may not carry information. The term “digital signal” at least in some examples refers to a signal that is constructed from a discrete set of waveforms of a physical quantity so as to represent a sequence of discrete values.

The term “identifier” at least in some examples refers to a value, or a set of values, that uniquely identify an identity in a certain scope. Additionally or alternatively, the term “identifier” at least in some examples refers to a sequence of characters that identifies or otherwise indicates the identity of a unique object, element, or entity, or a unique class of objects, elements, or entities. Additionally or alternatively, the term “identifier” at least in some examples refers to a sequence of characters used to identify or refer to an application, program, session, object, element, entity, variable, set of data, and/or the like. The “sequence of characters” mentioned previously at least in some examples refers to one or more names, labels, words, numbers, letters, symbols, and/or any combination thereof. Additionally or alternatively, the term “identifier” at least in some examples refers to a name, address, label, descriptor, distinguishing index, and/or attribute. Additionally or alternatively, the term “identifier” at least in some examples refers to an instance of identification. The term “persistent identifier” at least in some examples refers to an identifier that is reused by a device or by another device associated with the same person or group of persons for an indefinite period. The term “identification” at least in some examples refers to a process of recognizing an identity as distinct from other identities in a particular scope or context, which may involve processing identifiers to reference an identity in an identity database. The term “application identifier”, “application ID”, or “app ID” at least in some examples refers to an identifier that can be mapped to a specific application, application instance, or application instance. In the context of 3GPP 5G/NR, an “application identifier” at least in some examples refers to an identifier that can be mapped to a specific application traffic detection rule.

The term “circuitry” at least in some examples refers to a circuit or system of multiple circuits configured to perform a particular function in an electronic device. The circuit or system of circuits may be part of, or include one or more HW components, such as a logic circuit, a processor (shared, dedicated, or group) and/or memory (shared, dedicated, or group), an application-specific integrated circuit (ASIC), field-programmable gate array (FPGA), programmable logic controller (PLC), system on chip (SoC), system in package (SiP), multi-chip package (MCP), digital signal processor (DSP), and the like, that are configured to provide the described functionality. In addition, the term “circuitry” may also refer to a combination of one or more HW elements with the program code used to carry out the functionality of that program code. Some types of circuitry may execute one or more SW or FW programs to provide at least some of the described functionality. Such a combination of HW elements and program code may be referred to as a particular type of circuitry.

The terms “machine-readable medium” and “computer-readable medium” refers to tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP). A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, and/or the like), interpreting, loading, organizing (e.g., dynamically or statically linking), encoding, decoding, encrypting, unencrypting, packaging, unpackaging, or otherwise manipulating the information into the instructions. In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, and/or the like) on one or several remote servers. The source code packages may be encrypted when in transit over a network and decrypted, uncompressed, assembled (e.g., linked) if necessary, and compiled or interpreted (e.g., into a library, stand-alone executable, and/or the like) at a local machine, and executed by the local machine. The terms “machine-readable medium” and “computer-readable medium” may be interchangeable for purposes of the present disclosure. The term “non-transitory computer-readable medium at least in some examples refers to any type of memory, computer readable storage device, and/or storage disk and may exclude propagating signals and transmission media.

The term “interface circuitry” at least in some examples refers to, is part of, or includes circuitry that enables the exchange of information between two or more components or devices. The term “interface circuitry” at least in some examples refers to one or more HW interfaces, for example, buses, I/O interfaces, peripheral component interfaces, network interface cards, and/or the like.

The term “SmartNIC” at least in some examples refers to a network interface controller (NIC), network adapter, or a programmable network adapter card with programmable HW accelerators and network connectivity (e.g., Ethernet or the like) that can offload various tasks or workloads from other compute nodes or compute platforms such as servers, application processors, and/or the like and accelerate those tasks or workloads. A SmartNIC has similar networking and offload capabilities as an IPU, but remains under the control of the host as a peripheral device.

The term “infrastructure processing unit” or “IPU” at least in some examples refers to an advanced networking device with hardened accelerators and network connectivity (e.g., Ethernet or the like) that accelerates and manages infrastructure functions using tightly coupled, dedicated, programmable cores. In some implementations, an IPU offers full infrastructure offload and provides an extra layer of security by serving as a control point of a host for running infrastructure applications. An IPU is capable of offloading the entire infrastructure stack from the host and can control how the host attaches to this infrastructure. This gives service providers an extra layer of security and control, enforced in HW by the IPU.

The term “device” at least in some examples refers to a physical entity embedded inside, or attached to, another physical entity in its vicinity, with capabilities to convey digital information from or to that physical entity. The term “controller” at least in some examples refers to an element or entity that has the capability to affect a physical entity, such as by changing its state or causing the physical entity to move. The term “scheduler” at least in some examples refers to an entity or element that assigns resources (e.g., processor time, network links, memory space, and/or the like) to perform tasks. The term “network scheduler” at least in some examples refers to a node, element, or entity that manages network packets in transmit and/or receive queues of one or more protocol stacks of network access circuitry (e.g., a network interface controller (NIC), baseband processor, and the like). The term “network scheduler” at least in some examples can be used interchangeably with the terms “packet scheduler”, “queueing discipline” or “qdisc”, and/or “queueing algorithm”.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like.

The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources.

The term “server” at least in some examples refers to a computing device or system, including processing HW and/or process space(s), an associated storage medium such as a memory device or database, and, in some instances, suitable application(s). Additionally or alternatively, the term “server” at least in some examples refers to one or more computing system(s) that provide access to a pool of physical and/or virtual resources. As examples, the various servers discussed herein can be arranged or configured in a rack architecture, tower architecture, blade architecture, and/or the like. Additionally or alternatively, the various servers discussed herein may represent an individual server, a cluster of servers, a server farm, a cloud computing service, an edge computing network, a data center, and/or other grouping or pool of servers.

The term “platform” at least in some examples refers to an environment in which instructions, program code, SW elements, and the like can be executed or otherwise operate, and examples of such an environment include an architecture (e.g., a motherboard, a computing system, and/or the like), one or more HW elements (e.g., embedded systems, and the like), a cluster of compute nodes, a set of distributed compute nodes or network, an operating system, a virtual machine (VM), a virtualization container, a SW framework, a client application (e.g., web browser or the like) and associated application programming interfaces, a cloud computing service (e.g., platform as a service (PaaS)), or other underlying SW executed with instructions, program code, SW elements, and the like.

The term “architecture” at least in some examples refers to a computer architecture or a network architecture. The term “computer architecture” at least in some examples refers to a physical and logical design or arrangement of SW and/or HW elements in a computing system or platform including technology standards for interacts therebetween. The term “network architecture” at least in some examples refers to a physical and logical design or arrangement of SW and/or HW elements in a network including communication protocols, interfaces, and media transmission.

The term “appliance,” “computer appliance,” and the like, at least in some examples refers to a computer device or computer system with program code (e.g., SW or FW) that is specifically designed to provide a specific computing resource. The term “gateway” at least in some examples refers to a network appliance that allows data to flow from one network to another network, or a computing system or application configured to perform such tasks. Examples of gateways include IP gateways, Internet-to-Orbit (I2O) gateways, IoT gateways, cloud storage gateways, and/or the like.

The term “user equipment” or “UE” at least in some examples refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, and the like. Furthermore, the term “user equipment” or “UE” may include any type of wireless/wired device or any computing device including a wireless communications interface. Examples of UEs, client devices, and the like, include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmet-mounted display devices, augmented reality (AR) devices, virtual reality (VR) devices, mixed reality (MR) devices, and/or other like systems or devices.

The term “station” or “STA” at least in some examples refers to a logical entity that is a singly addressable instance of a medium access control (MAC) and physical layer (PHY) interface to the wireless medium (WM). The term “wireless medium” or WM” at least in some examples refers to the medium used to implement the transfer of protocol data units (PDUs) between peer physical layer (PHY) entities of a wireless local area network (LAN). Additionally or alternatively, the term “end station” at least in some examples refers to a device attached to a local area network (LAN) or metropolitan area network (MAN) that acts as a source of, and/or destination for, traffic carried on the LAN or MAN. The term “talker” at least in some examples refers to an end station that is the source or producer of a stream. The term “listener” at least in some examples refers to an end station that is the destination, receiver, or consumer of a stream.

The term “bridge” at least in some examples refers to a functional unit that interconnects two or more networks (e.g., one or more IEEE 802® networks and/or some other network(s) such as any of those discussed herein) that use the same data link layer (DLL) protocols above the MAC sublayer, but can use different MAC protocols. In some examples, forwarding and filtering decisions are made at a bridge on the basis of layer 2 (L2) information. Additionally or alternatively, the term “bridge” at least in some examples refers to a system that includes bridge component functionality (e.g., MAC, VLAN, and/or other bridge component functionality) and supports a claim of conformance to [IEEE802.1Q] § 5 for system behavior. The term “AV bridge” at least in some examples refers to a relay device (e.g., an [IEEE802.1Q] Bridge or an [IEEE80211]access point) that conforms to the requirements stated in an AVB profile for a bridge as specified in [IEEE802.1BA].

The term “network element” at least in some examples refers to physical or virtualized equipment and/or infrastructure used to provide wired or wireless communication network services. The term “network element” may be considered synonymous to and/or referred to as a networked computer, networking HW, network equipment, network node, router, switch, hub, bridge, radio network controller, network access node (NAN), base station, access point (AP), RAN device, RAN node, gateway, server, network appliance, network function (NF), virtualized NF (VNF), and/or the like.

The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” may include specialized digital signal processing, network function HW, and/or compute HW to operate as a compute node. In some examples, a “network access node” or “NAN” may be split into multiple functional blocks operating in SW for flexibility, cost, and performance. In some examples, a “network access node” or “NAN” may be a base station (e.g., an evolved Node B (eNB) or a next generation Node B (gNB)), an access point and/or wireless network access point, router, switch, hub, radio unit or remote radio head, Transmission Reception Point (TRxP), a gateway device (e.g., Residential Gateway, Wireline 5G Access Network, Wireline 5G Cable Access Network, Wireline BBF Access Network, and the like), network appliance, and/or some other network access HW. The term “access point” or “AP” at least in some examples refers to an entity that contains one station (STA) and provides access to the distribution services, via the wireless medium (WM) for associated STAs. An AP comprises a STA and a distribution system access function (DSAF).

The term “edge computing” encompasses many implementations of distributed computing that move processing activities and resources (e.g., compute, storage, acceleration, and/or network resources) towards the “edge” of the network. Example edge computing implementations can provide cloud-like services, functions, applications, and subsystems, from one or multiple locations accessible via wireless networks.

The term “colocated” or “co-located” at least in some examples refers to two or more elements being in the same place or location, or relatively close to one another (e.g., within some predetermined distance from one another). Additionally or alternatively, the term “colocated” or “co-located” at least in some examples refers to the placement or deployment of two or more compute elements or compute nodes together in a secure dedicated storage facility, or within a same enclosure or housing.

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like).

The term “compute resource” or simply “resource” at least in some examples refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, and the like), operating systems, virtual machines (VMs), SW/applications, computer files, and/or the like. A “hardware resource” or “HW resource” at least in some examples refers to compute, storage, and/or network resources provided by physical hardware element(s). A “virtualized resource” at least in some examples refers to compute, storage, and/or network resources provided by virtualization infrastructure to an application, device, system, and the like. The term “network resource” or “communication resource” at least in some examples refers to resources that are accessible by computer devices/systems via a communications network. The term “system resources” at least in some examples refers to any kind of shared entities to provide services, and may include computing and/or network resources. System resources may be considered as a set of coherent functions, network data objects or services, accessible through a server where such system resources reside on a single host or multiple hosts and are clearly identifiable.

The term “network function” or “NF” at least in some examples refers to a functional block within a network infrastructure that has one or more external interfaces and a defined functional behavior. The term “network service” or “NS” at least in some examples refers to a composition of Network Function(s) and/or Network Service(s), defined by its functional and behavioral specification(s). The term “RAN function” or “RANF” at least in some examples refers to a functional block within a RAN architecture that has one or more external interfaces and a defined behavior related to the operation of a RAN or RAN node. Additionally or alternatively, the term “RAN function” or “RANF” at least in some examples refers to a set of functions and/or NFs that are part of a RAN. The term “Application Function” or “AF” at least in some examples refers to an element or entity that interacts with a 3GPP core network in order to provide services. Additionally or alternatively, the term “Application Function” or “AF” at least in some examples refers to an edge compute node or ECT framework from the perspective of a 5G core network. The term “edge compute function” or “ECF” at least in some examples refers to an element or entity that performs an aspect of an edge computing technology (ECT), an aspect of edge networking technology (ENT), or performs an aspect of one or more edge computing services running over the ECT or ENT. The term “management function” at least in some examples refers to a logical entity playing the roles of a service consumer and/or a service producer. The term “management service” at least in some examples refers to a set of offered management capabilities.

The term “service consumer” at least in some examples refers to an entity that consumes one or more services. The term “service producer” at least in some examples refers to an entity that offers, serves, or otherwise provides one or more services. The term “service provider” at least in some examples refers to an organization or entity that provides one or more services to at least one service consumer. For purposes of the present disclosure, the terms “service provider” and “service producer” may be used interchangeably even though these terms may refer to difference concepts. Examples of service providers include cloud service provider (CSP), network service provider (NSP), application service provider (ASP) (e.g., Application SW service provider in a service-oriented architecture (ASSP)), internet service provider (ISP), telecommunications service provider (TSP), online service provider (OSP), payment service provider (PSP), managed service provider (MSP), storage service providers (SSPs), SAML service provider, and/or the like. At least in some examples, SLAs may specify, for example, particular aspects of the service to be provided including quality, availability, responsibilities, metrics by which service is measured, as well as remedies or penalties should agreed-on service levels not be achieved. The term “SAML service provider” at least in some examples refers to a system and/or entity that receives and accepts authentication assertions in conjunction with a single sign-on (SSO) profile of the Security Assertion Markup Language (SAML) and/or some other security mechanism(s).

The term “virtualization container”, “execution container”, or “container” at least in some examples refers to a partition of a compute node that provides an isolated virtualized computation environment. The term “OS container” at least in some examples refers to a virtualization container utilizing a shared Operating System (OS) kernel of its host, where the host providing the shared OS kernel can be a physical compute node or another virtualization container. Additionally or alternatively, the term “container” at least in some examples refers to a standard unit of SW (or a package) including code and its relevant dependencies, and/or an abstraction at the application layer that packages code and dependencies together. Additionally or alternatively, the term “container” or “container image” at least in some examples refers to a lightweight, standalone, executable SW package that includes everything needed to run an application such as, for example, code, runtime environment, system tools, system libraries, and settings.

The term “virtual machine” or “VM” at least in some examples refers to a virtualized computation environment that behaves in a same or similar manner as a physical computer and/or a server. The term “hypervisor” at least in some examples refers to a SW element that partitions the underlying physical resources of a compute node, creates VMs, manages resources for VMs, and isolates individual VMs from each other.

The term “edge compute node” or “edge compute device” at least in some examples refers to an identifiable entity implementing an aspect of edge computing operations, whether part of a larger system, distributed collection of systems, or a standalone apparatus. In some examples, a compute node may be referred to as a “edge node”, “edge device”, “edge system”, whether in operation as a client, server, or intermediate entity. Additionally or alternatively, the term “edge compute node” at least in some examples refers to a physical, logical, and/or virtualized implementation of a compute-capable element in the form of a device, gateway, bridge, system or subsystem, component, and/or any other computing element whether operating in a server, client, endpoint, or peer mode, and whether located at an “edge” of an network or at a connected location further within the network.

The term “Internet of Things” or “IoT” at least in some examples refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smart home, smart building and/or smart city technologies), and the like. IoT devices are usually low-power devices without heavy compute or storage capabilities. The term “Edge IoT devices” at least in some examples refers to any kind of IoT devices deployed at a network's edge.

The term “protocol” at least in some examples refers to a predefined procedure or method of performing one or more operations. Additionally or alternatively, the term “protocol” at least in some examples refers to a common means for unrelated objects to communicate with each other (sometimes also called interfaces). The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. In various implementations, a “protocol” and/or a “communication protocol” may be represented using a protocol stack, a finite state machine (FSM), and/or any other suitable data structure. The term “standard protocol” at least in some examples refers to a protocol whose specification is published and known to the public and is controlled by a standards body. The term “protocol stack” or “network stack” at least in some examples refers to an implementation of a protocol suite or protocol family. In various implementations, a protocol stack includes a set of protocol layers, where the lowest protocol deals with low-level interaction with HW and/or communications interfaces and each higher layer adds additional capabilities.

The term “application layer” at least in some examples refers to an abstraction layer that specifies shared communications protocols and interfaces used by hosts in a communications network. Additionally or alternatively, the term “application layer” at least in some examples refers to an abstraction layer that interacts with SW applications that implement a communicating component, and may include identifying communication partners, determining resource availability, and synchronizing communication. Examples of application layer protocols include HTTP, HTTPs, File Transfer Protocol (FTP), Dynamic Host Configuration Protocol (DHCP), Internet Message Access Protocol (IMAP), Lightweight Directory Access Protocol (LDAP), MQTT (MQ Telemetry Transport), Remote Authentication Dial-In User Service (RADIUS), Diameter protocol, Extensible Authentication Protocol (EAP), RDMA over Converged Ethernet version 2 (RoCEv2), Real-time Transport Protocol (RTP), RTP Control Protocol (RTCP), Real Time Streaming Protocol (RTSP), SBMV Protocol, Skinny Client Control Protocol (SCCP), Session Initiation Protocol (SIP), Session Description Protocol (SDP), Simple Mail Transfer Protocol (SMTP), Simple Network Management Protocol (SNMP), Simple Service Discovery Protocol (SSDP), Small Computer System Interface (SCSI), Internet SCSI (iSCSI), iSCSI Extensions for RDMA (iSER), Transport Layer Security (TLS), voice over IP (VoIP), Virtual Private Network (VPN), Extensible Messaging and Presence Protocol (XMPP), and/or the like.

The term “session layer” at least in some examples refers to an abstraction layer that controls dialogues and/or connections between entities or elements, and may include establishing, managing and terminating the connections between the entities or elements.

The term “transport layer” at least in some examples refers to a protocol layer that provides end-to-end (e2e) communication services such as, for example, connection-oriented communication, reliability, flow control, and multiplexing. Examples of transport layer protocols include datagram congestion control protocol (DCCP), fibre channel protocol (FBC), Generic Routing Encapsulation (GRE), GPRS Tunneling (GTP), Micro Transport Protocol (μTP), Multipath TCP (MPTCP), MultiPath QUIC (MPQUIC), Multipath UDP (MPUDP), Quick UDP Internet Connections (QUIC), Remote Direct Memory Access (RDMA), Resource Reservation Protocol (RSVP), Stream Control Transmission Protocol (SCTP), transmission control protocol (TCP), user datagram protocol (UDP), and/or the like.

The term “network layer” at least in some examples refers to a protocol layer that includes means for transferring network packets from a source to a destination via one or more networks. Additionally or alternatively, the term “network layer” at least in some examples refers to a protocol layer that is responsible for packet forwarding and/or routing through intermediary nodes. Additionally or alternatively, the term “network layer” or “internet layer” at least in some examples refers to a protocol layer that includes interworking methods, protocols, and specifications that are used to transport network packets across a network. As examples, the network layer protocols include internet protocol (IP), IP security (IPsec), Internet Control Message Protocol (ICMP), Internet Group Management Protocol (IGMP), Open Shortest Path First protocol (OSPF), Routing Information Protocol (RIP), RDMA over Converged Ethernet version 2 (RoCEv2), Subnetwork Access Protocol (SNAP), and/or some other internet or network protocol layer.

The term “link layer” or “data link layer” at least in some examples refers to a protocol layer that transfers data between nodes on a network segment across a physical layer. Examples of link layer protocols include logical link control (LLC), medium access control (MAC), Ethernet, RDMA over Converged Ethernet version 1 (RoCEv1), and/or the like.

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices. Additionally or alternatively, the term “medium access control layer”, “MAC layer”, or “MAC” at least in some examples refers to a protocol layer or sublayer that performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding (see e.g., [IEEE802], 3GPP TS 38.321 v17.2.0 (2022-10-01) and 3GPP TS 36.321 v17.2.0 (2022-10-03)).

The term “physical layer”, “PHY layer”, or “PHY” at least in some examples refers to a protocol layer or sublayer that includes capabilities to transmit and receive modulated signals for communicating in a communications network (see e.g., [IEEE802], 3GPP TS 38.201 v17.0.0 (2022-01-05) and 3GPP TS 36.201 v17.0.0 (2022-03-31)).

The term “access technology” at least in some examples refers to the technology used for an underlying physical connection to a wired or wireless communication network. The term “radio technology” at least in some examples refers to technology for wireless transmission and/or reception of electromagnetic radiation for information transfer. The term “radio access technology” or “RAT” at least in some examples refers to the technology used for the underlying physical connection to a radio based communication network. The term “RAT type” at least in some examples may identify a transmission technology and/or communication protocol used in an access network, for example, new radio (NR), Long Term Evolution (LTE), narrowband IoT (NB-JOT), untrusted non-3GPP, trusted non-3GPP, trusted Institute of Electrical and Electronics Engineers (IEEE) 802 protocols (e.g., [IEEE80211] and IEEE Standard for Local and Metropolitan Area Networks: Overview and Architecture, IEE Std 802-2014, pp.1-74 (30 Jun. 2014) (“[IEEE802]”), the contents of which is hereby incorporated by reference in its entirety), non-3GPP access, MuLTEfire, WiMAX, wireline, wireline-cable, wireline broadband forum (wireline-BBF), and the like. Examples of RATs and/or wireless communications protocols include Advanced Mobile Phone System (AMPS) technologies such as Digital AMPS (D-AMPS), Total Access Communication System (TACS) (and variants thereof such as Extended TACS (ETACS), and the like); Global System for Mobile Communications (GSM) technologies such as Circuit Switched Data (CSD), High-Speed CSD (HSCSD), General Packet Radio Service (GPRS), and Enhanced Data Rates for GSM Evolution (EDGE); Third Generation Partnership Project (3GPP) technologies including, for example, Universal Mobile Telecommunications System (UMTS) (and variants thereof such as UMTS Terrestrial Radio Access (UTRA), Wideband Code Division Multiple Access (W-CDMA), Freedom of Multimedia Access (FOMA), Time Division-Code Division Multiple Access (TD-CDMA), Time Division-Synchronous Code Division Multiple Access (TD-SCDMA), and the like), Generic Access Network (GAN)/Unlicensed Mobile Access (UMA), High Speed Packet Access (HSPA) (and variants thereof such as HSPA Plus (HSPA+), and the like), Long Term Evolution (LTE) (and variants thereof such as LTE-Advanced (LTE-A), Evolved UTRA (E-UTRA), LTE Extra, LTE-A Pro, LTE LAA, MuLTEfire, and the like), Fifth Generation (5G) or New Radio (NR), and the like; ETSI technologies such as High Performance Radio Metropolitan Area Network (HiperMAN) and the like; IEEE technologies such as [IEEE802] and/or WiFi (e.g., [IEEE80211] and variants thereof), Worldwide Interoperability for Microwave Access (WiMAX) (e.g., [WiMAX] and variants thereof), Mobile Broadband Wireless Access (MBWA)/iBurst (e.g., IEEE 802.20 and variants thereof), and the like; Integrated Digital Enhanced Network (iDEN) (and variants thereof such as Wideband Integrated Digital Enhanced Network (WiDEN); millimeter wave (mmWave) technologies/standards (e.g., wireless systems operating at 10-300 GHz and above such as 3GPP 5G, Wireless Gigabit Alliance (WiGig) standards (e.g., IEEE 802.11ad, IEEE 802.11ay, and the like); short-range and/or wireless personal area network (WPAN) technologies/standards such as Bluetooth (and variants thereof such as Bluetooth 5.3, Bluetooth Low Energy (BLE), and the like), IEEE 802.15 technologies/standards (e.g., IEEE Standard for Low-Rate Wireless Networks, IEEE Standard for Low-Rate Wireless Networks, IEEE Std 802.15.4-2020, pp.1-800 (23 Jul. 2020) (“[IEEE802154]”), ZigBee, Thread, IPv6 over Low power WPAN (6LoWPAN), WirelessHART, MiWi, ISA100.11a, IEEE Standard for Local and metropolitan area networks—Part 15.6: Wireless Body Area Networks, IEEE Std 802.15.6-2012, pp. 1-271 (29 Feb. 2012), WiFi-direct, ANT/ANT+, Z-Wave, 3GPP Proximity Services (ProSe), Universal Plug and Play (UPnP), low power Wide Area Networks (LPWANs), Long Range Wide Area Network (LoRA or LoRaWAN™), and the like; optical and/or visible light communication (VLC) technologies/standards such as IEEE Standard for Local and metropolitan area networks-Part 15.7: Short-Range Optical Wireless Communications, IEEE Std 802.15.7-2018, pp.1-407 (23 Apr. 2019), and the like; V2X communication including 3GPP cellular V2X (C-V2X), Wireless Access in Vehicular Environments (WAVE) (IEEE Standard for Information technology—Local and metropolitan area networks—Specific requirements—Part 11: Wireless LAN Medium Access Control (MAC) and Physical Layer (PHY) Specifications Amendment 6: Wireless Access in Vehicular Environments, IEEE Std 802.11p-2010, pp.1-51 (15 Jul. 2010) (“[IEEE80211p]”), which is now part of [IEEE80211]), IEEE 802.11bd (e.g., for vehicular ad-hoc environments), Dedicated Short Range Communications (DSRC), Intelligent-Transport-Systems (ITS) (including the European ITS-G5, ITS-G5B, ITS-G5C, and the like); Sigfox; Mobitex; 3GPP2 technologies such as cdmaOne (2G), Code Division Multiple Access 2000 (CDMA 2000), and Evolution-Data Optimized or Evolution-Data Only (EV-DO); Push-to-talk (PTT), Mobile Telephone System (MTS) (and variants thereof such as Improved MTS (IMTS), Advanced MTS (AMTS), and the like); Personal Digital Cellular (PDC); Personal Handy-phone System (PHS), Cellular Digital Packet Data (CDPD); Cellular Digital Packet Data (CDPD); DataTAC; Digital Enhanced Cordless Telecommunications (DECT) (and variants thereof such as DECT Ultra Low Energy (DECT ULE), DECT-2020, DECT-5G, and the like); Ultra High Frequency (UHF) communication; Very High Frequency (VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union (ITU), or the ETSI, among others. The examples provided herein are thus understood as being applicable to various other communication technologies, both existing and not yet formulated.

The term “channel” at least in some examples refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” at least in some examples refers to a connection between two devices through a RAT for the purpose of transmitting and receiving information.

The term “local area network” or “LAN” at least in some examples refers to a network of devices, whether indoors or outdoors, covering a limited area or a relatively small geographic area (e.g., within a building or a campus). The term “wireless local area network”, “wireless LAN”, or “WLAN” at least in some examples refers to a LAN that involves wireless communications. The term “wide area network” or “WAN” at least in some examples refers to a network of devices that extends over a relatively large geographic area (e.g., a telecommunications network). Additionally or alternatively, the term “wide area network” or “WAN” at least in some examples refers to a computer network spanning regions, countries, or even an entire planet. The term “backbone network”, “backbone”, or “core network” at least in some examples refers to a computer network which interconnects networks, providing a path for the exchange of information between different subnetworks such as LANs or WANs. The term “virtual local area network” or “VLAN” at least in some examples refers to a LAN that is partitioned and/or isolated in a computer network. Additionally or alternatively, the term “virtual local area network” or “VLAN” at least in some examples refers to closure of a set of MAC service access points (MSAPs) such that a data request in one MSAP in the set is expected to result in a data indication in another MSAP in the set. The term “interworking” at least in some examples refers to the use of interconnected stations in a network for the exchange of data, by means of protocols operating over one or more underlying data transmission paths.

The term “interconnection” at least in some examples refers to a data communication path between stations in one or more networks (e.g., IEEE 802 networks and/or some other network types such as any of those discussed herein. The term “interworking” at least in some examples refers to the use of interconnected stations in a network for the exchange of data by means of protocols operating over the underlying data transmission paths.

The term “flow” at least in some examples refers to a sequence of data and/or data units (e.g., datagrams, data units, packets, and/or the like) from a source entity/element to a destination entity/element. Additionally or alternatively, the term “flow” at least in some examples refers to a stream of packets used to transport data of a certain priority from a source to a sink. Additionally or alternatively, the terms “flow” or “traffic flow” at least in some examples refer to an artificial and/or logical equivalent to a call, connection, or link. Additionally or alternatively, the terms “flow” or “traffic flow” at least in some examples refer to a sequence of packets sent from a particular source to a particular unicast, anycast, or multicast destination that the source desires to label as a flow; from an upper-layer viewpoint, a flow may include of all packets in a specific transport connection or a media stream, however, a flow is not necessarily 1:1 mapped to a transport connection. Additionally or alternatively, the terms “flow” or “traffic flow” at least in some examples refer to a set of data and/or data units (e.g., datagrams, packets, or the like) passing an observation point in a network during a certain time interval. Additionally or alternatively, the term “flow” at least in some examples refers to a user plane data link that is attached to an association. Examples are circuit switched phone call, voice over IP call, reception of an SMS, sending of a contact card, PDP context for internet access, demultiplexing a TV channel from a channel multiplex, calculation of position coordinates from geopositioning satellite signals, etc. For purposes of the present disclosure, the terms “traffic flow”, “data flow”, “dataflow”, “packet flow”, “network flow”, and/or “flow” may be used interchangeably even though these terms at least in some examples refers to different concepts. The term “dataflow” or “data flow” at least in some examples refers to the movement of data through a system including software elements, hardware elements, or a combination of both software and hardware elements. Additionally or alternatively, the term “dataflow” or “data flow” at least in some examples refers to a path taken by a set of data from an origination or source to destination that includes all nodes through which the set of data travels.

The term “stream” at least in some examples refers to a sequence of data elements made available over time. At least in some examples, functions that operate on a stream, which may produce another stream, are referred to as “filters,” and can be connected in pipelines, analogously to function composition; filters may operate on one item of a stream at a time, or may base an item of output on multiple items of input, such as a moving average. Additionally or alternatively, the term “stream” or “streaming” at least in some examples refers to a manner of processing in which an object is not represented by a complete logical data structure of nodes occupying memory proportional to a size of that object, but are processed “on the fly” as a sequence of events. Additionally or alternatively, the term “filter” or “filtering” at least in some examples refers to a function in a bridge or other network element that is used to determine if a received MAC frame is to be forwarded or discarded on any given outbound port. Additionally or alternatively, the term “stream” at least in some examples refers to a unidirectional flow of data (e.g., audio and/or video) from a “talker” to one or more “listeners”.

The term “service” at least in some examples refers to the provision of a discrete function within a system and/or environment. Additionally or alternatively, the term “service” at least in some examples refers to a functionality or a set of functionalities that can be reused. The term “microservice” at least in some examples refers to one or more processes that communicate over a network to fulfill a goal using technology-agnostic protocols (e.g., HTTP or the like). Additionally or alternatively, the term “microservice” at least in some examples refers to services that are relatively small in size, messaging-enabled, bounded by contexts, autonomously developed, independently deployable, decentralized, and/or built and released with automated processes. Additionally or alternatively, the term “microservice” at least in some examples refers to a self-contained piece of functionality with clear interfaces, and may implement a layered architecture through its own internal components. Additionally or alternatively, the term “microservice architecture” at least in some examples refers to a variant of the service-oriented architecture (SOA) structural style wherein applications are arranged as a collection of loosely-coupled services (e.g., fine-grained services) and may use lightweight protocols. The term “network service” at least in some examples refers to a composition of Network Function(s) and/or Network Service(s), defined by its functional and behavioral specification.

The term “quality” at least in some examples refers to a property, character, attribute, or feature of something as being affirmative or negative, and/or a degree of excellence of something. Additionally or alternatively, the term “quality” at least in some examples, in the context of data processing, refers to a state of qualitative and/or quantitative aspects of data, processes, and/or some other aspects of data processing systems. The term “Quality of Service” or “QoS’ at least in some examples refers to a description or measurement of the overall performance of a service. In some cases, the QoS may be described or measured from the perspective of the users of that service, and as such, QoS may be the collective effect of service performance that determine the degree of satisfaction of a user of that service. In other cases, QoS at least in some examples refers to traffic prioritization and resource reservation control mechanisms rather than the achieved perception of service quality. In these cases, QoS is the ability to provide different priorities to different applications, users, or flows, or to guarantee a certain level of performance to a flow. In either case, QoS is characterized by the combined aspects of performance factors applicable to one or more services such as, for example, service operability performance, service accessibility performance; service retain ability performance; service reliability performance, service integrity performance, and other factors specific to each service. Several related aspects of the service may be considered when quantifying the QoS, including packet loss rates, bit rates, throughput, transmission delay, availability, reliability, jitter, signal strength and/or quality measurements, and/or other measurements such as those discussed herein. Additionally or alternatively, the term “Quality of Service” or “QoS’ at least in some examples refers to mechanisms that provide traffic-forwarding treatment based on flow-specific traffic classification. In some examples, Additionally or alternatively, the term “Quality of Service” or “QoS’ at least in some examples is based on the definitions provided by SERIES E: OVERALL NETWORK OPERATION, TELEPHONE SERVICE, SERVICE OPERATION AND HUMAN FACTORS Quality of telecommunication services: concepts, models, objectives and dependability planning—Terms and definitions related to the quality of telecommunication services, Definitions of terms related to quality of service, ITU-T Recommendation E.800 (09/2008) (“[ITUE800]”), the contents of which is hereby incorporated by reference in its entirety. The term “Class of Service” or “CoS” at least in some examples refers to mechanisms that provide traffic-forwarding treatment based on non-flow-specific traffic classification. In some implementations, the term “Quality of Service” or “QoS” can be used interchangeably with the term “Class of Service” or “CoS”.

The term “clock” at least in some examples refers to a physical device that is capable of providing a measurement of the passage of time since a defined epoch. The term “local clock” at least in some examples refers to a free-running clock, embedded in a respective entity (e.g., PTP instance, CSN node, and/or the like), that provides a common time to that entity relative to an arbitrary epoch. The term “recognized timing standard” at least in some examples refers to recognized standard time source that is a source external to PTP and provides time that is traceable to the international standards laboratories maintaining clocks that form the basis for the International Atomic Time (TAI) and Coordinated Universal Time (UTC), timescales. Examples of these sources are National Institute of Standards and Technology (NIST) timeservers, global navigation satellite systems (GNSSs), Long Range Navigator (LORAN) atomic clocks, and/or the like.

The term “clock drift” at least in some examples refers to a phenomena where a clock (e.g., a local clock) does not run at exactly the same rate as another clock (e.g., a reference clock or a clock of a synchronization source). Additionally or alternatively, the term “clock drift” at least in some examples refers to the gradual desynchronization of at least two clocks from one another after some time, which leads to eventual divergence unless resynchronized.

The term “event message” at least in some examples refers to a message that is timestamped on egress from a PTP instance and ingress to a PTP instance.

The term “fractional frequency offset” at least in some examples refers to a fractional offset, y, between a measured clock and a reference clock as defined by: y=_{f}_{ᵣ}^{f}ₘ-fᵣ, where fₘ is the frequency of the measured clock and fᵣ is the frequency of the reference clock, and wherein the measurement units of fₘ and fᵣ are the same.

The term “frequency offset” at least in some examples refers to the offset between a measured frequency and a reference frequency as defined by fm-fr, where fm is the frequency of the measured clock and fr is the frequency of the reference clock. The measurement units of fm and fr are the same.

The term “general message” at least in some examples refers to a message that is not timestamped.

The term “gPTP communication path” at least in some examples refers to a segment of a generalized precision time protocol (gPTP) domain that enables direct communication between two PTP instances.

The term “grandmaster-capable PTP instance”, “GM-capable PTP instance”, or GM-capable instance” at least in some examples refers to a PTP instance that is capable of being a grandmaster PTP instance.

The term “grandmaster clock” or “GM clock” at least in some examples refers to In the context of a single PTP domain, the synchronized time of a PTP instance that is the source of time to which all other PTP instances in the domain are synchronized.

The term “grandmaster PTP instance”, “GM PTP instance”, or “GM instance” at least in some examples refers to a PTP instance containing the Grandmaster Clock.

The term “message timestamp point” at least in some examples refers to a point within an event message serving as a reference point for when a timestamp is taken

The term “message type” at least in some examples refers the name of a respective message (e.g., Sync, Announce, Timing Measurement Frame, and/or the like).

The term “precision” at least in some examples refers to a measure of the deviation from the mean of the time or frequency error between the clock under test and a reference clock (see e.g., [IEEE1588]).

The term “primary reference” at least in some examples refers to source of time and/or frequency that is traceable to international standards.

The term “PTP end instance” at least in some examples refers to a PTP instance that has exactly one PTP port.

The term “PTP instance” at least in some examples refers to an instance of the IEEE 802.1AS protocol, operating in a single time-aware system within exactly one domain. A PTP instance implements the portions of IEEE Std 802.1AS indicated as applicable to either a PTP relay instance or a PTP End Instance. Additionally or alternatively, the term “PTP instance” refers to an IEEE 1588 PTP instance that conforms to the requirements of IEEE Std 802.1AS.

The term “PTP link” at least in some examples refers to within a domain, a network segment between two PTP ports using the P2P delay mechanism of IEEE Std 802.1AS [IEEE802.1AS]. The P2P delay mechanism is designed to measure the propagation time over such a link. Additionally or alternatively, a “PTP link” between PTP ports of PTP instances is also a gPTP Communication Path.

The term “PTP relay instance” at least in some examples refers to a PTP instance that is capable of communicating synchronized time received on one PTP port to other PTP ports, using the IEEE 802.1AS protocol. In some implementations, a PTP relay instance could, for example, be contained in a bridge, a router, or a multi-port end station.

The term “recognized timing standard” at least in some examples refers to recognized standard time source that is a source external to PTP [IEEE1588] and provides time that is traceable to the international standards laboratories maintaining clocks that form the basis for the International Atomic Time (TAI) and Coordinated Universal Time (UTC) timescales. Examples of these sources are National Institute of Standards and Technology (NIST) timeservers and global navigation satellite systems (GNSSs).

The term “reference plane” at least in some examples refers to boundary between a PTP port of a PTP instance and the network physical medium. Timestamp events occur as frames cross this interface.

The term “residence time” at least in some examples refers to a duration of the time interval between the receipt of a time-synchronization event message by a PTP instance and the sending of the next subsequent time-synchronization event message on another PTP port of that PTP instance. Residence time can be different for different PTP ports. Additionally or alternatively, the term “residence time” at least in some examples applies only to the case where syncLocked is TRUE. If a PTP port of a PTP instance sends a time-synchronization event message without having received a time synchronization event message, e.g., if syncLocked is FALSE or if sync receipt timeout occurs, the duration of the interval between the most recently received time-synchronization event message and the sent time synchronization event message is mathematically equivalent to residence time; however, this interval is not normally called a residence time.

The term “stability” in the context of a clock or clock signal, at least in some examples refers to a measure of the variations over time of the frequency error (of the clock or clock signal). The frequency error typically varies with time due to aging and various environmental effects, e.g., temperature. The term “synchronized time” at least in some examples refers to the time of an event relative to the Grandmaster Clock. If there is a change in the Grandmaster PTP instance or its time base, the synchronized time can experience a phase and/or frequency step. The term “synchronized clocks” at least in some examples refers to, absent relativistic effects, two clocks are synchronized to a specified uncertainty if they have the same epoch and their measurements of the time of a single event at an arbitrary time differ by no more than that uncertainty. The term “syntonized clocks” at least in some examples refers to, absent relativistic effects, two clocks are syntonized to a specified uncertainty if the duration of a second is the same on both, which means the time as measured by each advances at the same rate within the specified uncertainty (in some examples, the two clocks might or might not share the same epoch).

The term “time-aware” at least in some examples refers to the use of time that is synchronized with other stations using a protocol (see e.g., [IEEE802.1AS]). The term “time-aware system” at least in some examples refers to a device that contains one or more PTP instances and/or PTP services (e.g., Common Mean Link Delay Service). In some implementations, a time-aware system can contain more than one PTP instance in the same domain and/or different domains. The term “time-sensitive stream” at least in some examples refers to a stream of traffic, transmitted from a single source station, destined for one or more destination stations, where the traffic is sensitive to timely delivery. Additionally or alternatively, the term “time-sensitive stream” at least in some examples refers to a stream of data frames that are required to be delivered within a bounded latency.

The term “temporal isolation” at least in some examples refers to the ability to ensure that a collection of processes, threads, and/or system resources can complete their tasks in a timely manner without interference from other processes.

The term “time synchronization” at least in some examples refers to the degree to which two or more systems or devices agree on what time it is, to within some maximum error.

The term “time-sensitive stream” at least in some examples refers to a stream of data frames that are required to be delivered with a bounded latency. Additionally or alternatively, the term “time-sensitive stream” at least in some examples refers to a stream of traffic, transmitted from a single source station, destined for one or more destination stations, where the traffic is sensitive to timely delivery, and in particular, requires transmission latency to be bounded. The term “AVB stream” at least in some examples refers to a data stream associated with a stream reservation established using the Stream Reservation Protocol (SRP).

The term “AVB profile” at least in some examples refers to set of feature and option selections that specifies aspects of Bridge and end station operation, and states the conformance requirements for support of AVB functionality for a specific class of user applications (see e.g., [IEEE802.1BA]). The term “AVB network” at least in some examples refers to a contiguous set of bridges and end stations that meet the conformance requirements of [IEEE802.1BA]. The term “AVB system” at least in some examples refers to a system (e.g., a piece of equipment that implements bridge and/or end station functionality) that meets the conformance requirements for an AVB profile.

The term “frequency stability” at least in some examples refers to the variation of output frequency of a crystal oscillator due to external conditions such as temperature variation, voltage variation, output load variation, and frequency aging. In some examples, “frequency stability” is expressed in parts-per-million (ppm, 10⁻⁶) or parts-per-billion (ppb, 10⁻⁹), which can be represented in the form of frequency (e.g., Hertz (Hz)) or the like.

The term “express traffic” at least in some examples refers to a set of frames transmitted through an express Media Access Control (eMAC) sublayer (see e.g., [IEEE802.3] § 99). The term “expedited traffic” at least in some examples refers to traffic that requires preferential treatment as a consequence of jitter, latency, or throughput constraints or as a consequence of management policy. The term “audio/video traffic” or “AV traffic” at least in some examples refers to traffic associated with audio and/or video applications that is sensitive to transmission latency and latency variation, and, for some applications, packet loss.

The term “Ethernet” at least in some examples refers to a term that is used to refer either to the IEEE 802.3 media access method or to the frame format discussed in IEEE Standard for Ethernet, IEEE Std 802.3-2018 (31 Aug. 2018) (“[IEEE802.3]”), the contents of which are hereby incorporated by reference in its entirety.

The term “Ethernet frame” or simply “frame” at least in some examples refers to a format of aggregated bits from a medium access control (MAC) sublayer entity that are transmitted together in time. Additionally or alternatively, the term “frame” at least in some examples refers to a unit of data transmission on an IEEE 802 Local Area Network (LAN) that conveys a MAC Protocol Data Unit (MPDU). The term “basic frame” at least in some examples refers to a MAC frame that carries a Length/Type field with the Length or Type interpretation and has a maximum length of 1518 octets; in some examples, a basic frame is not intended to allow inclusion of additional tags or encapsulations required by higher layer protocols (see e.g., [IEEE802.3], clause 3.2.7). The term “envelope frame” at least in some examples refers to a MAC frame that carries a length/type field with the type interpretation that may indicate additional encapsulation information within the MAC client data and has a maximum length of 2000 octets; at least in some examples, an envelope frame is allows additional prefixes and suffixes to be included as required by higher layer encapsulation protocols, where the encapsulation protocols may use up to 482 octets (see e.g., [IEEE802.3] § 3.2.7). The term “MAC frame” at least in some examples refers to a frame including a destination address, a source address, a length/type field, MAC client data, and a frame check sequence (FCS); in some examples, a MAC frame also includes padding bits/bytes. The term “MAC frame” at least in some examples can also be referred to as a “data frame” or the like.

The term “tagged frame” at least in some examples refers to a frame that contains a tag header immediately following the source (MAC) address field of a frame. The term “virtual local area network tagged frame” or “VLAN tagged frame” at least in some examples refers to a tagged frame whose tag header carries both VLAN identification (e.g., VLAN ID (VID)) and priority information. The term “backbone VLAN tag”, “B-VLAN tag”, or “B-TAG” at least in some examples refers to a service VLAN tag (S-TAG) used in conjunction with backbone MAC (B-MAC) addresses. The term “backbone service instance tag” or “I-TAG” at least in some examples refers to a tag with an EtherType value allocated for an “IEEE 802.1Q Backbone Service Instance Tag EtherType.” The term “congestion notification tag” or “CN-TAG” at least in some examples refers to a tag that conveys a flow identifier (ID) that a reaction point (RP) can add to transmitted congestion controlled flow (CCF) frames, and that a congestion point (CP) includes in a congestion notification message (CNM). The term “customer VLAN tag”, “C-VLAN tag”, or “C-TAG” at least in some examples refers to VLAN tag with a tag protocol identification value allocated for an “802.1Q Tag Protocol EtherType.” The term “flow filtering tag” or “F-TAG” at least in some examples refers to a tag with a tag protocol identification value allocated for an “IEEE 802.1Q Flow Filtering Tag EtherType.” The term “service VLAN tag”, “S-VLAN tag”, or “S-TAG” at least in some examples refers to a VLAN tag with a tag protocol identification value allocated for an “802.1Q Service Tag EtherType.” The term “tag header” at least in some examples refers to a header that allows priority information, and optionally, VLAN identification information, to be associated with a frame.

The term “traffic class” at least in some examples refers to a classification used to expedite transmission of frames generated by critical or time-sensitive services. At least in some examples, traffic classes are numbered from zero through N-1, where N is the number of outbound queues associated with a given bridge port, and 1≤N≤8, and each traffic class has a one-to-one correspondence with a specific outbound queue for that port, wherein traffic class 0 corresponds to non-expedited traffic and non-zero traffic classes correspond to expedited classes of traffic. At least in some examples, a fixed mapping determines, for a given priority associated with a frame and a given number of traffic classes, what traffic class will be assigned to the frame.

The term “queue” at least in some examples refers to a collection of entities (e.g., data, objects, events, and the like) are stored and held to be processed later. that are maintained in a sequence and can be modified by the addition of entities at one end of the sequence and the removal of entities from the other end of the sequence; the end of the sequence at which elements are added may be referred to as the “back”, “tail”, or “rear” of the queue, and the end at which elements are removed may be referred to as the “head” or “front” of the queue. Additionally, a queue may perform the function of a buffer, and the terms “queue” and “buffer” may be used interchangeably throughout the present disclosure. The term “enqueue” at least in some examples refers to one or more operations of adding an element to the rear of a queue. The term “dequeue” at least in some examples refers to one or more operations of removing an element from the front of a queue.

The term “queue management” at least in some examples refers to a system, mechanism, policy, process, algorithm, or technique used to control one or more queues. The term “Active Queue Management” or “AQM” at least in some examples refers to a system, mechanism, policy, process, algorithm, or technique of dropping packets in a queue or buffer before the queue or buffer becomes full. The term “AQM entity” as used herein may refer to a network scheduler, a convergence layer entity, a network appliance, network function, and/or some other like entity that performs/executes AQM tasks. The term “queue management technique” at least in some examples refers to a particular queue management system, mechanism, policy, process, and/or algorithm, which may include a “drop policy”. The term “active queue management technique” or “AQM technique” at least in some examples refers to a particular AQM system, mechanism, policy, process, and/or algorithm. Examples of queue management and/or AQM algorithms/techniques include random early detection (RED), adaptive RED (ARED), robust RED (RRED), stabilized RED (SRED), explicit congestion notification (ECN), controlled delay (CoDel), Packet First in First Out (PFIFO), Blue, Stochastic Fair Blue (SFB), Resilient SFB (RSFB), Random Exponential Marking (REM), modified REM (M-REM), RED with Preferential Dropping (RED-PD), Common Applications Kept Enhanced (CAKE), smart queue management (SQM) (e.g., combination of AQM, QoS, and/or other techniques), Proportional Rate-based Control (PRC), proportional integral (PI) controller, and/or the like.

The term “drop policy” at least in some examples refers to a set of guidelines or rules used by a queue management/AQM technique to determine when to discard, remove, delete, or otherwise drop data or packets from a queue, buffer, cache, or other like data structure or device, or data or packets arriving for storage in a queue, buffer, cache, and/or other like data structure or device. The term “cache replacement algorithm”, “cache replacement policy”, “cache eviction algorithm”, “cache algorithm”, or “caching algorithm” at least in some examples refers to an optimization instructions or algorithms used by a caching system to manage cached data stored by the caching system. Examples of cache algorithms include Bélády's algorithm, random replacement (RR), first-in first-out (FIFO), last-in first-out (LIFO), first-in last-out (FILO), least recently used (LRU), time-aware LRU (TLRU), pseudo-LRU (PLRU), most recently used (MRU), least frequently used (LFU), LFU with dynamic aging (LFUDA), least frequent recently used (LFRU), re-reference interval prediction (RRIP), low inter-reference recency set (LIRS), adaptive replacement cache (ARC), Markov chain-based cache replacement, multi-queue algorithm (MQ), and/or the like. For purposes of the present disclosure, the aforementioned example cache replacement algorithms, as well as those not listed, can be used as queue management/AQM techniques.

The term “stack” at least in some examples refers to an abstract data type that serves as a collection of elements and may include a push operation or function, a pop operation or function, and sometimes a peek operation or function. The term “push”, in the context of data structures such as stacks, buffers, and queues, at least in some examples refers an operation or function that adds one or more elements to a collection or set of elements. The term “pop”, in the context of data structures such as stacks, buffers, and queues, at least in some examples refers an operation or function that removes or otherwise obtains one or more elements from a collection or set of elements. The term “peek”, in the context of data structures such as stacks, buffers, and queues, at least in some examples refers an operation or function that provides access to one or more elements from a collection or set of elements.

The term “data buffer” or “buffer” at least in some examples refers to a region of a physical or virtual memory used to temporarily store data, for example, when data is being moved from one storage location or memory space to another storage location or memory space, data being moved between processes within a computer, allowing for timing corrections made to a data stream, reordering received data packets, delaying the transmission of data packets, and the like. At least in some examples, a “data buffer” or “buffer” may implement a queue. The term “circular buffer”, “circular queue”, “cyclic buffer”, or “ring buffer” at least in some examples refers to a data structure that uses a single fixed-size buffer or other area of memory as if it were connected end-to-end or as if it has a circular or elliptical shape.

The term “traffic shaping” at least in some examples refers to a bandwidth management technique that manages data transmission to comply with a desired traffic profile or class of service. Traffic shaping ensures sufficient network bandwidth for time-sensitive, critical applications using policy rules, data classification, queuing, QoS, and other techniques. The term “throttling” at least in some examples refers to the regulation of flows into or out of a network, or into or out of a specific device or element. The term “access traffic steering” or “traffic steering” at least in some examples refers to a procedure that selects an access network for a new data flow and transfers the traffic of one or more data flows over the selected access network. Access traffic steering is applicable between one 3GPP access and one non-3GPP access. The term “access traffic switching” or “traffic switching” at least in some examples refers to a procedure that moves some or all traffic of an ongoing data flow from at least one access network to at least one other access network in a way that maintains the continuity of the data flow. The term “access traffic splitting” or “traffic splitting” at least in some examples refers to a procedure that splits the traffic of at least one data flow across multiple access networks. When traffic splitting is applied to a data flow, some traffic of the data flow is transferred via at least one access channel, link, or path, and some other traffic of the same data flow is transferred via another access channel, link, or path.

The term “network address” at least in some examples refers to an identifier for a node or host in a computer network, and may be a unique identifier across a network and/or may be unique to a locally administered portion of the network. Examples of identifiers and/or network addresses include a Closed Access Group Identifier (CAG-ID), Bluetooth HW device address (BD_ADDR), a cellular network address (e.g., Access Point Name (APN), AMF identifier (ID), AF-Service-Identifier, Edge Application Server (EAS) ID, Data Network Access Identifier (DNAI), Data Network Name (DNN), EPS Bearer Identity (EBI), Equipment Identity Register (EIR) and/or 5G-ETR, Extended Unique Identifier (EUI), Group ID for Network Selection (GIN), Generic Public Subscription Identifier (GPSI), Globally Unique AMF Identifier (GUAMI), Globally Unique Temporary Identifier (GUTI) and/or 5G-GUTI, Radio Network Temporary Identifier (RNTI) (including any RNTI discussed in clause 8.1 of 3GPP TS 38.300 v17.2.0 (2022-09-29) (“[TS38300]”)), International Mobile Equipment Identity (IMEI), IMEI Type Allocation Code (IMEA/TAC), International Mobile Subscriber Identity (IMSI), IMSI SW version (IMSISV), permanent equipment identifier (PEI), Local Area Data Network (LADN) DNN, Mobile Subscriber Identification Number (MSIN), Mobile Subscriber/Station ISDN Number (MSISDN), Network identifier (NID), Network Slice Instance (NSI) ID, Permanent Equipment Identifier (PEI), Public Land Mobile Network (PLMN) ID, QoS Flow ID (QFI) and/or 5G QoS Identifier (5QI), RAN ID, Routing Indicator, SMS Function (SMSF) ID, Stand-alone Non-Public Network (SNPN) ID, Subscription Concealed Identifier (SUCI), Subscription Permanent Identifier (SUPI), Temporary Mobile Subscriber Identity (TMSI) and variants thereof, UE Access Category and Identity, and/or other cellular network related identifiers), an email address, Enterprise Application Server (EAS) ID, an endpoint address, an Electronic Product Code (EPC) as defined by the EPCglobal Tag Data Standard, a Fully Qualified Domain Name (FQDN), an internet protocol (IP) address in an IP network (e.g., IP version 4 (IPv4), IP version 6 (IPv6), and the like), an internet packet exchange (IPX) address, Local Area Network (LAN) ID, a media access control (MAC) address, personal area network (PAN) ID, a port number (e.g., Transmission Control Protocol (TCP) port number, User Datagram Protocol (UDP) port number), QUIC connection ID, RFID tag, service set identifier (SSID) and variants thereof, telephone numbers in a public switched telephone network (PTSN), a socket address, universally unique identifier (UUID) (e.g., as specified in ISO/IEC 11578:1996), a Universal Resource Locator (URL) and/or Universal Resource Identifier (URI), Virtual LAN (VLAN) ID, an X.21 address, an X.25 address, Zigbee® ID, Zigbee® Device Network ID, and/or any other suitable network address and components thereof. The term “universally unique identifier” or “UUID” at least in some examples refers to a number used to identify information in computer systems. In some examples, a UUID includes 128-bit numbers and/or are represented as 32 hexadecimal digits displayed in five groups separated by hyphens in the following format: “xxxxxxxx-xxxx-Mxxx-Nxxx-xxxxxxxxxxxx” where the four-bit M and the 1 to 3 bit N fields code the format of the UUID itself. Additionally or alternatively, the term “universally unique identifier” or “UUID” at least in some examples refers to a “globally unique identifier” and/or a “GUID”. The term “endpoint address” at least in some examples refers to an address used to determine the host/authority part of a target URI, where the target URI is used to access an NF service (e.g., to invoke service operations) of an NF service producer or for notifications to an NF service consumer. The term “port” in the context of computer networks, at least in some examples refers to a communication endpoint, a virtual data connection between two or more entities, and/or a virtual point where network connections start and end. Additionally or alternatively, a “port” at least in some examples is associated with a specific process or service.

The term “physical rate” or “PHY rate” at least in some examples refers to a speed at which one or more bits are actually sent over a transmission medium. Additionally or alternatively, the term “physical rate” or “PHY rate” at least in some examples refers to a speed at which data can move across a wireless link between a transmitter and a receiver.

The term “delay” at least in some examples refers to a time interval between two events. Additionally or alternatively, the term “delay” at least in some examples refers to a time interval between the propagation of a signal and its reception. The term “packet delay” at least in some examples refers to the time it takes to transfer any packet from one point to another. Additionally or alternatively, the term “packet delay” or “per packet delay” at least in some examples refers to the difference between a packet reception time and packet transmission time. Additionally or alternatively, the “packet delay” or “per packet delay” can be measured by subtracting the packet sending time from the packet receiving time where the transmitter and receiver are at least somewhat synchronized. The term “processing delay” at least in some examples refers to an amount of time taken to process a packet in a network node. The term “transmission delay” at least in some examples refers to an amount of time needed (or necessary) to push a packet (or all bits of a packet) into a transmission medium. The term “propagation delay” at least in some examples refers to amount of time it takes a signal's header to travel from a sender to a receiver. The term “network delay” at least in some examples refers to the delay of an a data unit within a network (e.g., an IP packet within an IP network). The term “queuing delay” at least in some examples refers to an amount of time a job waits in a queue until that job can be executed. Additionally or alternatively, the term “queuing delay” at least in some examples refers to an amount of time a packet waits in a queue until it can be processed and/or transmitted. The term “delay bound” at least in some examples refers to a predetermined or configured amount of acceptable delay. The term “per-packet delay bound” at least in some examples refers to a predetermined or configured amount of acceptable packet delay where packets that are not processed and/or transmitted within the delay bound are considered to be delivery failures and are discarded or dropped.

The term “packet drop rate” at least in some examples refers to a share of packets that were not sent to the target due to high traffic load or traffic management and should be seen as a part of the packet loss rate. The term “packet loss rate” at least in some examples refers to a share of packets that could not be received by the target, including packets dropped, packets lost in transmission and packets received in wrong format.

The term “latency” at least in some examples refers to the duration of time between two events. Additionally or alternatively, the term “latency” at least in some examples refers to the amount of time it takes to transfer a first/initial data unit in a data burst from one point to another. Additionally or alternatively, the term “latency” at least in some examples refers to the delay experienced by a data unit (e.g., frame) in the course of its propagation between two points in a network, measured from the time that a known reference point in the frame passes the first point to the time that the reference point in the data unit passes the second point.

The term “jitter” at least in some examples refers to the difference between maximum and minimum of some quantity. Additionally or alternatively, the term “jitter” at least in some examples refers to a deviation from a predefined (“true”) periodicity of a presumably periodic signal in relation to a reference clock signal. Additionally or alternatively, the term “jitter” at least in some examples refers to variations of signal transitions from their ideal positions in time. In some examples, “jitter may be characterized by its spectral properties and its distribution in time.

The term “throughput” or “network throughput” at least in some examples refers to a rate of production or the rate at which something is processed. Additionally or alternatively, the term “throughput” or “network throughput” at least in some examples refers to a rate of successful message (date) delivery over a communication channel. The term “goodput” at least in some examples refers to a number of useful information bits delivered by the network to a certain destination per unit of time. The term “performance indicator” at least in some examples refers to performance data aggregated over a group of network functions (NFs), which is derived from performance measurements collected at the NFs that belong to the group, according to the aggregation method identified in a Performance Indicator definition.

The term “application” at least in some examples refers to a computer program designed to carry out a specific task other than one relating to the operation of the computer itself. Additionally or alternatively, term “application” at least in some examples refers to a complete and deployable package, environment to achieve a certain function in an operational environment. The term “process” at least in some examples refers to an instance of a computer program that is being executed by one or more threads. In some implementations, a process may be made up of multiple threads of execution that execute instructions concurrently. The term “thread of execution” or “thread” at least in some examples refers to the smallest sequence of programmed instructions that can be managed independently by a scheduler. The term “algorithm” at least in some examples refers to an unambiguous specification of how to solve a problem or a class of problems by performing calculations, input/output operations, data processing, automated reasoning tasks, and/or the like. The term “analytics” at least in some examples refers to the discovery, interpretation, and communication of meaningful patterns in data.

The term “application programming interface” or “API” at least in some examples refers to a set of subroutine definitions, communication protocols, and tools for building SW. Additionally or alternatively, the term “application programming interface” or “API” at least in some examples refers to a set of clearly defined methods of communication among various components. In some examples, an API may be defined or otherwise used for a web-based system, operating system, database system, computer HW, SW library, and/or the like.

The term “data processing” or “processing” at least in some examples refers to any operation or set of operations which is performed on data or on sets of data, whether or not by automated means, such as collection, recording, writing, organization, structuring, storing, adaptation, alteration, retrieval, consultation, use, disclosure by transmission, dissemination or otherwise making available, alignment or combination, restriction, erasure and/or destruction. The term “data pipeline” or “pipeline” at least in some examples refers to a set of data processing elements (or data processors) connected in series and/or in parallel, where the output of one data processing element is the input of one or more other data processing elements in the pipeline; the elements of a pipeline may be executed in parallel or in time-sliced fashion and/or some amount of buffer storage can be inserted between elements.

The terms “instantiate,” “instantiation,” and the like at least in some examples refers to the creation of an instance. An “instance” also at least in some examples refers to a concrete occurrence of an object, which may occur, for example, during execution of program code.

The term “packet processor” at least in some examples refers to SW and/or HW element(s) that transform a stream of input packets into output packets (or transforms a stream of input data into output data); examples of the transformations include adding, removing, and modifying fields in a packet header, trailer, and/or payload.

The term “use case” at least in some examples refers to a description of a system from a user's perspective. Use cases sometimes treat a system as a black box, and the interactions with the system, including system responses, are perceived as from outside the system. Use cases typically avoid technical jargon, preferring instead the language of the end user or domain expert. The term “user” at least in some examples refers to an abstract representation of any entity issuing commands, requests, and/or data to a compute node or system, and/or otherwise consumes or uses services.

The term “data unit” at least in some examples at least in some examples refers to a unit of information that is communicated (e.g., transmitted and/or received) through a network. In some examples, a data unit is structured to have header and payload sections. The term “data unit” at least in some examples may be synonymous with any of the following terms, even though they may refer to different aspects: “datagram”, a “protocol data unit” or “PDU”, a “service data unit” or “SDU”, “frame” and/or “data frame”, “packet”, “network packet”, “segment”, “block” and/or “data block”, “cell”, “chunk” or “data chunk”, “Type Length Value” or “TLV”, “information element”, “data element”, “bits”, “symbols”, and/or the like. Examples of data units include internet protocol (IP) packets, Internet Packet Exchange (IPX) packets, Sequenced Packet Exchange (SPX) packets, Internet Control Message Protocol (ICMP) packet, UDP datagrams, TCP segments, SCTP packet, ICMP packet, Ethernet packet (see e.g., [IEEE802.3]), Ethernet frame (see e.g., [IEEE802.3]), asynchronous transfer mode (ATM) cells, RRC messages, SDAP PDUs, SDAP SDUs, PDCP PDUs, PDCP SDUs, MAC PDUs, MAC SDUs, BAP PDUs. BAP SDUs, RLC PDUs, RLC SDUs, bits, symbols, application PDUs (APDUs), transaction PDUs (TPDUs), WiFi frames (see e.g., [IEEE802], [IEEE80211], and/or the like), Type Length Value (TLV), and/or other like data structures.

The term “translation” at least in some examples refers to the process of converting or otherwise changing data from a first form, shape, configuration, structure, arrangement, embodiment, description, or the like into a second form, shape, configuration, structure, arrangement, embodiment, description, or the like; at least in some examples there may be two different types of translation: transcoding and transformation. The term “transcoding” at least in some examples refers to taking information/data in one format (e.g., a packed binary format) and translating the same information/data into another format in the same sequence. Additionally or alternatively, the term “transcoding” at least in some examples refers to taking the same information, in the same sequence, and packaging the information (e.g., bits or bytes) differently. The term “transformation” at least in some examples refers to changing data from one format and writing it in another format, keeping the same order, sequence, and/or nesting of data items. Additionally or alternatively, the term “transformation” at least in some examples involves the process of converting data from a first format or structure into a second format or structure, and involves reshaping the data into the second format to conform with a schema or other like specification. Transformation may include rearranging data items or data objects, which may involve changing the order, sequence, and/or nesting of the data items/objects. Additionally or alternatively, the term “transformation” at least in some examples refers to changing the schema of a data object to another schema.

The term “display device” at least in some examples refers to an output device for presentation of information in visual and/or tactile form (e.g., used for visually impaired persons). For purposes of the present disclosure, the terms “display device”, “display”, “screen”, “AVB endpoint”, and “AVB system” can used interchangeably.

The term “display technology” at least in some examples refers to the technology used by a display device to present information. The term “display technology type” at least in some examples may identify a display technology and/or protocol(s) used in a display device. Examples of display technologies include liquid crystal display (LCD) and variants thereof (e.g., LED backlit LCD, thin-film transistor (TFT) LCD, blue phase mode LCD, ferroelectric liquid crystal display (FLCD), and/or the like), light-emitting diode (LED) displays and variants thereof (e.g., organic LED (OLED), active matrix OLED (AMOLED), super AMOLED, microLED (μLED), and/or the like), digital light processing (DLP), liquid crystal on silicon (LCoS), quantum dot display (e.g., quantum LED (QLED), electroluminescent quantum dots (ELQD/QD-LED), and/or the like), projectors (e.g., LCD projector, LCD with laser illumination, LED projector, laser diode projector, DLP projector, digital micromirror device (DMD), LCoS with laser illumination, MEMS with laser scanning, microoptoelectromechanical system (MOEMS) laser scanner, and/or the like), organic light-emitting transistor (OLET), surface-conduction electron-emitter display (SED), field-emission display (FED), laser TV, microelectromechanical systems (MEMS) displays (e.g., interferometric modulator display (IMoD), time multiplexed optical shutter (TMOS), and/or the like), thick-film dielectric electroluminescent technology (TDEL), telescopic pixel display (TPD), laser-powered phosphor display (LPD), electromechanical (e.g., flip-dot, split-flap, vane, and/or the like), electronic ink (e-ink) or electronic paper (e-paper), eggcrate, fiber-optic, nixie tube, vacuum fluorescent display (VFD), light-emitting electrochemical cell (LEC), lightguide display, dot-matrix display, segment displays (e.g., seven-segment display (SSD), eight-segment display, nine-segment display, fourteen-segment display (FSD), sixteen-segment display (SISD), and/or the like), 3D displays (e.g., stereoscopic, autostereoscopic, multiscopic, holographic displays, computer-generated holography, volumetric displays, fog displays, and/or the like), neon signs, laser beam displays, see-through displays, electroluminescent display (ELD), plasma displays, tactile electronic displays, vane displays, rollsigns, flip-disc displays, flip-dot displays, and/or any other type of display technologies.

The term “digital signage” at least in some examples refers to a type of electronic signage that uses various display technologies to display content, which are often used in public spaces, private/entreprise buildings, transportation systems/stations, and/or the like to provide wayfinding, exhibitions, marketing, advertising, and/or for other purposes.

The term “network video recorder” or “NVR” at least in some examples refers to a specialized computer system that includes SW that records video in a digital format to a memory or storage device. In some examples, an NVR contains no dedicated video capture HW. Additionally or alternatively, the SW of an NVR runs on a dedicated/special-purpose device with an embedded operating system or runs on a general purpose device with a standard operating system.

The term “generator lock” or “genlock” at least in some examples refers to a mechanism that locks the timing of video outputs to a reference source. Additionally or alternatively, the term “generator lock” or “genlock” at least in some examples refers to a technique where a video output of one source (or a specific reference signal from a signal generator) is used to synchronize other picture sources together to ensure the coincidence of signals in time at a combining or switching point.

The term “artefact” or “artifact” at least in some examples refers to undesired alteration in data introduced during digital processing. Additionally or alternatively, the term “artefact” or “artifact” at least in some examples refers to one or more anomalies during visual representation of digital graphics and/or imagery. Additionally or alternatively, the term “artefact” or “artifact” at least in some examples refers to a misleading and/or confusing alteration in data or observation, commonly in experimental science, resulting from flaws in technique or equipment. As examples, an “artefact” or “artifact” can be the result of a HW malfunction, SW malfunction, compression technique, aliasing, rolling shutter, error diffusion, signaling/communication-related delays or errors (within a device or system, or in a network), and/or the like.

Aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1. One or more non-transitory computer-readable media (NTCRM) comprising instructions, wherein execution of the instructions by a display controller is to cause the display controller to:
monitor clock drift of a display clock (dispclk) with respect to a Precision Time Protocol (PTP) clock; and
adjust a vertical synchronization signal (Vsync) based on the clock drift without broadcasting the Vsync over a network.

2. The one or more NTCRM of claim 1, wherein execution of the instructions is to cause the display controller to:
receive a pulse per second signal (PPS) from a network interface controller (NIC), wherein the PPS is based on the PTP clock.

3. The one or more NTCRM of claim 2, wherein execution of the instructions is to cause the display controller to:
determine the clock drift of the dispclk with respect to the PPS, wherein the PPS is a frame of reference for the PTP clock.

4. The one or more NTCRM of claim 3, wherein execution of the instructions is to cause the display controller to:
determine a step value based on the clock drift and a desired Vsync frequency.

5. The one or more NTCRM of claim 4, wherein execution of the instructions is to cause the display controller to:
add the step value to a previous dispclk correction value.

6. The one or more NTCRM of claim 5, wherein execution of the instructions is to cause the display controller to:
adjust the Vsync based on carry bits produced as a result of adding the step value to the previous dispclk correction value.

7. The one or more NTCRM of claim 1, wherein execution of the instructions is to cause the display controller to:
broadcast a frame number of a frame to be played by a content playback application.

8. The one or more NTCRM of claim 1, wherein execution of the instructions is to cause the display controller to:
receive a first frame number of a first frame to be played by a content playback application of a primary system;
determine a difference between the first frame number and a second frame of a second frame to be played by another content playback application of a secondary system; and
speed up or slow down rendering of one or more frames subsequent to the second frame based on the determined difference between the first frame number and the second frame.

9. A method for display network synchronization, comprising:
performing intra-system synchronization of a primary display system (PS) including synchronizing a primary Precision Time Protocol (PTP) clock of the PS with a primary application clock of the PS;
performing inter-system synchronization between the PS and a secondary display system (SS) including synchronizing the primary PTP clock with a secondary PTP clock of the SS;
performing intra-system synchronization of the SS including synchronizing the secondary PTP clock with a secondary application clock of the SS; and
performing display synchronization including:
synchronizing a primary display clock of the PS with the primary PTP clock, and
synchronizing a secondary display clock of the SS with the secondary PTP clock.

10. The method of claim 9, wherein the performing the display synchronization includes:
monitoring clock drift of a display clock with respect to the PTP clock; and
adjusting a vertical synchronization signal (Vsync) based on the clock drift without broadcasting the Vsync over a network.

11. The method of claim 10, wherein the performing the display synchronization includes:
receiving a pulse per second signal (PPS) from a network interface controller (NIC), wherein the PPS is based on the PTP clock;
determining the clock drift of the display clock with respect to the PPS, wherein the PPS is a frame of reference for the PTP clock; and
determining a step value based on the clock drift and a desired Vsync frequency.

12. The method of claim 11, wherein the performing the display synchronization includes:
adding the step value to a previous display clock correction value; and
adjusting the Vsync based on carry bits produced as a result of adding the step value to the previous display clock correction value.

13. The method of claim 9, wherein the method includes:
broadcasting a frame number of a frame to be played by a content playback application.

14. The method of claim 9, wherein the method includes:
receiving a first frame number of a first frame to be played by a content playback application of a primary system;
determining a difference between the first frame number and a second frame of a second frame to be played by another content playback application of a secondary system; and
adjusting rendering of one or more frames subsequent to the second frame based on the determined difference between the first frame number and the second frame.

15. A display controller, comprising:
display clock (dispclk) monitor circuitry to generate a correction signal based on a clock drift of a dispclk with respect to a reference time of a Precision Time Protocol (PTP) clock; and
vertical synchronization signal (Vsync) timer circuitry connected to the dispclk monitor circuitry, wherein the Vsync timer circuitry is to:
adjust generation of a Vsync based on the correction signal, and
output the Vsync to a display device, wherein the Vsync is to cause the display device to synchronize output of a set of frames to the PTP time.

16. The display controller of claim 15, wherein the dispclk monitor circuitry is to:
receive the reference time from a network interface controller (NIC), wherein the PTP clock is part of the NIC.

17. The display controller of claim 15, wherein the dispclk monitor circuitry is to:
determine a correction slope based on a display frequency and a desired Vsync frequency, wherein the display frequency is based on the clock drift.

18. The display controller of claim 17, wherein the Vsync timer circuitry is to:
add the correction slope to a previous correction signal value; and
adjust the Vsync based on carry bits produced as a result of adding the correction slope to the previous correction signal value.

19. The display controller of claim 15, further comprising:
microcontroller circuitry to provide an indication of a frame number of a current frame to be rendered.

20. The display controller of claim 15, further comprising microcontroller circuitry to:
receive a first frame number of a first frame to be played by a content playback application of a primary system;
determine a difference between the first frame number and a second frame of a second frame to be played by another content playback application of a secondary system; and
speed up or slow down rendering of one or more frames subsequent to the second frame based on the determined difference between the first frame number and the second frame.
